(19) United States
(12) Patent Application Publication
(10) Pub. No.: US 2025/0349323 A1
(43) Pub. Date: Nov. 13, 2025

(54) Data Capture System

(71) Applicant: Insightful Mechanisms LLC, Mountain View, CA (US)

(72) Inventors: Hector H. Gonzalez-Banos, San Mateo, CA (US); Max McFarland, Lake Oswego, OR (US); Ramya Narasimha, San Francisco, CA (US)

(21) Appl. No.: 18/884,446

(22) Filed: Sep. 13, 2024

Related U.S. Application Data
(63) Continuation-in-part of application No. 18/660,610, filed on May 10, 2024.

(51) Int. Cl. G11B 27/34; G06F 16/71; G06T 7/20; G11B 27/10; H04N 5/77

(52) U.S. Cl. CPC G11B 27/34; G06F 16/71; G06T 7/20; G11B 27/102; H04N 5/77; G06T 2207/10016; G06T 2207/30244

(57) ABSTRACT

Data capture techniques are disclosed that utilize a capture application running on a capture apparatus carried by a user/operator during a capture session. The capture apparatus comprises one or more cameras and an inertial measurement unit (IMU). User markings are applied by the user to portions of the capture data that comprises video data and IMU data. The video data portions and IMU data portions are segmented and indexed into video segments and IMU segments. Based on instant non-sequential visual inertial odometry (VIO), a velocity profile of the capture apparatus is estimated as it was carried by the user during the capture session. The non-sequential VIO is performed on segmented and indexed portions of capture data in the order requested by the user, and by employing the user markings.

### RELATED APPLICATIONS

This application is a continuation-in-part of U.S. patent application Ser. No. 18/660,610 filed on May 10, 2024 and which is incorporated herein by reference for all purposes in its entirety.

### FIELD OF THE INVENTION

This invention generally relates to the field of data capture technologies and more specifically to capturing, segmenting and indexing capture data for its efficient processing by a backend.

### BACKGROUND

It is commonly believed that the cameras of today can accurately depict the world “as it is”, and that as the quality of image sensors and lenses improve, so does the fidelity of the cameras in showing what the world is. One could argue that in the future, cameras will be so advanced and affordable that we could readily use them to observe and document any environment or situation we want. However, even with flawless sensors, cameras would still not reflect reality “as it is”. Cameras narrate a visual story according to the framing decided by the director, cinematographer, videographer, video editor, or even as implicitly dictated by their placement.

Through his film editing technique Kuleshov Effect, Lev Kuleshov demonstrates the necessity of a montage as the basic or fundamental tool in cinema. Cinema consists of fragments and the assembly of those fragments. The content of the images is not necessarily what is important but rather its combination. This is why the Academy Award for Best Film Editing exists.

Now let us consider the context of capturing visual evidence in manufacturing, construction, retail, or any other business setting. Just placing cameras is not enough. Simply recording volumes of raw video footage is not enough. Instead, one desires to “focalize” the visual evidence on what is relevant or pertinent to the business setting. For example, casinos want cameras directly above the gambling tables, retailers want visual records organized around point of sales transactions, or around key-fob entries in access control systems.

The necessity of a montage is thus true not just for cinema but also for any application that requires visual records. Montaging is the arranging of media elements into a unified composition or presentation that serves a given purpose. From this perspective, the camera output is merely raw material. It becomes a useful visual record once a human or an algorithm organizes videos and images around elements of the ontology that is relevant to the application. We refer to this as being focalized. Here we use the term ontology in the information science sense: the representation, formal naming and definitions of the categories, properties, and relations between the concepts, data, or entities that are pertinent to a subject or application.

Blueprints and floorplans are the organizing principle in architecture, engineering, and construction (AEC). The use of building information modeling (BIM) software is prevalent in this industry. In fact, it is a standard. ISO 19650-1:2018 defines BIM as: Use of a shared digital representation of a built asset to facilitate design, construction, and operation processes to form a reliable basis for decisions. A person having ordinary skill in the art (POSA) knows that BIM is fundamentally based on blueprints and floorplans.

Notice the term “operation processes” in the ISO 19650-1:2018 standard. This wording appears because BIM software is often used to manage non-construction projects also. BIM can be used in any project where participants need to share a common representation of a facility (i.e., floorplans and blueprints). Warehousing, equipment inventory, and retooling in manufacturing are some of such non-construction examples.

In AEC and related projects, the facility or environment is constantly changing, and these changes need to be periodically inspected. This is often done using photography. A POSA understands that such inspection involves more than just taking pictures with a camera. Said pictures must also be uploaded to the project management software, organized in collections, and located within the blueprint or floorplan.

Inspections or walkthroughs in small projects e.g., home construction, apartment remodeling, require low or moderate effort. But in large projects, this can become a tedious and error-prone activity if performed manually. Consider a 20-floor commercial building where the same architectural details often repeat throughout the building (even within the same floor). An inspector will have a hard time organizing and locating the photos just based on their recollection.

This challenge is demonstrated by workflow 10 of the prior art as illustrated in FIG. 1. More specifically, the process begins at block or step 12 where an inspector visits a site and takes as many pictures as practicable. Once back from the inspection or walkthrough, the inspector inserts the memory card or a universal serial bus (USB) drive from the camera to a computer. Ideally, the inspector was able to or remembered to bring the laptop to the site for this purpose. The above is shown by block 14. Then as shown by block 16, the inspector transfers the files to the laptop, and erases the old files in the camera. Now, the inspector transfers the pictures to a remote location or to a web-based project management software. Often, however, there is limited network connectivity on the site, so this must be done long after the inspection took place.

Then the inspector needs to organize the pictures relying on memory. In other words, the inspector does the organization of the captured data while relying on his/her memory to recall details about the path that he/she took during the walkthrough. This is shown by block 18. As illustrated by block 20, the inspector adds or places or pastes the pictures to the blueprint of the site of the inspection. They now need to ensure that they have an updated or latest copy of the blueprint as it is subject to revisions. At this stage the inspector shows the blueprint along with the pictures to a manager or supervisor or foreman shown in block 22.

The supervisor may now ask the inspector for any number of unanticipated questions. For example, the supervisor may ask the inspector to add his/her notes and voice recordings to the blueprint also. This can be a frustrating situation because the inspector may not anymore recall all the relevant details about the sections or parts of the inspection. This is especially true if the inspection was conducted at some time significantly in the past and/or the site is complex with many floors and sections, such as a commercial building. The inspector may now have to resort to add voice memos and other notes after the fact based on memory. The accuracy of such additions is now suspect. Moreover, they may have no other choice than to conduct the inspection again!

There is plenty of prior art that attempts to address some of the challenges in the field. U.S. Pat. No. 11,188,787 B1 to Ulbricht et al. discloses systems, methods, and computer readable media for implementing an end-to-end room layout estimation. A room layout estimation engine performs feature extraction on an image frame to generate a first set of coefficients for a first room layout class and a second set of coefficients for a second room layout class. Afterwards, the room layout estimation engine generates a first set of planes according to the first set of coefficients and a second set of planes according to the second set of coefficients. The room layout estimation engine generates a first prediction plane according to the first set of planes and a second prediction plane according to the second set of planes. Afterwards, the room layout estimation engine merges the first prediction plane and the second prediction plane to generate a predicted room layout for the room.

U.S. Patent Publication No. 2023/0392944 A1 to Kimia teaches a wearable device for estimating a location of the device within a space. The device comprises a plurality of cameras mounted to a structure, with at least a portion of the structure being adapted to facilitate a user wearing the device. The plurality of cameras have substantially fixed positions and orientations on the structure relative to each other. At least one processor is configured to receive image data from the plurality of cameras, perform feature detection on the image data to obtain a first plurality of features from the image data, and determine an estimate of the location of the device in the space. This is done based at least in part, on a location associated with a second plurality of features obtained from image data previously captured from the space that matches the first plurality of features.

U.S. Patent Publication No. 2022/0066456 A1 to Afrouzi et al. discloses a method for operating a robot, including capturing images of a workspace, capturing movement indicative of movement of the robot and capturing LIDAR data as the robot performs work within the workspace. The method further compares at least one object from the captured images to objects in an object dictionary, identifies a class to which the at least one object belongs and then generates a first iteration of a map of the workspace based on the LIDAR data. The method then generates additional iterations of the map based on newly captured LIDAR data and newly captured movement data. It then actuates the robot to drive along a trajectory that follows along a planned path by providing pulses to one or more electric motors of wheels of the robot. It then localizes the robot within an iteration of the map by estimating a position of the robot based on the movement data, slippage, and sensor errors.

U.S. Patent Publication No. 2019/0041858 A1 to Bortoff et al. teaches a system for controlling a motion of a vehicle from an initial state to a target state. The system includes a path planner to determine a discontinuous curvature path connecting the initial state with the target state by a sequential composition of driving patterns. The discontinuous curvature path is collision-free within a tolerance envelope centered on the discontinuous curvature path. The system further includes a path transformer to locate and replace at least one treatable primitive in the discontinuous curvature a path with corresponding continuous curvature segment to form a modified path remaining within the tolerance envelope. Each treatable primitive is a predetermined pattern of elementary paths. The system further includes a controller to control the motion of the vehicle according to the modified path.

U.S. Pat. No. 10,907,971 B2 to Roumeliotis et al. teaches a vision-aided inertial navigation system that comprises an image source to produce image data for poses of reference frames along a trajectory, a motion sensor configured to provide motion data of the reference frames, and a hardware-based processor configured to compute estimates for a position and orientation of the reference frames for the poses. The processor executes a square-root inverse Schmidt-Kalman Filter (SR-ISF)-based estimator to compute, for features observed from poses along the trajectory, constraints that geometrically relate the poses from which the respective feature was observed. The estimator determines, in accordance with the motion data and the computed constraints, state estimates for position and orientation of reference frames for poses along the trajectory and computes positions of the features that were each observed within the environment. Further, the estimator determines uncertainty data for the state estimates and maintains the uncertainty data as a square root factor of a Hessian matrix.

U.S. Pat. No. 11,380,362 B2 to Huang discloses systems and methods provide for editing of spherical video data. In one example, a computing device can receive a spherical video (or a video associated with an angular field of view greater than an angular field of view associated with a display screen of the computing device), such as by a built-in spherical video capturing system or by acquiring the video data from another device. The computing device can display the spherical video data. While the spherical video data is displayed, the computing device can track the movement of an object (e.g., the computing device, a user, a real or virtual object represented in the spherical video data, etc.) to change the position of the viewport into the spherical video. The computing device can generate a new video from the new positions of the viewport.

U.S. Patent Publication No. 2016/0140729 A1 to Soatto et al. teaches a method for improving the robustness of visual-inertial integration systems (VINS) based on derivation of optimal discriminants for outlier rejection, and the consequent approximations that are purportedly both conceptually and empirically superior to other outlier detection schemes used in this context. They argue that VINS is central to a number of application areas including augmented reality (AR), virtual reality (VR), robotics, autonomous vehicles, autonomous flying robots, and so forth and their related hardware including mobile phones, such as for use in indoor localization (in GPS-denied areas), and the like.

In the article entitled “Train Position and Speed Estimation by Integration of Odometers and IMUs”, authors Monica Malvezzi et al. summarize the main features of an odometry algorithm to be used in modern Automatic Train Protection and Control (ATP/ATC) systems. They argue that the availability of a reliable speed and travelled distance estimation is fundamental for the efficiency and the safety of the whole system. They investigate the integration of odometers and an IMU (Inertial Measurement Unit) in the position and speed estimation process. Their objective is to increase the accuracy of the odometric estimation, especially in critical adhesion conditions. The preliminary results show a significant improvement of position and speed estimation performance. Their paper presents the criteria to fuse the information from the different sensors. Then a set of test results showing the improvement of the estimation process are presented and discussed.

Despite the plethora of prior art and while keeping the above-described challenges of the field in mind, what is needed is a system and method for creating montages of captured data or content that can serve a variety of purposes. Such techniques, absent from the prior art, would need to “remember” the walkthrough and organize the captured content from being “in time” to a montage that organizes it “in space” for a given application. What is also needed are systems and methods of montaging that can capture content in any arbitrary order, estimate the positions/path of the observer and create a montage of the content as desired. Such systems and methods, absent from the prevailing art, would accrue a number of field automation (FA) benefits for a variety of industries.

### OBJECTS OF THE INVENTION

In view of the shortcomings of the prior art, it is an object of the invention to capture unordered or non-sequential capture data using a capture apparatus carried by a user during a walkthrough.

It is also an object of the invention to perform non-sequential visual inertial odometry (VIO) on the capture data to estimate positions of the capture apparatus during the walkthrough.

It is also an object of the invention to segment and index the capture data.

It is further an object of the invention to provide random-access to the segmented and indexed capture data.

It is also an object of the invention to fit the estimated positions as a path onto a blueprint associated with the site where the walkthrough was performed.

It is further an object of the invention to visualize the estimated path by overlaying it onto the blueprint.

It is also further an object of the invention for the capture device to be an on-off device (OOD).

It is also an object of the invention for the capture apparatus to be an always-on device (AOD).

Still other objects and advantages of the invention will become apparent upon reading the summary and the detailed description in conjunction with the drawing figures.

### SUMMARY OF THE INVENTION

A number of objects and advantages of the invention are achieved by apparatus and methods of montaging by employing non-sequential visual inertial odometry (VIO) performed on one or more portions of capture data. The capture data is produced by a capture apparatus carried by a user or an observer or an operator during a capture session at a site. Depending on the application of the present technology, the capture session may be referred to as a walkthrough or an inspection and the user may also be referred to as an inspector. According to the instant design, the capture data is non-sequential because it consists of one or more unordered portions that are collected in an arbitrary order.

The capture data is specifically produced by one or more cameras and an inertial measurement unit (IMU) contained in/on the capture apparatus. Consequently, the capture data consists of video footage generated by camera(s) and IMU measurements or IMU data measured by the IMU. The capture data is recorded or stored locally onboard the capture apparatus and uploaded to a remote storage when there is network connectivity between the capture apparatus and the remote storage. Preferably, the remote storage is in the cloud.

There are also one or more markings that are applied to the portions of capture data by the user. The markings are applied in a number of ways and serve a number of purposes. In one embodiment, the user markings or simply markings are entered by the user as waypoints indicating reference points or specific points of interest during the walkthrough or the capture session. Preferably, such waypoint markings indicate the start and end of the walkthrough. Preferably, the waypoint markings designate a pause or stop undertaken by the user during the walkthrough.

Preferably still, the waypoint markings identify a reference point that is optically derived from a fiducial marker or a landmark at the site. Preferably still, the markings are applied by the user to designate certain portions of capture data to be excluded from uploading to the remote storage. Preferably still, the markings are applied by the user to designate certain portions of capture data to be skipped from downstream processing and hence from inclusion in the montage produced per below.

There are also one or more applied constraints that condition the motion of the user in the walkthrough and in turn the motion of the capture apparatus. Preferably, one or more of these constraints are based on or derived from the above markings. Preferably, these constraints are based on corrections entered by the user for fitting estimated positions of the capture apparatus to an underlying blueprint/floorplan/architectural layout of or associated with the site. Preferably, one or more of these constraints are based on a reference point derived from a landmark or a fiducial marker at the site. Preferably still, one or more of these constraints are derived from a pause or stop detected in the motion of the capture apparatus. Preferably still, one or more of these constraints are based on a known compass point or heading at the site.

The present design estimates the velocity profile of the motion of the capture apparatus during the walkthrough based on non-sequential VIO. The above user markings are utilized in this process. The benefits of instant non-sequential VIO are accrued by first determining a partial orientation of the capture apparatus. The partial orientation comprises its roll (ϕ) and pitch (e) with respect to the gravity plane, its angular velocity dψ/dt (about the gravity vector) and its velocities in the three dimensions or 3-D (vₓ, v_{y}, v_{z}). The collection of (vₓ, v_{y}, v_{z}) estimates for an entire set of discrete samples is referred to as the velocity profile. Based on the instant principles, the above kinematic quantities can be estimated using non-sequential or sparse visual data.

Now, the position of the capture apparatus in 3-D and its remaining orientation are obtained by a constrained integration of dψ/dt and velocity profile i.e. (vₓ, v_{y}, v_{z}). This is done by utilizing the above-discussed constraints conditioning the motion of the capture apparatus. The result is a set of positions of the capture apparatus (and its remaining orientation) while undergoing motion during the walkthrough or capture session. By performing non-sequential VIO on the unordered/non-sequential portions of capture data, the present technology thus estimates the positions of the capture apparatus as it was carried by the user during the capture session/walkthrough/inspection.

The above-estimated set of positions of the capture apparatus are then used to create a montage of the capture data according to the requirements of a given application. For AEC applications, the set of positions trace the estimated path of the capture apparatus during the inspection. The montage of capture data produced for such AEC embodiments preferably uses the estimated path (algorithmically) fit to a blueprint or floorplan associated with the site. More specifically, the path is fit to a specific section or folio/page of the site where the inspection was performed. The above fit is then visualized on a computer screen by overlaying the estimated path onto the blueprint.

The non-sequential VIO is preferably performed on an appropriately provisioned backend. Preferably, the backend is in the cloud and is based on a serverless architecture, such as, Amazon AWS® Lambda. Depending on the embodiment, the capture apparatus may be an on-off device (OOD) or an always-on device (AOD). When the capture apparatus is an OOD, the user can define the start and end of the inspection by simply starting and stopping the device at the beginning and the end of the inspection respectively. Alternatively, when the capture apparatus is an AOD, the user can retrospectively define the start and end of the inspection in the non-sequential capture data ex post facto. In either case, the above is accomplished by the user by applying respective waypoint markings to the capture data, and specifically to its portions.

In a preferred embodiment, the user provides manual inputs and corrections for performing the above fit/fitting of the estimated path to the blueprint. These user corrections are used as constraints conditioning the motion of the capture apparatus and employed in the above-discussed constrained integration. In a related embodiment, the fit or fitting is based on a confidence measure that is derived from the non-sequential VIO.

In a highly preferred embodiment, the user orders the unordered portions of capture data before the above estimation of velocity profile is performed. The above-discussed user markings are employed for such ordering. In another embodiment, the user also carries a secondary device, such as a smartphone for taking pictures at desired points during the walkthrough and for including those pictures in the non-sequential capture data. In a related embodiment, the user can also include text and/or voice memos recorded at the desired points during the walkthrough and include them in the capture data.

The camera on the capture apparatus is preferably a 360-degree camera to record a 360-degree video and the montage produced is a 360-degree virtual tour. In another embodiment, the montage produced is a hyperlapse. In another embodiment, the camera is in an array of standard or non-360-degrees cameras on the capture apparatus for recording a 360-degree video. It is noted that having a 360-degree or an omnidirectional video coverage is not a requirement of the present technology.

In another preferred embodiment, the capture apparatus is mounted on a helmet worn by the user, or in other words is head-mounted to the user. In an alternative embodiment, the user carries the capture apparatus on a monopod or a “stick”. In another embodiment, the user also carries a companion device to conveniently issue commands to the capture apparatus. The companion device is particularly useful if the capture apparatus is head-mounted to the user or is otherwise not conveniently accessible during the capture session. The present technology offers a large variety of choices for the secondary device and the companion device above. These include a smartphone, a smartwatch, a tablet, a mobile computing device, a laptop, a wearable device, a personal digital assistant (PDA) or any other suitable computing device.

There is a rich array of functionality afforded by the computer applications of the present technology for organizing and managing walkthroughs in the system. For AEC embodiments, these include assigning an inspection to the site where the inspection was performed. More particularly, the assignment is to an individual section or folio of the site where the inspection was performed. Explained further, the inspection is assigned to the blueprint of the section of the site to which the estimated path of the capture apparatus is fit per above. In related embodiments, a given capture apparatus or camera or IMU is preassigned to a site/section. After the pre-assignment, any data captured by the capture apparatus is automatically assigned to that site/section.

The present technology also supports multiple observers or users each carrying a capture apparatus or sharing one or more capture apparatus. Such team of observers/inspectors can collaborate to perform a walkthrough of a large project. Depending on the embodiment, the montage produced combines the estimated positions of the capture apparatus from different users/observers/inspectors either individually or collectively.

Systems and methods of a highly preferred set of embodiments are further directed to the data capture capabilities of the present technology. The capture apparatus comprises one or more cameras and an IMU for capturing video data and IMU data respectively. There are enough computer resources on the capture apparatus to run a capture application. The capture application controls the capture apparatus and plays a key role in enabling the instant data capture capabilities. Capture data captured or recorded by the capture apparatus is non-sequential because it consists of one or more unordered portions that are collected in an arbitrary order.

The capture application is preferably modular and comprises a number of modules, each in charge of a set of responsibilities. Preferably, there is a video capture module that is in charge of reading/capturing video data from the camera(s). Preferably, there is an IMU data capture module that is in charge of reading/capturing IMU data from the IMU. The video and IMU data thus captured is segmented/decomposed into video segments and IMU segments respectively. The video and IMU data segments are also indexed by creating and updating/maintaining a video index and an IMU index respectively.

The responsibilities of segmenting and indexing video and IMU data are preferably carried out by a video segmentation and indexing module and an IMU data segmentation and indexing module respectively of the capture application. In a manner consistent with the indexing of video and IMU data, the above-discussed markings are also indexed by creating/updating/maintaining a user markings index.

Based on the instant indexing design, the capture data comprising video and IMU data can thus be retrieved in a random-access manner. Furthermore, from its originally unordered portions, the capture data can be retrieved in the order requested by the user based on user markings. The backend performs the instant non-sequential VIO on the segmented and indexed video and IMU data in the order requested by the user and by employing the user markings. As a result, a velocity profile of the capture apparatus during the capture session is obtained by the backend.

Other downstream capabilities of the prior embodiments also apply to the present embodiments. These include producing a montage of the capture data as discussed above.

Preferably, the computer resources of the capture apparatus are integrated with the camera(s) in a common housing. Preferably, the computer resources of the capture apparatus comprise an embedded computer with sufficient compute, storage and networking resources. Preferably, the video segments of t video data are produced by a video pipeline. Preferably, the video pipeline comprises a timestamp module or timestamp filter, a scaler, a transposer, a GPU encoder and an HTTP Live Streaming (HLS) multiplexer. Preferably, the video pipeline comprises a hardware video encoder and an MPEG multiplexer.

Preferably, the IMU segments comprise accelerometer segments and gyroscope segments. Preferably, the accelerometer and gyroscope segments are stored in an array. Preferably, the video index comprises a number of entries or rows in a database table, each row/entry corresponding to a video segment. Preferably, each row/entry comprises a timestamp of the start of the video segment, the duration of the video segment, a camera label and a resource locator. The resource locator locates or identifies where in the datastore or filesystem the contents or the actual video segment (containing the video frames) is stored.

The capture data including the video and IMU segments are initially stored in a local storage of the capture apparatus. These are subsequently copied or uploaded to the remote storage of the backend in the cloud. The local storage of the capture data and its uploading to remote storage is governed by a data storage and upload scheme. The data storage and upload scheme is tailored for scenarios where the capture apparatus is an AOD and where the capture apparatus is an OOD.

In the data storage and upload scheme for an AOD, the video index, the IMU index and the user markings index are preferably uploaded to the remote storage by table/database replication techniques. In one embodiment, capture data upload for an AOD employs a bidirectional WebSocket connection established by a messaging service. In the same or a related embodiment, the messaging service is Pusher® messaging service.

In the data storage and upload scheme for an OOD, entries of the video index, the IMU index and the user markings index are preferably uploaded to the remote storage by utilizing a Representational State Transfer (REST)-full API over HTTP. Preferably, there is also a background process that transfers the content files of the video and IMU segments from the OOD to remote storage.

The data capture systems and apparatus of the present technology comprise: (a) a capture apparatus containing at least one camera and an inertial measurement unit (IMU); (b) a first set and a second set of computer-readable instructions stored in a first non-transitory storage medium and a second non-transitory storage medium respectively, and at least one microprocessor coupled to said first non-transitory storage medium for executing said first set of computer-readable instructions, and at least one microprocessor coupled to said second non-transitory storage medium for executing said second set of computer-readable instructions; (c) said first set of computer-readable instructions causing a first computer application to: (d) collect one or more portions of capture data while said capture apparatus is carried by a user undergoing motion at a site during a capture session, wherein said capture data comprises video data and IMU data produced by said at least one camera and said IMU respectively; (e) allow said user to apply one or more markings to said one or more portions; (f) decompose said one or more portions into a plurality of video segments and a plurality of IMU segments; (g) index said plurality of video segments, said plurality of IMU segments and said one or more markings by employing a video index, an IMU index and a markings index respectively; and (h) said second set of computer-readable instructions causing a second computer application to estimate a velocity profile of said capture apparatus by performing non-sequential visual inertial odometry (VIO) on said plurality of video segments and said plurality IMU segments and by employing said one or more markings.

The methods of the present data capture technology execute computer program instructions by at least one processor coupled to at least one non-transitory storage medium storing said computer program instructions, said method comprise the steps of: (a) collecting one or more portions of capture data produced by a capture apparatus carried by a user undergoing motion at a site during a capture session, said capture apparatus comprising a camera and an inertial measurement unit (IMU); (b) applying one or more markings by said user to said one or more portions; (c) decomposing said one or more portions into a plurality of video segments and a plurality of IMU segments; (d) indexing said plurality of video segments, said plurality of IMU segments and said one or more markings by employing a video index, an IMU index and a markings index respectively; and (e) estimating a velocity profile of said capture apparatus from said one or more portions by employing non-sequential visual inertial odometry (VIO) and by utilizing said one or more markings.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 illustrates a workflow depicting the challenges of the prior art.

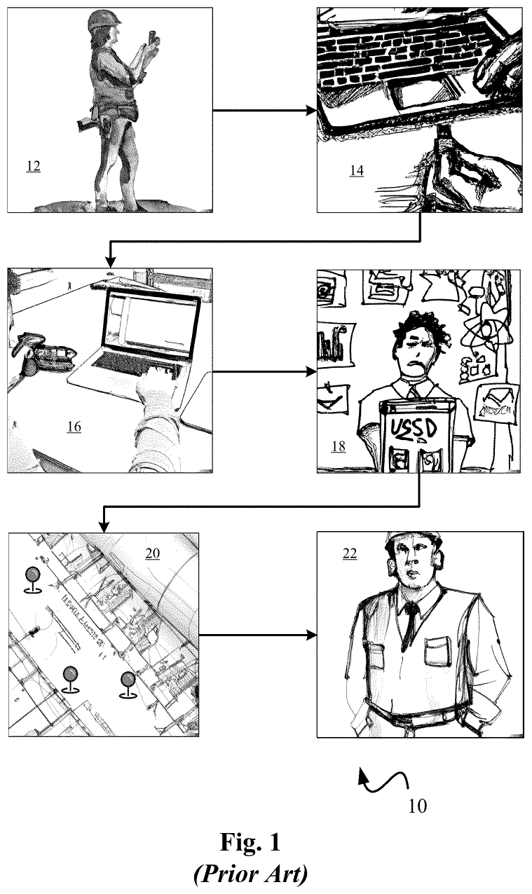

FIG. 2 provides a block diagram of the main embodiments of the present technology.

FIG. 3A illustrates a field automation (FA) workflow based on the present principles.

FIG. 3B is a variation of FIG. 3A as applied to AEC embodiments.

FIG. 4 shows two views of an exemplary capture apparatus of a preferred embodiment.

FIG. 5 shows another configuration of a capture apparatus in an alternative embodiment.

FIG. 6 shows four scenes from a video footage/coverage using a multi-camera capture apparatus.

FIG. 7 shows an inspection dashboard mockup from an exemplary 41 computer application of the present montaging technology.

FIG. 8 shows mockup of a webpage related to data validation tasks of an FA workflow using the present technology.

FIG. 9 shows an exemplary blueprint overlaid with an exemplary path estimated using the instant non-sequential VIO.

FIG. 10 shows the blueprint of FIG. 9 with the path being scaled and rotated based on user input/corrections.

FIG. 11 shows the blueprint and path of FIG. 9-10 with the corrections being made by the user.

FIG. 12 shows a montage containing a blueprint/floorplan onto which an estimated path of an inspection has been overlaid based on the present teachings.

FIG. 13 presents an exemplary modal window showing a 360-degree view associated with a particular circle/point on the path of FIG. 12.

FIG. 14 shows a montage from an embodiment that allows the user to upload secondary photos captured with a supplementary device (e.g., a smartphone) and associate these with an inspection.

FIG. 15 is a variation of FIG. 2 and illustrates an architectural block diagram with the various modules or components of the present technology.

FIG. 16 illustrates two video pipelines for processing and segmenting video from data two cameras into corresponding video segments.

FIG. 17 shows a nominal field of view (FOV) of an ideal 1/1.7″ sensor.

FIG. 18 shows a nominal FOV of a preferable sensor with a resolution of 4000×3000 pixels.

FIG. 19 shows a nominal FOV of a preferable sensor with a resolution of (1920×1440)*2 pixels i.e. with 2×2 binning and then cropping to an image size of 1920×1440 pixels.

FIG. 20A-B show conceptual top-view representations of the effective FOVs of two camera arrangements based on the instant principles.

FIG. 20C shows the three body planes of a user or operator of an instant capture apparatus.

FIG. 21 shows in detail one exemplary implementation of a video pipeline according to the present principles.

FIG. 22 shows a simplified variation of the pipeline of FIG. 21.

FIG. 23 shows another video pipeline that is particularly suited to the embodiments where the capture apparatus is an OOD.

FIG. 24 illustrates how video segments are written sequentially but are then readable in a random-access manner based on the instant index design.

FIG. 25 illustrates two IMU data pipelines for processing and segmenting IMU data into acc and gyro segments.

FIG. 26 shows the implementation design of the acc and gyro data processing pipelines of FIG. 25.

FIG. 27 shows the physical and logical views of a rolling partition storage system for the local storage of an instant capture apparatus based on the instant principles.

FIG. 28A-B show a capture apparatus in the form of a handheld device with a touch screen and where the computer resources of the capture apparatus are integrated with a camera in a common housing.

FIG. 29A-B show two examples of companion devices based on the instant design.

FIG. 30 presents various screens of an exemplary companion application operating on a smartwatch based on the present principles.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Let us now review the systems and methods of montaging based on the present technology. Among other applications, the present montaging technology is well-suited for implementing field automation (FA) for a variety of industries. In such industries, participants benefit from sharing a common representation of a facility, such as a building, a warehouse, a factory or a home/house. Target industries that can benefit from FA based on the present technology include architecture, engineering and construction (AEC), real-estate, manufacturing, warehousing and/or logistics, among many others. Specific areas that may be the beneficiaries in the above target industries include site inspections, factory retooling, facility management, real-estate sales, warehousing, among many others. The reader is informed that the benefits accrued by the present design to AEC embodiments discussed in detail below can be applied, with minor adaptations (if needed), to real-estate and related industries also.

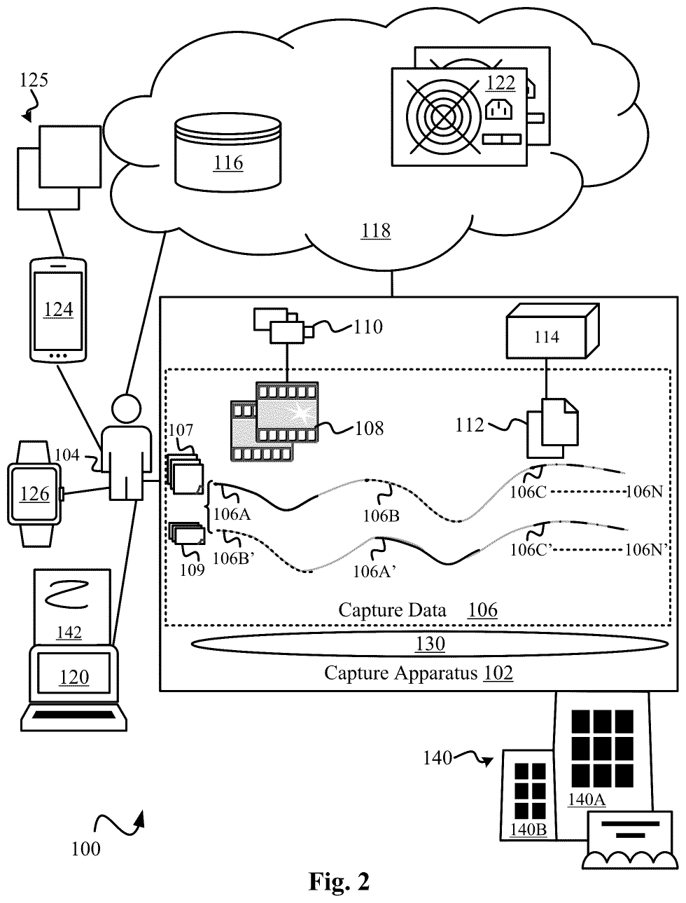

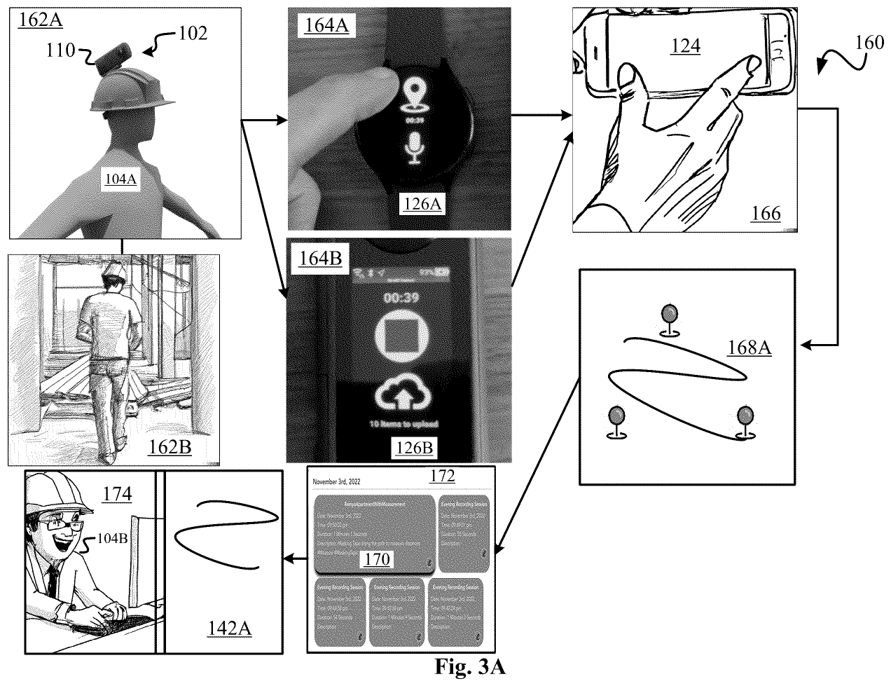

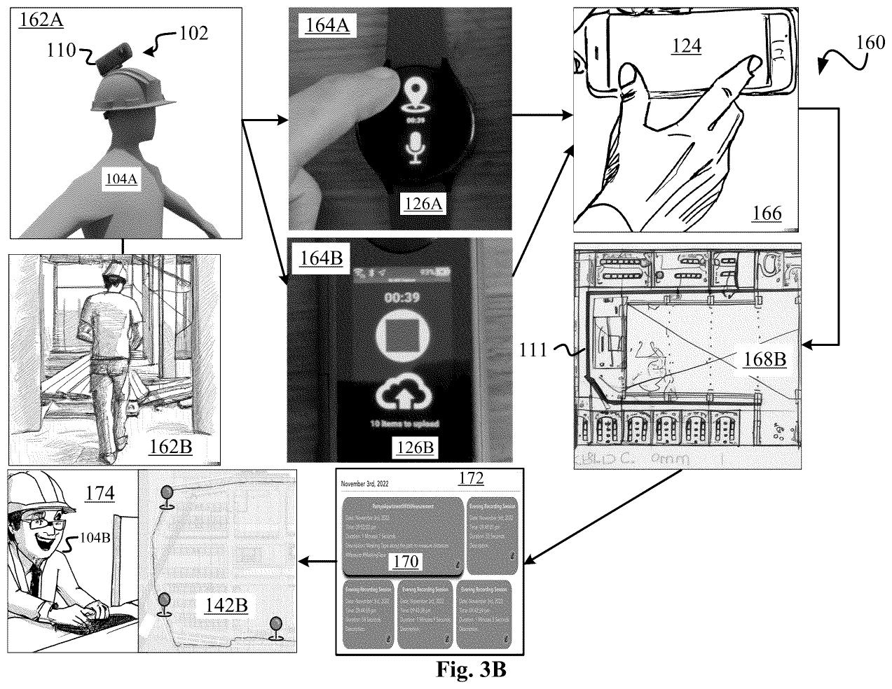

Let us now take advantage of FIG. 2 in conjunction with FIG. 3 and an overall FA workflow. Such an FA workflow 150 can be divided into a number of tasks/functions/activities as provided below:

### FA Workflow 150:

(1) Collect and store capture data from a capture session.
(2) Perform data validation.
(3) Estimate a velocity profile and the positions of the capture apparatus during the capture session.
(4) Produce a visual representation suitable for a given application based on the positions of the capture apparatus.
(5) Perform additional reporting and analysis as needed.

In any given FA implementation, these activities may be performed by different users, engaged with different modules of the instant system, however they may also be performed by the same user. Let us now review these activities and functions that are greatly improved by the montaging systems and methods of the present technology in much more detail.

(1) Collect and Store Capture Data from a Capture Session:

A capture session is characterized by a “walkthrough” of a site, building, facility or home or any other physical area of interest by an observer or an operator or a user carrying the capture apparatus. In practice, the walkthrough may be any form of locomotion of the observer, aided or unaided i.e. with or without the observer being on a mechanized ride e.g. a scooter. The observer is likely a human, although the observer may also be a robot. Because a capture session always employs such a use the terms capture session and walkthrough, we will walkthrough interchangeably in this disclosure.

For the purpose of understanding the first stage or set of functions (1) of FA workflow 150 above, let us take a detailed look at FIG. 2 now. FIG. 2 shows an embodiment 100 of a montaging system comprising a capture apparatus 102 carried by an observer or user 104. Capture apparatus collects capture data 106 shown within the dotted-lined box. Capture data 106 comprises of video data 108 recorded or captured by one or more cameras 110 and IMU data 112 measured or taken by an inertial measurement unit (IMU) 114.

Camera(s) 110 and IMU 114 are onboard capture apparatus 102 carried by observer or user or operator 104. Capture data 106 comprises one or more portions 106A, 106B, . . . 106N as shown. Three portions 106A, 106B and 106C are shown and marked explicitly but any number of such portions may be present as shown by the dotted line connecting portions 106C and 106N. According to the chief aspects, portions 106A, 106B, . . . 106N of capture data 106 are unordered. In other words, there is no requirement on the order or ordering of portions 106A-N of capture data 106 as these portions are collected. Stated differently, in this stage (1) of workflow 150, one or more portions 106A, 106B, . . . of capture data 106 are collected and stored in any arbitrary order.

Capture apparatus 102 has enough compute, memory/storage and network capabilities to execute a capture application 130 that is in charge of performing its various functions as will be described herein. Preferably, these resources are available on capture apparatus 102 itself in the form of an embedded computer. These compute, storage and network resources on capture apparatus 102 are not explicitly shown in FIG. 2 to avoid clutter. As capture data 106 in portions 106A-N is collected, it is first stored by capture application 130 locally on capture apparatus 102 in its local memory storage.

However, from time to time, capture data 106 is uploaded to a remote computer storage 116. Remote storage 116 is preferably in the cloud, such as cloud 118 shown in FIG. 2. However, remote storage 116 may be any remote storage with substantially more storage capacity than the local storage on capture apparatus 102. The uploading of capture data 106 is performed by capture application 130 running on apparatus 102. This uploading of capture data requires that there is network connectivity between capture apparatus 102 and remote storage 116.

The present technology recognizes that such network connectivity can be disrupted at times. That is why capture data 102 is stored locally per above or “buffered” on the capture apparatus. It is then copied to remote storage 116 when there is network connectivity and according to a data replication scheme. In other words, local storage on apparatus 102 acts as a local buffer for locally storing capture data 106 until the time that there is network connectivity to remote storage 116 for uploading data 106 or until a prescribed time or event. As will be explained further below, based on the markings applied by user 104 on capture data 106, and specifically to (unordered) portions 106A-N, these portions may be wholly or selectively designated by user 104 to be discarded from capture apparatus 102 without having to be uploaded to remote storage 116.

According to the instant design of montaging system 100 of FIG. 2, user 104 applies one or more markings 107 to portions 106A-N. Depending on the embodiment, markings 107 may be applied by the user in a number of ways and may serve a variety of purposes. In one set of embodiments, markings 107 contain waypoints or waypoint information entered by the user. For this purpose, appropriate user interface (UI) affordances are provided to user 104 in montaging system 100. A waypoint signifies any important point or location during the walkthrough performed by user 104 and such markings are also referred to as waypoint markings.

In one such embodiment, the waypoint marks the start and end of the walkthrough or capture session in capture data 106. In an AEC project, such a capture session is referred to as an inspection, and user 104 is referred to as an inspector. So, the waypoint information entered by the user in such AEC embodiments identifies the position in capture data 106 where the inspection started and ended. This may be accomplished by the user entering a specific time instant in video data 110 or IMU data 114 that identifies the start and end of the inspection. More particularly, user 104 identifies one of portions 106A-N and a time instant in it when the inspection started. In a similar manner, user 104 identifies one of portions 106A-N and a time instant in it when the inspection ended. Usual sanity checks, e.g. inspection end time cannot be the same or before the inspection start time, and the like, are applied.

Depending on the embodiment, a waypoint and more specifically a waypoint marking may thus be entered in system 100 of FIG. 2 as a combination of the identifier of a specific portion from portions 106A-N and a time instant within the identified portion. Alternatively, a waypoint marking may also be entered as geographical coordinates or reference points or locations of interest in the walkthrough performed by observer 104.

An inspection is a critical part of an AEC project. It is performed by a qualified person/personnel or observer/user 104 at a given project or building or site 140, which may be a construction site. More specifically, it is performed at a page or a folio or a section of such a site/project/building. Building 140 in FIG. 2 has two such sections 140A and 140B as shown. In this disclosure, we use the terms folio, page and section interchangeably as well as the terms site and project. For simple sites/projects, there may only be one section or folio at a site. In such a scenario, the terms site, project and section may be used interchangeably.

Regardless, an inspection is a specific use-case of capture session for an AEC or another application that requires an inspection or a survey or an examination of a site. Thus, in embodiments in which an inspection is carried out during the capture session, the terms capture session, walkthrough and inspection may be employed interchangeably.

More specifically, an inspection is a period of time during which user 104 inspects a section of a project and collects and stores capture data 106 via apparatus 102. There may be more than one inspection performed for a given folio/page/section of a site/project. For brevity we refer to capture apparatus 102 as “producing” capture data 106 with the understanding that it is camera(s) 110 and IMU 114 onboard capture apparatus 102 that produce video data/content 108 and IMU data 112 respectively.

Capture data 106 thus produced is also collected or recorded or “captured” by capture apparatus 102. What we mean is that capture data 106 produced by camera(s) 108 and IMU 112 is collected or stored by appropriate memory/storage devices onboard capture apparatus 102. Local memory storage on capture apparatus 102 is not explicitly shown in FIG. 2 to avoid clutter but is presumed to exist. Capture data 106 is first stored locally in this local storage and then uploaded/transferred to remote storage 116 according to a data replication scheme. In the simplest case, the replication scheme may simply be a periodic upload.

In embodiments where capture apparatus 102 operates as an on-off device (OOD), observer/user 104 applies markings 107 to portions 106A-N of capture data 106 in real-time or simultaneously or concurrently while the capture session is active. These markings preferably designate the start and end of the capture session. For an AEC application, this is while the inspection is being performed. In such an OOD scenario, user 104 starts or turns on capture apparatus 102 and specifically instructs capture application 130 to do so at the start of the capture session/inspection. This signifies the start of the capture session. Then the user turns off capture apparatus 102 and more specifically instructs capture application 130 to do so at the end of the capture session/inspection. This signifies the end of the capture session.

However, in alternative embodiments where capture apparatus operates as an always-on device (AOD), capture data 106 is continuously collected or captured. In such AOD embodiments, observer/user 104 applies markings to portions 106A-N of capture data 106 retrospectively i.e. after the fact or after the data has been collected/recorded/captured and stored or ex post facto. In one such embodiment, user 104 does this by entering one or more waypoints to/into capture data 106, or in other words, by applying waypoint markings to portions 106A-N. Such waypoint markings preferably identify the start and end of the inspection or capture session per above.

The walkthrough of user 106 during a capture session is usually not a single continuous motion without pauses or stops. Thus, user 104 also advantageously applies markings 107 to portions 106A-N to indicate such pauses. Each such marking is a waypoint that represents a momentary and brief pause during the walkthrough. For an inspection, it usually lasts only a few seconds although it can be longer. A user may perform a pause or stop for one or more of several reasons. For example, to mark a point of interest or an easily recognizable location, or when a required checkpoint location is reached, or at the intended start and end of the walkthrough/inspection. Exemplarily, such a checkpoint may be an entrance and/or an exit of the building/site.

Referring to the above discussion of OOD versus AOD configurations of capture apparatus 102, a waypoint marking 107 that signifies a pause/stop in the walkthrough may be applied or entered into capture data 106 as it is collected or afterwards. In a preferred embodiment in which user 106 wears a head-worn capture apparatus 102, a marking 107 may be applied to capture data 106 simply by a head gesture and concurrently with the capture session. In other words, the head gesture automatically enters a waypoint of interest into capture data 106 and more specifically in one of portions 106A-N being captured/collected/recorded. If capture apparatus 102 is an AOD device, then the present technology allows the markings to be applied retrospectively into capture data 106 after it has been produced and collected per above explanation.

A key innovation of the present design is the ability to perform walkthroughs at a given site/project non-sequentially or out of order or in any arbitrary order or at will or not in a preordained path/route or not following a prescribed schedule. After capture data 106 from a given capture session has been produced and collected, UI affordances in system 100 are invoked that allow the user to order its portions 106A-N. Based on the requirements of a given application, a practitioner is able to order portions 106A-N as required to produced/generate a montage or visual composition 142 for the given application. Explained further, the results produced by montaging system 100 of the present design comprise montage 142 and they may be used for reporting or analysis as needed. In addition, they may include any other data of interest accumulated from the capture apparatus and from subsequent processing.

In the case of an AEC application, the preferred visual composition or montage of interest 142 generated by montaging system 100 is a path that the inspector took during the inspection. More specifically, montaging system 100 first determines or estimates the velocity profile of capture apparatus 102 during the walkthrough by deploying instant visual inertial odometry (VIO). It then determines or estimates a set of positions of the capture apparatus from the velocity profile based on the constraints conditioning the motion of capture apparatus 102 as to be discussed further below. This set of positions trace or constitute a path of the capture apparatus as carried by inspector 104 during the inspection. Therefore, it is important to order portions 106A-N first before such a path is traced or determined or estimated.

This is so that the set of positions estimated from the ordered portions 106A-N would trace a path that covers or circumscribes all the sections of the building that are to be inspected. For example, it may be desirable for a prescribed path to cover the entryway first, then the hallway, then the offices, then the storage and the mailroom and so on. The present technology allows the above to be accomplished, even though the inspector may not have physically followed the prescribed path. In other words, the present design does not impose the prescribed path on the physical walkthrough or inspection, while still arriving at the prescribed path. It does so by enabling user 104 to order portions 106A-N before performing path estimation.

While still taking advantage of FIG. 2, let us now consider an AEC example where capture data 106 was collected as three (unordered) portions 106A-C in this arbitrary order or sequence “in time”: 106A, 106B and 106C. Let us assume that site/building 140 consists of three folios or i.e. sections first, intermediate, last. Only two such folios 140A and 140B are explicitly marked and shown in FIG. 2 for clarity. Further, our observer or inspector 104 walks through the intermediate section first, causing unordered portion 106A of capture data 106 to be collected.

Then, the observer/inspector passes through the first section of the building, causing unordered portion 106B to be collected. Finally, the observer/inspector passes through the third and the final section of the building and this causes unordered portion 106C to be collected. Now, by utilizing UI affordances of montaging system 100 and based on markings 107 applied to the unordered portions 106A-C, user 104 orders or sorts these unordered portions such that they are ordered according to a prescribed path that is suitable for montage or presentation 142 of capture data 106. The sorted order or simply order of unordered portions 106A-C is shown in FIG. 2 as: 106B′, 106A′ and 106C′. This is the order that is used for tracing or estimating the path of inspector 104 as will be taught further below.

To expound further, user 104 first applies markings 107 to identify each portion 106A, 106B, 106C, for example, by labels/texts “intermediate section”, “first section”, “third section” respectively. The user then orders the portions based on these markings by designating unordered portion 106B to appear first (as ordered portion 106B′), followed by portion 106A (as ordered portion 106A′), followed by portion 106C (as ordered portion 106C′). Exemplary UI affordances that may be utilized for this purpose include point-and-click and drag-and-drop widgets.

The present technology is thus able to order unordered portions from the order that they were captured “in time” i.e. 106A, 106B and 106C to arrive at an order that is organized “in space” i.e. 106B′, 106A′, 106C′. The user may apply any ordering on (unordered) portions 106A-C as desired to satisfy the requirements of montage or presentation 142 of capture data 106. For example, one such presentation may require that user orders data portions 106A-C in reverse order of capture i.e., 106C′, 106B′ and 106A′. The user may also consider after the walkthrough that a certain portion e.g. portion 106C is not relevant or important enough. In that case, the user would exclude or skip the portion from the final order i.e. 106B′, 106A′.

The present design considers such user-applied or simply user markings 107 as natural or ordinary elements of a capture session or walkthrough. According to present teachings, these markings annotate or denote or apply additional information to portions 106A-N in a number of useful ways. As noted in the example above, they are also used by system 100 of FIG. 2 in the generation of montage 142 of capture data 106 that is suitable for the application at hand. For AEC embodiments, such a montage 142 comprises the traced/estimated path fit or focalized to the blueprint of the section/folio that has undergone inspection. This montage serves as a “visual evidence” of capture data 106 and is contained in the overall results produced by montaging system 100 per above.

In still related embodiments, user-applied markings 107 are used to identify which of the portions of capture data 106 to include or to exclude from uploading to remote storage 116. More specifically, user 106 may mark portions 106A and 106C to be uploaded to remote storage 116 and to be included for downstream processing for inclusion in montage 142. The user may mark portion 106B to be skipped or excluded uploading.

Alternatively or in addition, the user may mark portion 106B to be skipped or excluded from downstream processing and hence to be excluded from montage 142. Portion 106B may thusly be skipped for a number of reasons, exemplarily for saving computational resources and/or for privacy concerns.

Thus, fragments or portions 106A-N of captured data 106 can be recorded or processed in arbitrary order. Further, the capture apparatus may be off during some portions of the walkthrough and consequently no corresponding portions of capture data may be collected/recorded. Such time periods without recorded capture data can also be the result of camera overexposure (excessive brightness) or underexposure (excessive darkness) or other equipment failures. Moreover, some portions may be marked to be skipped per above i.e. not uploaded and/or excluded from downstream data processing and inclusion in montage 142. In one embodiment, portions 106A-N are uploaded to the cloud for processing. Alternatively, they are processed locally on-premise.

Based on the instant principles, there are also constraints 109 that condition the motion of capture apparatus 102 as hinted above. Let us now discuss this aspect of the present design in a lot more detail. In order for the present technology to accurately determine the positions of the capture apparatus during the walkthrough, it is important that one or more constraints 109 be applied that condition the motion that capture apparatus 102 of FIG. 2 undergoes. These constraints 109 are applied during the mathematical computations performed for the estimation of positions of capture apparatus 102 during its motion.

Constraints 109 conditioning the motion of the capture apparatus 102 are derived from a number of sources and can be applied in a number of ways. These constraints are in part derived from user markings 107 applied to portions 106A-N of capture data 106. In the preferred embodiments, some subset of constraints 109 are derived from waypoint markings 107 applied by the user to data portions. In the same or related embodiments, these constraints 109 take the form of manual corrections applied by the user to the set of positions of the captured apparatus determined by montaging system 100.

In AEC embodiments, such corrections are applied to the walkthrough path, or simply path, of capture apparatus 102 traced/estimated. For this purpose, an appropriate graphical user interface (GUI) is provided for the user to manually use correction points or to “drag” the path or line on the blueprint as desired. This is also referred to as editing or confirmation of the path in the present design.

In other embodiments, applied constraints 109 conditioning the motion of capture apparatus 102 comprise a reference point that is derived from an optical fiducial marker or a visual landmark or a reference point or a checkpoint or a visual identifier at the site. What this means is that a marker or landmark at the site is first recognized by the system using computer vision techniques. Then, its location at the site is used as a reference point and applied as a constraint 109 conditioning the motion of capture apparatus 102 for correcting/adjusting the estimated set of positions of the capture apparatus.

Therefore, rather than manually entering/inputting corrections to the computed/determined/estimated positions of the capture apparatus, they are automatically applied/entered from known reference points. Those reference points are in turn derived from visual markers/landmarks/identifiers at the building/site, and are then applied as constraints for estimating the positions of the capture apparatus per above. In still other embodiments, applied constraints 109 are automatically derived from pauses or stops detected in the motion of capture apparatus 102. Recall, that such pauses/stops may also be explicitly entered by user 104 as waypoint markings 107 and applied constraints 109 may also be based on such waypoint markings.

In a preferred embodiment, montage 142 is generated/produced on computing device 120 that is separate from capture apparatus 102. This is because visualization and reporting may require storage and compute resources that are excessive for storage and compute resources onboard capture apparatus 102. In the case of AEC embodiments for example, the estimated path is algorithmically fit to a blueprint of a section e.g. section 140A or section 140B of site 140. The above path fitting or overlaying is preferably performed by/on computing device 120. Computing device 120 may also store the blueprints for site 140.

The present technology thus greatly simplifies field automation (FA) by allowing an observer/operator 104 to freely perform walkthroughs in any order at a site/building 140. These walkthroughs or walkthrough portions may be performed as convenient by observer 104 and produce corresponding unordered capture data portions 106A-N. The present technology is then still able to order these portions 106A-N and produce a montage 142 of capture data 106 that is suitable for a given application. Capture data 106 includes video data 108 from one or more cameras 110 on capture apparatus 102 as well as IMU data 112 from IMU 114 onboard capture apparatus 102. Preferably, montage 142 allows the user to access the video footage in video data 108 as well as IMU data 112 at various points during the walkthrough as desired.

Capture apparatus 102 of FIG. 2 is operated by user/operator/inspector 104 per above. The operation of the apparatus includes turning the apparatus on or off, calibrating s 1 camera 110 and/or the IMU sensors 114, checking the overall status of the apparatus among other tasks. Therefore, there is an appropriate human-computer interface provided with capture apparatus 102. Such a human-computer interface may include a touchscreen with an appropriate user interface (UI), or a keyboard and a screen presenting a UI, among other options available in the art. However, in the preferred embodiment, capture apparatus 102 is head-mounted on user/inspector 104 thus allowing for its hands-free operation. Alternatively, the capture apparatus is mounted on a monopod or a “stick” carried by observer/user 104.

The present design also offers a companion device 126 carried by user 104. The companion device enables the user to conveniently issue commands to capture apparatus 102 without having to inconveniently access the apparatus such as by dismounting the helmet. The companion device runs a companion application and has its own UI such as a touchscreen or a screen/keyboard for the user. A companion device is also needed in embodiments where capture apparatus 102 does not have its own UI and thus necessarily has to rely on the companion device for inputting commands and displaying results back to the user. Examples of a companion device include a smartwatch such as smartwatch 126 shown in FIG. 2, a smartphone, a tablet or any other mobile computing device that can be conveniently carried by user 104.

In some embodiments, capture application 130 running on capture apparatus 102 also allows user or operator or inspector 104 to include secondary content 125 such as pictures, notes and/or voice memos taken on/from secondary device 124. Secondary content 125 is thus included in capture data 106. Secondary or supplemental device 124 may be a mobile computing device such as a smartwatch, smartphone, tablet or the like that has a camera/microphone and is easily carried/transported by user 104.

Depending on the embodiment, secondary or supplemental device 124 and companion device 126 may be a single device that is able to take and upload pictures/notes/memos 125 as well as to run the companion application. Secondary content 125 is then utilized by/in montage 142 as needed for a given application.

For example, by clicking at a given point or position on the montage, the user is able to access video data 108 and IMU data 112 from the clicked point. Additionally, the user is also able to access secondary content 125 from the clicked point and in turn the corresponding point/location in the walkthrough. If such secondary content is not available from the clicked point, then the available secondary content from or a point close/closest to the clicked point is retrieved for user 104.

In the case of AEC embodiments, by utilizing an appropriate UI on computing device 120 or secondary device 124 or on companion device 126 (if present) or on capture apparatus 120 itself, user/operator 104 can assign an inspection or capture session to a building/project/site, such as building 140, and specifically to a section/folio of it, such as section 140B. In this manner, any number of inspections may be assigned to a given section of a building. Alternatively, or in addition, the UI allows the user to preassign a capture apparatus, such as apparatus 102 of FIG. 2 or its camera(s) 110 and/or its IMU 114 to a project e.g. project 140.

From then on, any capture data captured by apparatus 102, such as capture data 106 of FIG. 2 is automatically assigned to site/project 140. This also means that any pictures 125 taken by secondary device 124 of montaging system 100 that are contained in capture data 106 are also automatically assigned to that project. Subsequently, the user also the can reassign inspections and any secondary pictures to an individual section, such as section 140B of project 140. Alternatively, or in addition, user 104 can also preassign apparatus 102 and/or cameras 110 and/or IMU 114 to an individual section 140B of project 140.

Depending on the embodiment, one or more of cameras 110 are 360-degrees cameras. Exemplarily, such a camera is one of Theta series cameras manufactured by The Ricoh Company, Limited. Alternatively, camera 110 is an Insta360 series camera manufactured by Arashi Vision Inc. As will be explained further below, having a 360-degrees camera or cameras and/or having omnidirectionality of video footage is not a requirement of the present design.

FIG. 3A shows a workflow 160 based on the present principles that is realized by deploying montaging system 100 of FIG. 2. FIG. 3B is a variation of FIG. 3A as applied to AEC embodiments. More specifically, in step/block 162A, an exemplary observer/user 104A is shown wearing a helmet embedded with capture apparatus 102 of the above teachings. Not all the components of capture apparatus 102 are visible in block 162A, however a camera 110 is explicitly shown. Depending on the embodiment, camera 110 may be a 360-degree camera. Associated step/block 162B of workflow 160 shows user 104A performing a physical walkthrough at a given site or project. For AEC embodiments, user 104A is an inspector and the walkthrough of block 162B is a site/project inspection.

While performing the walkthrough, user 104A is able to access or instruct capture apparatus 102 via a companion device, exemplarily a smartwatch 126A as shown in step/block 164A. Block step 164B shows an alternate handheld companion device 126B. Step/block 166 shows a smartphone as a secondary or supplementary device 124 of FIG. 2 carried by user 104A that may be used to capture secondary pictures, notes and/or voice memos in capture data 102 of the inspection per above teachings.

Then instant montaging system 100 estimates the velocity profile of capture apparatus 102 by deploying non-sequential VIO based on markings 107 as taught further below. It then computes a set of positions of the capture apparatus during the walkthrough based on the velocity profile and constraints 109 conditioning the motion of the capture apparatus per above. Then as shown by block 168A of FIG. 3A, montaging system 100 produces a montage 142A that is suitable for the given application of montaging system 100. This montage 142A is produced and made available via computer application 170 in step/block 170 to user 104B in step/block 174.

As shown in FIG. 3B as a variation of FIG. 3A for AEC, the montage is an estimated path of the inspector that is fit to a blueprint or floorplan of the section of the building being inspected. The system allows the user to manually perform any requisite corrections to the fit per above. These activities of path estimation, fitting of the path to a blueprint and manual corrections are shown by step or bock 168B of FIG. 3B. Step/block 168B visualizes estimated path 111 fit and overlaid onto an underlying blueprint as shown.

Next, as in FIG. 3A, step/block 172 of FIG. 3B shows the GUI of an exemplary computer application 170 of the present design preferably running on computing device 120 shown and discussed in reference to FIG. 2. By utilizing computer application 170, user 104B can perform data validation as well as access montage 142B produced by the system. Visual composition/representation/presentation/montage 142B is suitable for the given AEC application that is enjoying FA benefits from montaging system 100 of FIG. 2. Moreover, user 104B can also perform reporting/querying of/on the results via application 170 as needed.

As will be discussed further below, data validation ensures that all requisite data related to the walkthrough(s) is present in the system. For AEC embodiments, data validation includes assigning or reassigning various inspections to the various sections of the building. Reporting/querying of the results includes querying the system for capture data associated with any point of interest on the estimated path along with video footage or secondary pictures associated with that point, and/or performing any other analyses on the data. Such analyses include querying for capture data 106 or content by location of a section or by an address of a site or by a given waypoint entered by the user among others. Step/block 174 shows user 104B e.g. a supervisor or a foreman performing the above data validation and/or analyses/querying of the system. In FIG. 3A-B, user/supervisor 104B is different from user/inspector 104A, although the two may also be the same user.

In fact, the present design allows for multiple users or observers who may team up collaboratively to perform a walkthrough or inspection. This is especially important for very large commercial sites and projects where it is impractical for a single observer/inspector to perform all the requisite inspections, such In multi-observer or multi-inspector embodiments, all the relevant present teachings apply except that observer/user 104 of FIG. 2 is embodied by multiple users who collectively perform their actions as described.

In such a multi-observer scenario, each observer may carry an instant capture apparatus or one or more capture apparatus may be shared by more than one observer. Thus, one such observer/inspector may perform a walkthrough of one section of the building while another performs a walkthrough of another section and so on. They may then apply markings 107 on data portions corresponding to their walkthroughs per above. Alternatively, the task of applying markings 107 may be shared amongst a subset of the observers. In one variation, the paths taken by each observer are combined and collectively fit to a blueprint of the site for producing montage 142. In an alternative variation, the paths taken by each observer are not combined but individually fit to corresponding portions of the blueprint to produce montage 142.

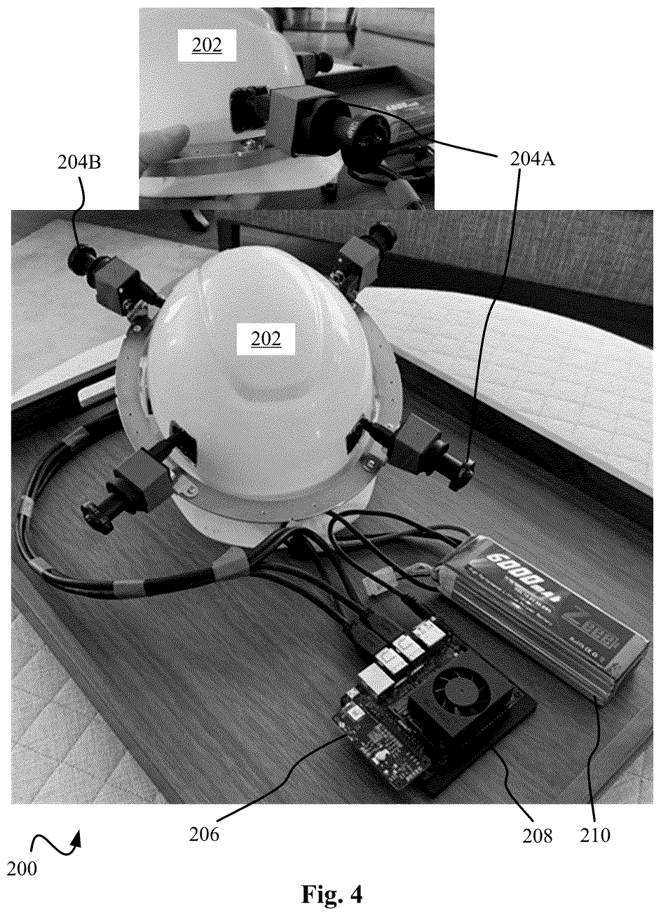

FIG. 4 shows two views of another exemplary capture apparatus of a preferred embodiment based on the instant principles. Capture apparatus 200 shown in FIG. 4 consists of a helmet 202 to which four cameras 204 are attached as shown. The set or array of cameras 104 afford obtaining a complete or partial 360-degree video footage for inclusion in the capture data captured or gathered or collected by capture apparatus 200. Of course, any number of such cameras may be present. Only two of these cameras are marked by reference numerals 204A and 204B to avoid clutter.

In one embodiment, cameras 204 are off-the-shelf cameras, exemplarily, FLIR® Blackfly cameras operating in 8-bit monochrome mode with 2000×1500 pixels resolution at 30 frames per second (fps). In the embodiment shown in FIG. 4 these cameras are non-360-degrees (unidirectional) or standard or regular cameras. Omnidirectionality in such an embodiment is achieved through the use of this array of non-360-degrees cameras 204 and not just a single camera. As discussed herein, however, omnidirectionality is not a requirement of the present design. As a consequence of its non-sequential VIO taught further below, the present technology also allows for video framerate to be different across the cameras.

Capture apparatus 200 also shows an IMU 206. Exemplarily, IMU 206 is a BerryGPS-IMU version 3. Cameras 204 and IMU 206 are operably connected to an onboard computer 208 powered by a battery 210 as shown. Exemplarily, computer 208 is an NVIDIA Jetson Nano embedded computer and the battery is a 600 mAh battery pack. Capture apparatus 200 is carried by a user during inspections for facilitating field automation (FA) per present teachings.

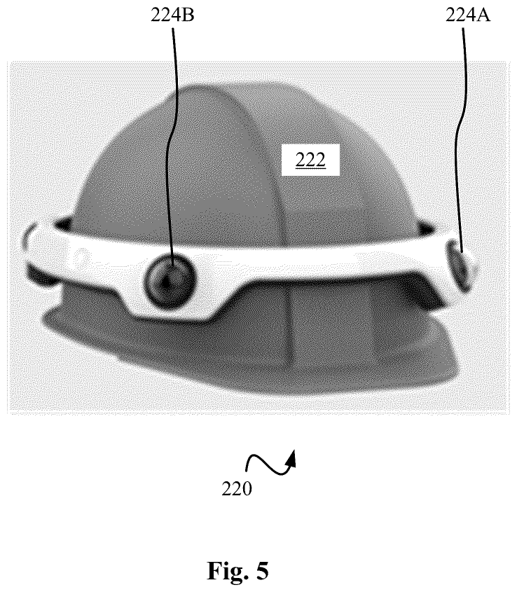

A variety of configurations of capture apparatus based on the present principles are conceivable. These include having a single omnidirectional or 360-degrees view camera on the helmet. These also include having one or more regular or non-360-degrees view cameras on the helmet. This is because having a 360-degree view is not a requirement in order to estimate positions of the capture apparatus during a walkthrough based on non-sequential VIO of the present design. FIG. 5 shows another configuration of a capture apparatus 220. Apparatus 220 utilizes a helmet 222 that has 4 ultrawide-angle cameras 224 mounted to it as shown. Only two of those cameras 224A and 224B are visible and marked by reference numerals in FIG. 5 for clarity.

The preferred embodiments of the present technology utilize 360-degrees or 360-degree imagery, however that is not a requirement as already stated. Depending on the embodiment, the 360-degree imagery can be accomplished using a variety of hardware solutions within the scope of the present design. In one such embodiment, the inspector wears a helmet with a head-mounted 360-camera presently available in the market. In another embodiment, the user carries the 360-camera using a monopod. Even though using a 360-degree camera is not a requirement, there is an advantage in using an omnidirectional capture device. This is because often it is not known beforehand which areas of the environment are noteworthy or important. It is therefore advantageous to capture visual information from all directions simultaneously during the walkthrough.

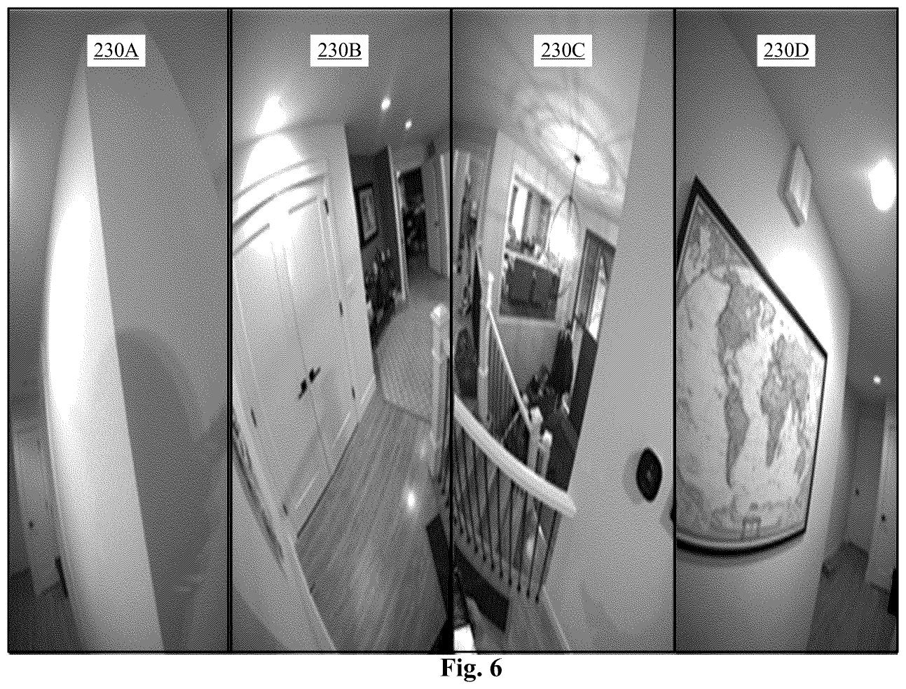

FIG. 6 shows scenes 230A, 230B, 230C and 230D from a video footage using one of the above multi-camera capture apparatus 200 or 220. It is immediately obvious that it is not a full omnidirectional coverage. This is because perfect or full omnidirectionality or 360-degrees/degree view or spherical view is not required by the present technology to accrue its many benefits. Embodiments have been implemented using two or more independent capture devices of limited field of view jointly achieving partial omnidirectionality. Furthermore, the present technology can perform its functions even when gaps in coverage exist. This is because the instant non-sequential VIO is able to process video and inertial/IMU data and is able to combine or “stitch together” unordered or non-sequential video sequences contained in video data and (consequently in capture data).

Referring back to FIG. 2-3, it is to be noted that capture data 106 captured by capture apparatus 106 comprising camera(s) 110 and IMU 114 is necessarily organized “in time”. Specifically referring to video data 108, camera(s) 110 capture video or image sequences that are a representation of reality as it occurred during the time that the camera(s) were operating. These video sequences may be captured in any order by a user such as observer 104. From the raw footage in capture data 106, it is not possible to know if a video scene contains a given part of a building or not.

However, based on markings 107 applied by observer 104 on portions 106A-N of capture data 106 and the ordering performed based on the markings as taught above, the instant technology causes capture data 106 to be subsequently organized “in space”. This allows issuing spatial queries on capture data 106 such as for retrieving capture data/content associated with or closest to a point or region of interest in space. In one embodiment, such a spatial query is issued by user 104 on montage 142 by clicking on a point or region of interest (in space) on an underlying floorplan/blueprint/architectural layout.

In other embodiments, a spatial query may be issued by specifying spatial coordinates or regions associated with points or areas of interest, and thus retrieving capture data 106 associated with or closest to the specified coordinates. For example, the query may be issued for retrieving capture data 106 associated with a region specified by xₘᵢₙ to xₘₐₓ, yₘᵢₙ to yₘₐₓ (and even zₘᵢₙ to zₘᵢₙ), where the min, max values specify a region of interest e.g., a living room, or an entrance. User 104 may also issue an unbounded query by specifying only one set of coordinates e.g. xₘᵢₙ to xₘₐₓ. Capture data 106 thus retrieved is preferably ordered using any ordering/sort criteria, such as in numerically ascending/descending order of the specified coordinates, or in any other order of desired architectural or presentation criteria. Per above, capture data 106 comprises (unordered) portions 106A-N of video data 108 and IMU data 112 shown.

Moreover, user 104 is also able to uploaded secondary images 125 from a secondary device 124. These also become a part of capture data 106 and get associated and become accessible at or near/close to the correct point or junction of montage 142 corresponding to the physical locations where the respective secondary images were taken. For an AEC application, montage 142 is the estimated path that is overlaid onto a blueprint for visualization. User 104 is able to click onto one of several points on the path to access the video footage of the corresponding area of the building, along with any secondary content including pictures and/or notes and/or voice memos from the point or near the point on the path that was clicked.

### (2) Data Validation:

Let us now review the next stage or set of functions (2) in the instant FA workflow 150 presented above. In the preferred embodiments, these functions are afforded via instant computer application 170 discussed above in reference to FIG. 3. This computer application allows a user to perform a number of functions including data validation. Data validation entails ensuring that all data relevant to the capture sessions is present in the system as well as the organization and management of that data. Per above, the functions afforded by computer application 170 also include reporting/querying of montaging system 100, analyzing the data, among others.

For the purposes of data organization and management, we refer to walkthrough data as any data that is relevant to a walkthrough. For AEC embodiments, walkthrough data may also be referred to as inspection data. Thus, one objective of data validation is to ensure that all requisite inspection/walkthrough data is present in the system. Data validation comprises assigning and organizing capture data relevant to the walkthroughs. This includes data about the site or location where the walkthrough was performed, including any clerical information associated with the walkthrough. This also includes capture data 106 discussed in reference to FIG. 2 above and collected by capture apparatus 102 as well as any details about the capture apparatus or device(s) themselves.

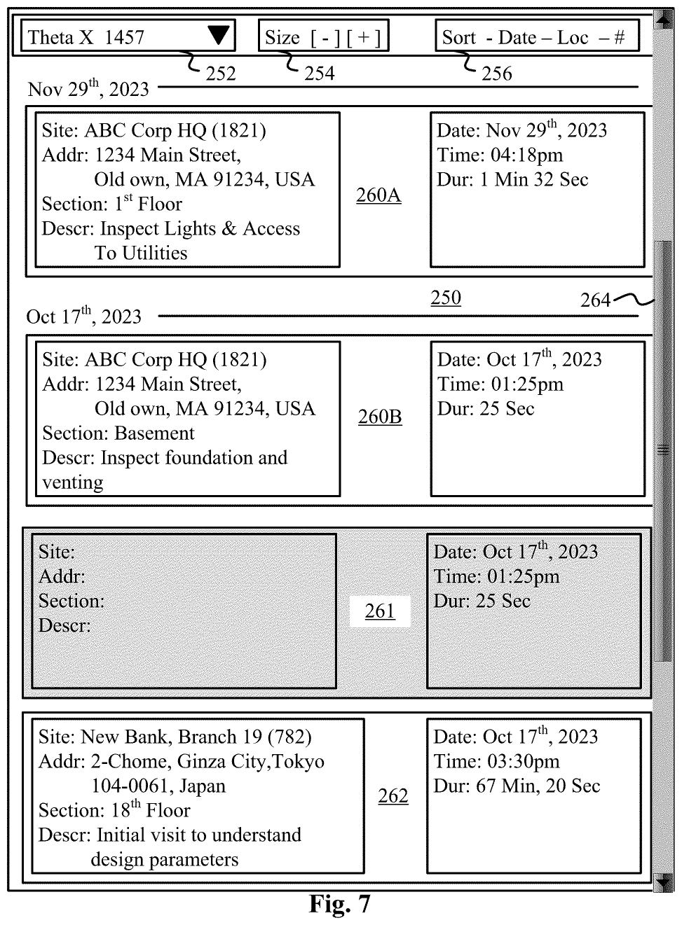

FIG. 7 shows inspection dashboard and more precisely its mockup 250 from an exemplary GUI of a computer application that provides inspection data organization and management for AEC embodiments. Exemplarily, the computer application is application 170 discussed in reference to FIG. 3. The computer application is preferably built as a web-application. As such, mockup/dashboard 250 is a webpage with familiar scrollbars, such as vertical scrollbar 264 as shown. Preferably, the computer application takes advantage of remote storage resources 116 and compute resources 122 in cloud 118 per FIG. 2 discussed above.

Inspection dashboard 250 shows the various inspections performed using the selected capture apparatus and presented according to various criteria. More specifically, inspection dashboard 250 shows the inspection data or simply inspections for short, performed using a device named Theta X 1457 as selected by the user using dropdown menu or box 252. The inspection data is sized using the sizing/zooming box 254 by the user and sorted using sorting box 256 as shown. The implementation of FIG. 7 shows the sort criteria implemented as data/time, location and the hashtags present in the data or extracted from its description.

The various inspections shown are inspections 260A and 260B belonging to the same project/site/address as well as inspection 262 belonging to a different project/site/address. The inspections shown occurred on two different dates, November 29th 2023 and October 17th 2023 as shown. Each inspection box in GUI dashboard 250 shows the name and address of the client/owner and project or site or building for each inspection along with a short description, duration, time, etc. of the individual inspection.

The objective of inspection dashboard 250 is to present inspection data of the various inspections to the user organized by criteria of user's choosing. In one embodiment, the inspections are grouped according to the device used to capture the data. In another embodiment, inspections are grouped according to the user. In a preferred embodiment, a multi-tenant approach is used where inspections are siloed and separated by user groups belonging to different organizations. In yet another embodiment, the inspections are sorted by the date of inspection.

In another embodiment, inspections are searched by hashtags present or extracted from their description. In another embodiment, inspections are sorted by the project name or whether the inspections belong or not to a project. A practitioner will recognize that numerous criteria can thusly be used to sort, index or search inspections.

Inspections are useful once they are assigned or attributed to a project, and specifically to a page or folio of the project. Construction projects, for example, consist of several pages of blueprints, each for a different section or area of the building.

A page or folio refers to a floor, wing, section, level, or area of the building. A page or folio may refer to a subsection of a larger area, such as a dining hall or lobby. In other words, a folio is a part of the facility that project management thinks is important enough to have its own blueprint.

In one embodiment, each project is assigned a name, address, and description. In another embodiment, each folio is also assigned a name and a description. In an embodiment, an inspection is assigned to a project by the user after capture (e.g., as part of Editing/Confirmation as discussed further herein). In the same or a related embodiment, camera devices are preassigned to specific projects or areas, in which case inspections are assigned to projects automatically. In yet another embodiment, inspections can be reassigned to different projects or assigned to multiple projects.

Any project shown in the inspection dashboard that has incomplete information e.g. it does not have a site information or it does not have an address or description is shown as greyed in dashboard 250. As such, project 261 is shown in grey in FIG. 7 because it does not yet have site information. In other words, it has not yet been assigned to a site or project. Therefore, the user can click on inspection box 261 and assign it to a project and/or enter any requisite information. This function of ensuring that all requisite information about an inspection has been entered into the system is accomplished in the present data validation stage of FA workflow 150.

In the preferred embodiment, the requisite data for an inspection includes site information, such as name, address, description and section information where the inspection(s) were performed. The requisite data also includes the floorplan or the blueprint of the sections or folios of the site where inspection(s) were performed.

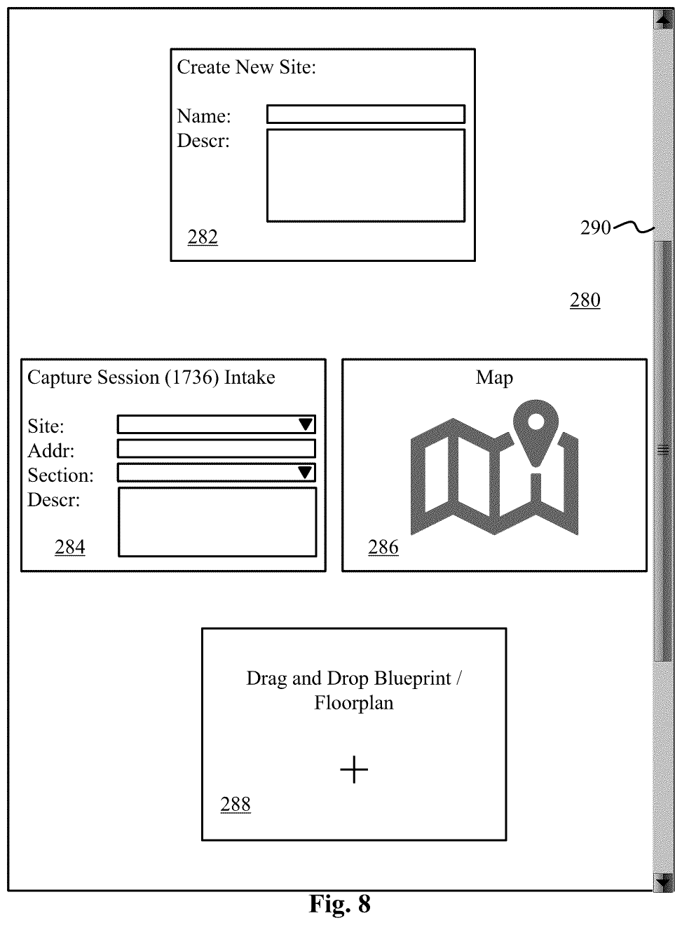

FIG. 8 shows a mockup 280 of the webpages from above-discussed computer application 170 responsible for the data validation tasks of FA workflow 150. Mockup 280 shows a web-based dialog box 284 using which a user can associate a capture session or inspection e.g. capture session 1736 shown in FIG. 8 to an existing Site using the shown dropdown menu. Once an existing site has been selected, the user can then select a section of the site from the dropdown menu shown. The user can also enter an address for the site using the map widget 286 as shown.

There is also a data entry form 282 using which a user can create a new site into the system if needed. The drag-and-drop box 288 allows user to add a blueprint/floorplan file for the selected section per dialog box 284 for capture session 1736. Thus, user has the option to enter any data associated with the inspection or capture session if it does not exist or to update/modify it if it already exists. Finally, there is the familiar vertical scrollbar 290 on webpage/mockup 280 as shown in FIG. 8. Depending on the width of webpage 280, there may also be a horizontal scrollbar and which is not shown in the view of FIG. 8.

The principles of data validation for AEC embodiments detailed above are easily extended to other applications of montaging system 100 of FIG. 2 according to the data requirements and characteristics of such applications.

### (3) Estimating Velocity Profile and Positions of the Capture Apparatus:

Referring still to FIG. 2-3, once above data validation tasks have been completed, system 100 is ready to estimate the positions of capture apparatus 102 carried by user/inspector 104 during a capture session in this stage (3) of FA workflow 150.

Per above, for AEC embodiments, these positions trace a path of the capture apparatus during a walkthrough. The number crunching or the “heavy lift” performed in this present stage (3) of workflow 150 is preferably performed by a backend that is implemented on cloud compute resources 122 shown in FIG. 2.

The frontend is preferably provided by computer application 170 of FIG. 3 discussed above. Among others, the frontend functions provided by application 170 include initiating, pausing, and resuming the estimation of velocity profile and positions. The application preferably utilizes cloud storage resources 116 and cloud compute resources 122. Preferably, cloud compute resources 122 comprise a serverless architecture, such as the one provided by Amazon AWS® Lambda. Serverless code is event-driven, allowing for scaling to meet elastic demands. It is typically offered by a micro-billing pricing for which the practitioner only pays for the actual runtime used.

For AEC applications, computer application 170 in concert with the above-descried backend performs algorithmic analysis of capture data 106. It does so in order to estimate the positions of capture apparatus 102 during the walkthrough(s). For AEC, these positions trace or reconstruct the walkthrough path(s) of inspector 104 carrying apparatus 102. Path estimation is also sometimes referred to as path generation and is preferably implemented using a serverless computing architecture as noted above.

For many technical, environmental, user experiential and business reasons, sequential processing of video or image data 108 of FIG. 2 is not desirable. What is needed instead is a non-sequential approach where video data can be processed out-of-order, in parallel, and even with missing video data. Based on the instant principles, the positions/path of observer 104 and in turn capture apparatus 102 is/are not computed/estimated directly. Instead, the present design computes/estimates/generates a velocity profile of the capture apparatus first. It then computes/estimates/generates the positions/path through a constrained integration of the velocity profile.

In principle, if we have the velocity profile and a known (typically initial) position, we can then numerically integrate the velocity to compute position. However, any errors in velocity accumulate during numerical integration and this naïve approach of the prior art does not work. As per the present principles, if we have additional constraints, such as constraints 109 of FIG. 2 discussed above, that condition the motion of capture apparatus 102, we can then postulate the existence of an adjustment or variation signal that is added to the velocity profile.

These constraints can be derived from markings 107 applied to portions 106A-N of capture data 106, as well as any additional applied constraints. Exemplarily, constraints 109 include waypoint markings 107 designating start/end positions of the walkthrough discussed above. Constraints 109 also exemplarily include corrections entered by user 104 to the estimated positions of capture apparatus 102. Constraints 109 are also exemplarily derived from landmarks and fiducial markers as discussed above.

According to the instant design, the estimated velocity of capture apparatus 102 is discretized in a number of samples. In other words, the velocity is estimated in discrete samples, and the entire collection of such velocity samples is referred to as the velocity profile. If the velocity profile is “good” in the sense that the errors are more or less evenly distributed across capture data 106, then we can compute the most parsimonious adjustment/variation signal satisfying constraints 109.

In one embodiment, a parsimonious variation is modeled as minimizing the sum of squares of the adjustments of all samples of the velocity profile. In yet another embodiment, a parsimonious variation is modeled as minimizing the sum of weighted squares of the adjustments for all samples. In a variation of the above embodiment, the weights are proportional to the instant speed derived from the velocity profile.

In general, we cannot derive a “good” velocity profile by simply integrating numerically the accelerometer values of an IMU sensor, such as IMU 114 of FIG. 2 or IMU 206 of FIG. 4. This is bound to fail with real data, because any errors in acceleration will accumulate during numerical integration. The errors here are not just because of noise in the accelerometer readings. In fact, the main complication is due to gravity.

Accelerometers measure acceleration both due to gravity and due to accelerating motion. The latter is called linear acceleration in the IMU literature. To estimate linear acceleration, one must remove the effect of gravity. And to remove the effect of gravity one needs to estimate the orientation of the device with respect to the ground plane (perpendicular to the gravity of Earth).

The present approach first employs a State Estimator that processes IMU data 112 of FIG. 2 in order to estimate various properties of capture apparatus 102. These include angles ϕ (roll/tilt) and θ (pitch/pan, with respect to the ground plane) as well as yaw speed or angular velocity dψ/dt (about gravity). These also include gyro drift and linear acceleration in a floating reference plane that is parallel to the ground plane but rotated according to the (yet unknown) yaw. In a manner analogous to the discretization of the velocity profile above, the orientation is also measured in a discrete number of samples, and the entire collection of such samples is referred to as an orientation profile.

Given an estimate of yaw speed we again use constrained integration approach to recover yaw across the entire orientation profile if we have additional constraints 109. Such constraints 109 include known start/end locations or reference points, known headings or “compass points” at the project/site, amongst others. We can now also postulate the existence of an adjustment or variation signal that is added to the yaw speed profile. If the yaw speed profile is “good” in the sense that the errors are more or less evenly distributed among all orientation samples, then we can compute the most parsimonious adjustment or variation signal such that the above additional constraints 109 are satisfied.

In one embodiment, a parsimonious variation is modeled as minimizing the sum of squares of the adjustments of all samples. In another embodiment, a parsimonious variation is modeled as minimizing the sum of weighted squares of the adjustments for all samples. In a variation of the above embodiment, the weights are proportional to the instant yaw speed derived from state estimator.

So, now we have orientation estimates for pan, tilt, and yaw across the entire orientation profile (i.e., all samples). We can use these orientation estimates to remove the effect of gravity and estimate the linear acceleration across the orientation profile. One might then be tempted to again perform constrained integration to produce velocity. But the linear acceleration estimates are not “good” in the sense that errors are not evenly distributed and cannot be corrected by simply computing a parsimonious adjustment or variation.

Depending on the embodiment, now optical adjustments are employed to improve the signal. Explained further, we divide the inspection footage into video blocks of short duration (e.g., 1 seconds or 2 seconds), but not necessarily of constant duration across all portions of video that are available. Recall that a subset of portions 106A-N of capture data 106 may be selected whether due to technical necessity or by user choice to be included in this downstream processing. That is, there are time periods without any video blocks. Thus, the video blocks do not necessarily form an uninterrupted sequence.

Now, each video block is processed as follows:
(a) frames are extracted from video using known techniques,
(b) features are detected and tracked across frames using known computer vision techniques, and
(c) structure from small motion (SfSM) based on the present design is computed.

SfSM produces a local estimate of the camera motion and a (typically sparse) three-dimensional (3D) point cloud with respect to the first camera position. Both the local motion estimate and 3D points are relative to each other and lack absolute or physical scale. Now we compute a velocity estimate for each video block. We perform a joint optimization per video block comprising of the following steps:
1. The SfSM local motion with respect to the first camera position for the given video block is computed.
2. The orientation estimates are computed as explained above.
3. Accelerations in the body reference frame of the capture apparatus/unit are measured.
4. Through joint optimization, we find the instant velocities, pan/tilt with small variations and local scale such that the SfSM output agrees with the local kinematic path computed through numerical integration over the video block duration. We call this step the SfSM+KIN joint optimization.

The output of the above is a velocity estimate for each video block processed.

We now have a set of velocity estimates per video block computed using optical information. However, these estimates are not dense. The final step is to compute the full velocity profile using these sparse set of estimates in conjunction with the orientation estimates and optionally the accelerations in the body reference frame. There are a number of approaches of solving this reconstruction problem, such as using interpolating splines, statistical techniques and machine learning approaches.

As a key contribution to the field, the present design can process video/image blocks out-of-order or independently or in parallel, skip blocks to save computation and/or bandwidth, and ignore missing video/image data. This non-sequential or parallel or independent processing of blocks of capture data 106 is a key contribution afforded by instant non-sequential or sparse or discontinuous or piecewise VIO. As a further capability of the present non-sequential design, recall the above discussion about unordered or out-of-order portions 106A-N of non-sequential capture data 106. To summarize, the present non-sequential design affords non-sequential capabilities not only to the collection of capture data 106 as well as to its (downstream) data processing.

The main distinguishing features of the present non-sequential VIO include:
1. SfSM blocks are processed independently of each other.
2. Velocity estimates per video block are also computed independently of each other.
3. The velocity profile is computed from a sparse set of velocity estimates from (2) above. These velocity estimates may be expressed as (vₓ, v_{y}, v_{z}) for each discrete sample of the velocity profile.

The final estimate of the walkthrough positions of capture apparatus 102 also includes orientation of the camera(s). That is to say that the final path estimated using the instant non-sequential visual inertial odometry (VIO) includes the full pose of each camera.

Intuitively, the “visual” component of capture data 106 of FIG. 2 i.e. video data 108 provides velocity reset or correction information although it may do so sparsely. In general, there can be other sources of velocity resets or corrections that may also be sparse. In one embodiment, user 104 indicates via waypoint markings 107 known stops or pauses which are de facto velocity estimates of zero. In another embodiment, the stops or pauses are detected automatically based on a motion saliency signal derived from raw IMU data. In yet another embodiment, the velocity estimates can be produced by a second vision process using a technique distinct from SfSM, such as “optical flow” as known in the art.

The estimated positions of capture apparatus 102 using the present non-sequential techniques can be used for a variety of purposes other than field automation (FA). They can be used for organizing or locating captured data/content 106 in general, and on a blueprint or a floorplan in particular. As noted above, the set of estimated positions trace a path of the capture apparatus and that is desirable for an AEC application or for any application for which estimating such a path is useful.

In other applications of the present techniques, the set of estimated positions is sparse and spatially arranged to be navigation points in a 360 virtual panoramic tour of capture data 106 as montage 142. Montage or spatial/visual composition/presentation/representation or visualization or arrangement 142 may be driven by UI/UX considerations completely unrelated to the walkthrough order. Simply put, the set of estimated positions can be used for creating any desired montage 142 for emulating a virtual scanning device using manifold stitching techniques.

Depending on the embodiment, montage 142 of FIG. 2 may be a virtual fly-through and/or a hyperlapse. It can also be used for producing high-quality 3D measurements by post-processing the video data with stereo-based techniques using the estimated path as a prior evidence or belief. Another embodiment uses the estimated path and the collection of sparse 3D point clouds from the processed SfSM video blocks to compute dense 3D data through depth densification.

To recapitulate, walkthrough positions/path estimation/generation based on instant non-sequential VIO comprises of the following sets of operations:
1. Process IMU data and compute an initial kinematic profile (KIN):
   a. Using the instant state estimator discussed above, estimates are computed for pan/tilt (with respect to the ground plane), yaw speed (about gravity), gyro drift and linear acceleration in a floating reference plane parallel to the ground plane but rotated according to the (yet unknown) yaw.
   b. From the initial or final heading that may be determined automatically, or entered manually, yaw is recovered across the orientation profile through constrained integration per above.
   c. Given the estimate for yaw, linear acceleration is computed with respect to the absolute reference frame. In one embodiment, the absolute reference frame is parallel to the ground plane with origin set at the initial position of the inspection/walkthrough.
   d. Using waypoint information, determine the time instants for walkthrough stops or pauses. This step can be augmented through motion saliency analysis to detect pauses that were not explicitly indicated by the user.
   e. By enforcing the constraint that linear velocity should be zero at the stop instants, velocity is estimated through constrained integration across the velocity profile.
   f. The results of (a) through (e) comprise the initial kinematic profile (KIN).
2. Process the video data in video blocks of short duration. Per above, this duration may be 1 seconds to 2 seconds, but does not necessarily need to be constant across all the video blocks. The video blocks do not necessarily form an uninterrupted sequence.

For each block, perform the following operations:
a. Extract frames.
b. Detect and track features for the duration of the block.
c. Compute structure from small motion (SfSM) per above.

As already noted, video blocks be processed independently and concurrently. In a preferred embodiment, this is accomplished using a serverless computing architecture. An exemplary implementation utilizing such serverless cloud computing resources is indicated by reference numeral 122 in FIG. 2. Serverless vendors offer compute runtimes, also known as Function as a Service (FaaS) platforms (e.g., Amazon AWS® Lambda).

In one embodiment, a function is defined for each type of block operation (i.e., frame extraction, feature extraction and SfSM). According to key aspects, multiple instances of each function can be launched simultaneously to process the blocks concurrently. In another embodiment, a task queue is associated to each block allowing sequencing of tasks. This allows all block operations to be triggered by a single action.

3. Through SfSM+KIN joint optimization, compute a sparse set of instant velocities, pan/tilt with small variations and local scale such that the SfSM output agrees with the local kinematic path over the video block duration.

4. The full velocity profile is reconstructed using the sparse set of instant velocities in conjunction with the orientation estimates and optionally the accelerations in the body reference frame. Estimation of the walkthrough positions/path is performed through constrained integration based on constraints 109. Such constraints 109 conditioning the motion of capture apparatus 102 may be derived in a number of ways and from a number of sources including presentation requirements of spatial/visual composition/presentation/representation/montage 142. We now have a set of estimated positions of moving capture apparatus 102 that was carried by a user, such as user/inspector 104 of FIG. 2.

### (4) Produce a Montage or Visual Composition Based on the Positions of the Capture Apparatus:

While still referring to FIG. 2-3 and related discussion, let us now review the next stage or set of functions (4) of our FA workflow 150. In some embodiments, including real-estate embodiments, the set of positions of the capture apparatus are used for placing panoramic images to create a 360 virtual tour. In other embodiments, including real-estate embodiments, the set of positions may trace a path of the capture apparatus and the path is then fitted to a floorplan of a house or building.

Based on its non-sequential design, the present technology is able to aggregate/combine unordered portions 106A-N of capture data 106 in the order most advantageous to a desired montage 142. Therefore, as another example, observer 104 may decide to perform a walkthrough of a bedroom first, and then the living room and the kitchen, and then the garage. Then, the montaging of capture data into the desired montage may consist of a hyperlapse visualization starting at the living room and kitchen, moving into the bedrooms, and ending at the bathrooms. The present technology can organize portions of capture data 106 from the order that they were captured “in time” i.e. 106A, 106B and 106C to arrive at an aggregated hyperlapse path that is organized “in space” or “in presentation space” i.e. 106B, 106A, 106C. Such a hyperlapse is useful for real-estate or other applications.

Note, that floorplan is the commonly used term in real-estate, while blueprint is more commonly employed in AEC. In the case of AEC embodiments, the set of estimated positions trace the walkthrough path. The set of positions of the capture apparatus estimated/generated above is then algorithmically fit/fitted to the blueprint of the site section or folio where the inspection was performed.

We will now describe the process of producing montage 142 for such AEC embodiments by fitting the path to a blueprint. However, the techniques described below can be extended to other embodiments in general for producing visual montages based on the set of estimated positions of capture apparatus 102.

The present design recognizes that in practical terms, the blueprint is at best an “aspirational” representation of the reality of a site/section, and not the actual reality. Unlike the techniques of the prior art, it therefore applies the walkthrough path or simply path to the blueprint holistically and not locally. Therefore, in some embodiments, user inputs are utilized by the instant algorithm to ensure the best fit to the blueprint.

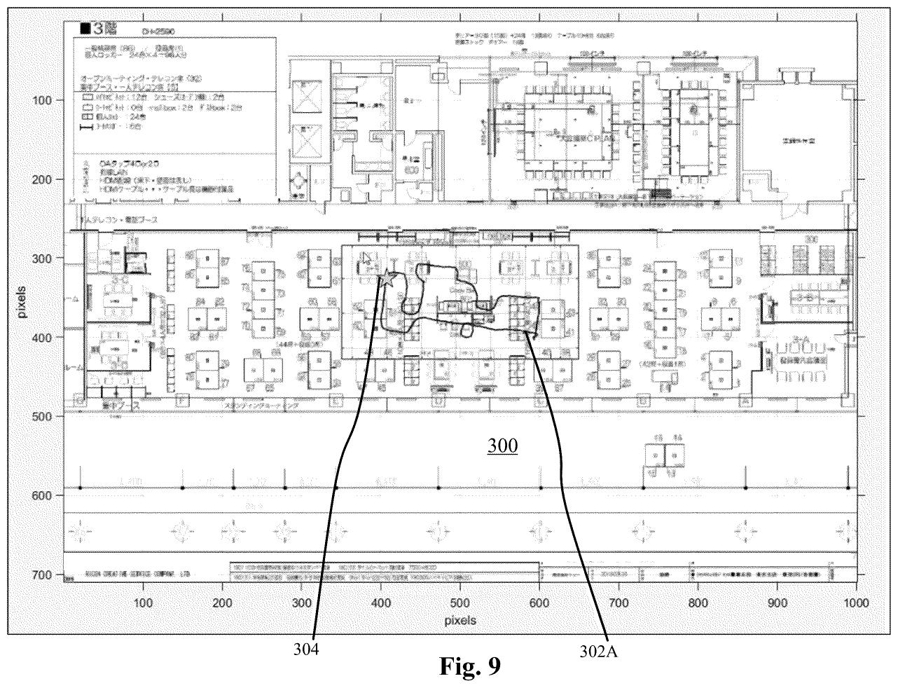

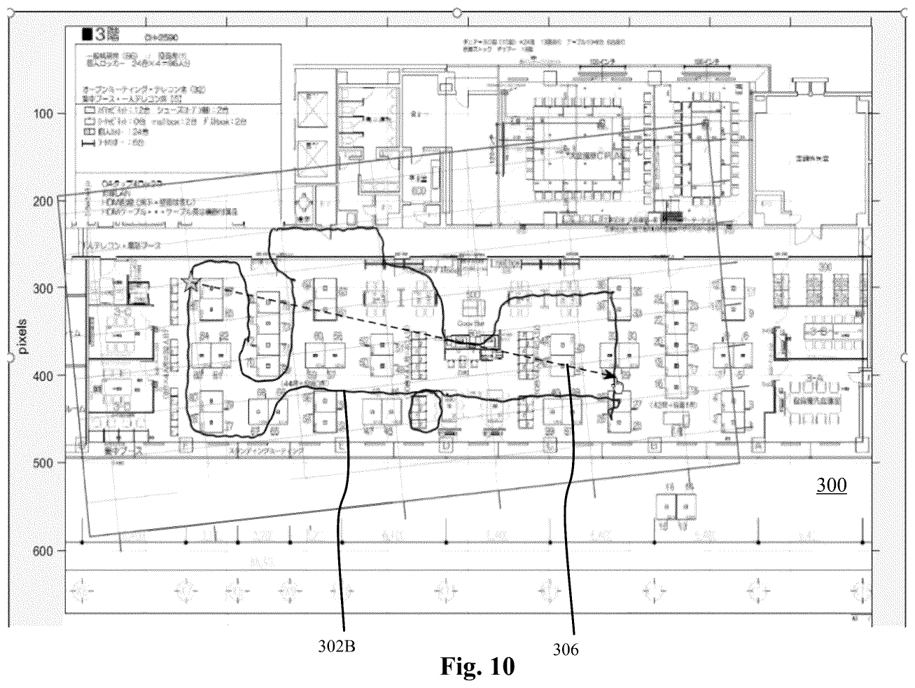

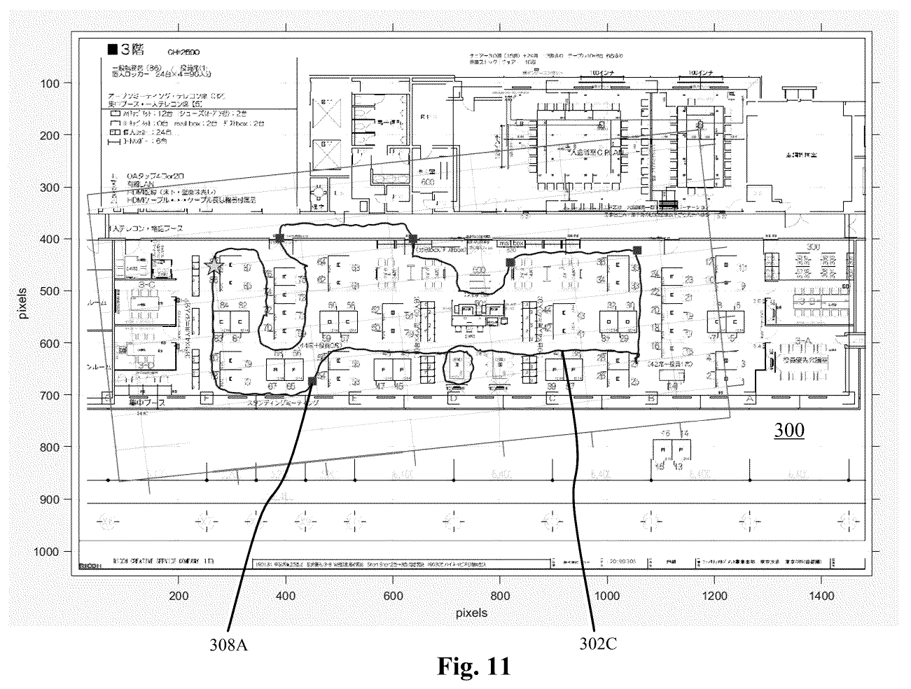

The fitting algorithm comprises the following set of actions in order to achieve its objectives.
1. Apply constraints 109: Per above, we state that constraints 109 condition the motion of capture apparatus 102. A base constraint is applied to the first and the last positions i.e. the start/starting point and the end/ending point of the walkthrough.
The base constraint sets the starting point and ending point of the walkthrough at respective specific locations on the underlying blueprint. Of course, these locations on the blueprint ultimately map to specific physical locations at the site. In one embodiment, the base constraint requires that the starting and ending positions be the same, thus forming a closed-loop walkthrough.
In the same or a related embodiment, additional constraints 109 are applied based on cues or hints originating from a variety of sources. For example, observer/operator 104 may visit predefined checkpoints (e.g. entrance/exit) at the site during the walkthrough. These checkpoints thus apply constraints conditioning the motion of the operator during the walkthrough because we know the true position/location of the observer at those checkpoints.
In the same or a related embodiment, additional constraints 109 are derived from optical fiducial markers or landmarks or reference points or checkpoints at known locations at the site. These fiducial markers/landmarks can be detected by the camera using computer vision techniques, and their locations can already be known or determined through triangulation or trilateration techniques.
These fiducial markers or landmarks are thus used as a basis to apply constraints 109 conditioning the motion of capture apparatus 102 because its true positions/locations at those markers/landmarks are known. Similarly, constraints 109 conditioning the motion of capture apparatus 102 may be based on known headings or compass points at the project/site. This is because the true orientation of the capture apparatus at those points is known.
Still other constraints 109 conditioning the motion of capture apparatus 102 based on the presentation requirements of montage 142 may be applied. For example, a user can enter corrections as per step (6) below to fit estimated positions/path of capture apparatus 102 to a distorted floorplan or a hand-drawn blueprint. The user can do that by placing appropriate checkpoints on the underlying floorplan/blueprint.
2. Compute velocity profile: The velocity profile consists of the velocity of capture apparatus 102 computed at every time instant of the walkthrough path. Depending on the embodiment, the time instant can be at any practical level of granularity such as a every few seconds, every second or even lower.
3. Determine initial scale: Determine an initial scale based on integration of the initial velocity profile. FIG. 9 shows an exemplary blueprint overlaid with an exemplary path 302A with an initial scale as shown. A yellow star in FIG. 9 represented by reference numeral 304 marks the starting point for the path.
4. Compute velocity adjustments: From here on, the values of the velocity in the velocity profile are adjusted in order to satisfy constraints 109 set above. This is a variational problem, where the goal is to find adjusted velocities satisfying applied constraints 109 after integration.
In one embodiment, these adjustments are multiplicative factors applied to the pre-adjusted velocity values i.e., each velocity value is adjusted by scaling up or down its original value.
In a preferred embodiment, the velocity adjustments are determined by minimizing a minimum norm defined over the aggregate of the velocity adjustments. A minimum norm solution can be effectively found using Moore-Penrose inverse (also known as pseudoinverse) when the norm is the L2 norm. This then becomes a linear problem. In another embodiment, the multiplicative factors are required to be non-negative, and the problem can be solved using linear programming techniques for the L1-norm case or by quadratic programming techniques for the L2-norm case.
Initially, only the base constraint set above is enforced, and the adjusted velocities yield an initial estimate of the walkthrough path. FIG. 10 shows blueprint 300 of FIG. 9 where the user is using dashed line 306 to scale and rotate this initial estimated path 302A of FIG. 9 in order to arrive at placement 302B of FIG. 10. Not all elements from FIG. 9 are marked in FIG. 10 to avoid clutter.
This step of computing velocity adjustments is repeated whenever any of constraints 109 changes. In one embodiment, new constraints 109 are added based on interactive corrections provided/entered by the user (see Step 6 below).
5. Compute confidence measure: A confidence measure is determined based on the quality of results of the SfSM+KIN joint optimization described earlier. If the agreement between SfSM and KIN analysis was higher, the confidence measure is higher and vice versa. The confidence measure is used to weight the scale changes above. In other words, more forceful or higher adjustments to velocity are required in sections or areas where the confidence measure is lower.
6. Apply corrections and perform fitting: In the preferred embodiment, the corrections are based on manual inputs by the user. FIG. 11 shows blueprint 300 and estimated walkthrough path of FIG. 9-10 for the embodiments where the corrections are made/entered by the user. The correction points are shown by small squares/dots 308 in FIG. 11. As needed, the user drags the squares to adjust/correct the path around blueprint 300. Only one such square is marked by reference numeral 308A to avoid clutter. As a benefit of the present technology, a handful or very few of such corrections or cues are needed from the user to obtain an acceptable fit of the path to the blueprint.
Based on the corrections, new constraints 109 are obtained. Further, new/adjusted velocities are calculated as described in step (4) above, a new corrected path is computed through integration of the newly adjusted velocities, and the above process is repeated until a final or acceptable fit is obtained. Note that when integrated, the adjusted velocities are required to satisfy the base constraint above. FIG. 11 shows such a final fit of walkthrough path 302C to blueprint 300 of FIG. 9-10. Again, not all elements from FIG. 9-10 are marked in FIG. 11 for clarity.
In alternative embodiments, the corrections may also be derived programmatically. For example, a set of noteworthy checkpoints or reference points is determined beforehand through automatic analysis of architectural floorplans. Such analysis computes a set of expected visual elements at each checkpoint, which are in turn detected and recognized by the camera using computer vision techniques. See “Automatic floor plan analysis and recognition” by Pizarro et al. (Journal of Automation in Construction, Vol. 140, 2022) for a review of automatic procedures for analyzing architectural floor plans of raster images. The path is then programmatically fit to the blueprint based on these checkpoints.

### (5) Additional Reporting and Analysis:

In this stage or set of functions (5) of FA workflow 150, the user can perform additional reporting and analysis in montaging system 100 of FIG. 2, after a desired montage 142 of captured data 106 has been obtained per above. For the AEC embodiments discussed above, the montage took the form of a walkthrough path fitted to a blueprint. Note, that this stage (5) and prior stage (4) of the workflow may overlap in terms of user experience and functional details depending on the implementation. In either case, based on the instant design, user 104 can query the system and generate a variety of reports from montaging system 100.

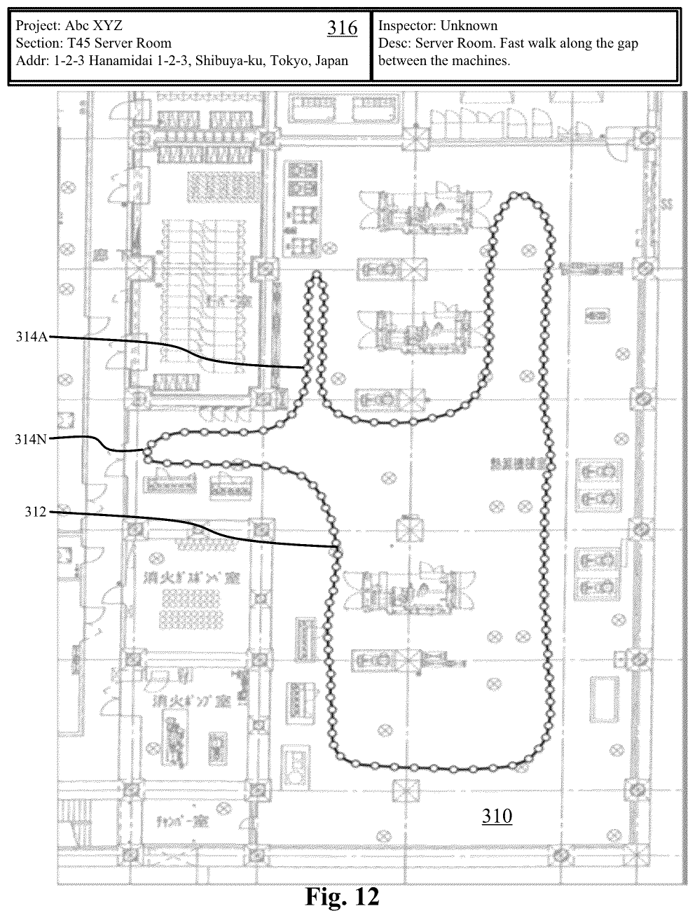

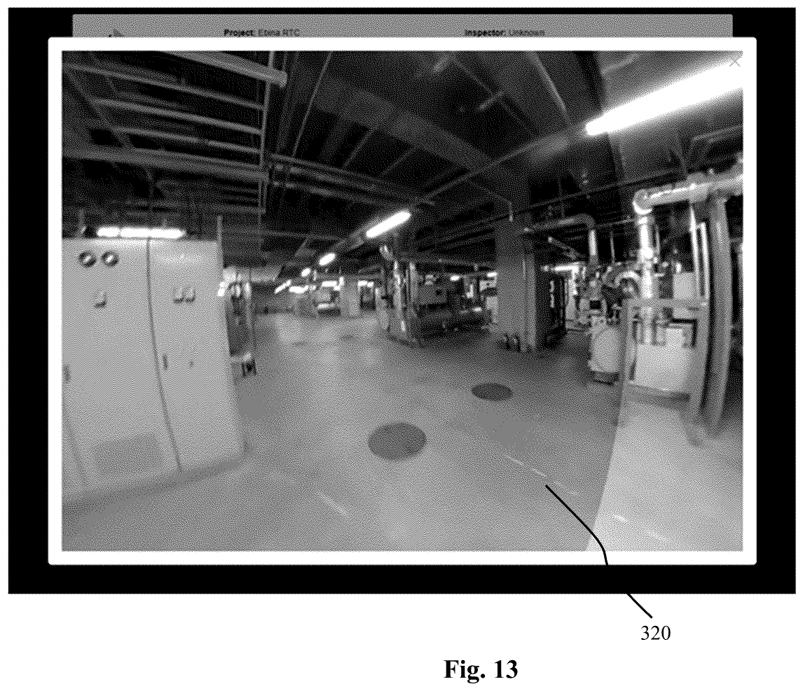

An exemplary report for AEC embodiments is illustrated in FIG. 12. More specifically, FIG. 12 shows a blueprint/floorplan 310 onto which a reported path 312 of an inspection has been overlaid based on the above teachings. Relevant inspection data is shown in text box 316. Each circle or point on path 312 is clickable. Only two such circles are explicitly marked by reference numerals 314A and 314N to avoid clutter. Once the user selects a circle along the path, the instant system opens a modal window displaying the relevant content. FIG. 13 presents such an exemplary modal window showing a 360-degree view 320 associated with a particular circle/point on path 312 of FIG. 12.

Recall from above that the objective of montaging is the creation of a montage or the production/generation of suitable visual composition of captured content 106. The report in FIG. 12 is truly a montage of captured data 106 discussed in reference to FIG. 2. In fact, path 312 shown in FIG. 12 is a “reported path” and may not entirely correspond to the physical walkthrough performed by observer/user/operator 104. Such a path that would correspond completely to the walkthrough may be excessively dense and contain “knots” and “wiggles” that are distracting.

Therefore, reported path 312 shown in FIG. 12 is a decimated version of the original walkthrough path, where the decimation occurs along an arc-length (not time). The decimation is also responsive to the pixel size of the drawn circles 314. As a result, drawn circles 314 never overlap and can be clicked easily by the user. Reported path 312 in FIG. 12 also acts as a visual navigation tool for the user to interact with the 360-degree content. In one embodiment, reported path 312 is a reduced set of locations at key areas of the blueprint and the report is a 360 virtual tour. In another embodiment, the blueprint is organized in a grid layout, and only one location is selected per grid.

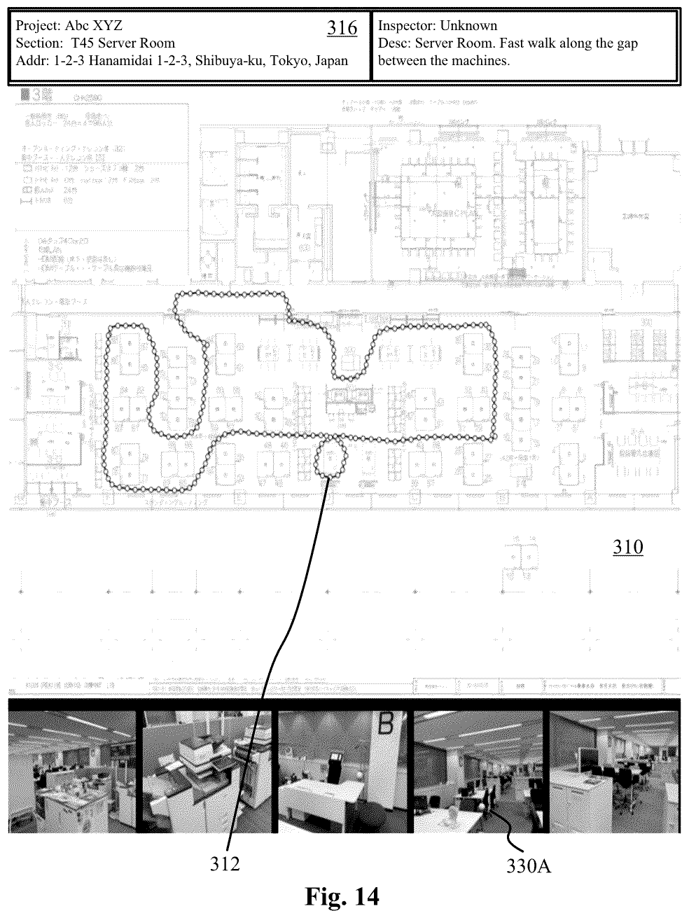

In yet another embodiment, the system allows the user to create shareable and obfuscated links to the final report, such as the one shown in FIG. 12. After sharing, the shareable links may also be preferably revoked by the user. FIG. 14 shows montage 142 from an embodiment that allows the user to upload secondary photos 125 captured with a supplementary device 124 (e.g., a smartphone) and associate these with an inspection per above teachings. More specifically, FIG. 14 shows blueprint 310 of FIG. 12 with a gallery of secondary photographs or pictures 125. One such picture 330A is marked explicitly for clarity. The montage of FIG. 14 may be referred to and accessed as a report from system 100. Upon clicking on a picture, a modal window displays a larger version of the photograph, such as the one shown in FIG. 13. Not all the elements from FIG. 13 are marked in FIG. 14 to avoid clutter.

In other embodiments, the user can query the system for content based on the location of the inspections, by time, by a capture session id, by a drop pin, among other search/query criteria. A drop pin is a GUI widget afforded by the present technology to mark a point on a reported path on the blueprint. Once a user clicks on the drop pin, any relevant data associated with the location on the section/site at or near that drop pin is displayed to the user in a modal window. This data includes capture data (including any secondary data), and preferably any other ancillary data as needed.

In a logistics/warehousing embodiment of the present technology, observer/operator/user 104 of FIG. 2 performs a partial or complete walkthrough of a warehouse 140 in order to analyze the stocking and picking quality/habits of warehouse employees. This is very useful because it is impractical or unpalatable to instrument cameras throughout a warehouse. Once the walkthrough has been done, then the user can easily generate a montage or a report from montaging system 100 and more specifically from its computer application 170.

In one embodiment, montage/report 142 comprises a path of the user overlaid onto the floorplan of the warehouse per above teachings. In another embodiment, montage 142 is based on a set of positions overlaid on a grid layout representing the aisles and bins of the warehouse without overlaying the walkthrough path. A user can now conveniently click on a circle at or near a desired bin in the warehouse to retrieve a video or secondary content/pictures showing how the bin is being stocked or picked.

Now let us review a set of highly preferred embodiments based on the present technology. These embodiments are specifically directed to the data capture technology of the present design and are thus accrued by the data capture systems and methods taught below. All the relevant teachings of these data capture embodiments also apply to the prior embodiments.

While first referring to FIG. 2, the present embodiments are especially suitable for the collection and capturing of video data 108 and IMU data 112 from camera(s) 110 and IMU 114 respectively of capture apparatus 102 taught above. The data thus captured i.e. capture data 106 may then be used for a variety of purposes, including estimating of the positions of capture apparatus 102 and for producing montage 142 of capture data 106 as discussed above.

The objectives of the present embodiments are achieved by capture application 130 introduced above and which runs on capture apparatus 102 by utilizing the computer resources thereon. These resources include compute, storage and networking resources per prior teachings. There is a backend application or simply a backend also introduced above, that coordinates with capture application 130 and processes capture data 106 according to the needs of a given application. The backend performs the instant non-sequential VIO to produce a montage of the capture data as taught above and runs by utilizing compute resources 122 and remote storage resources 116 in cloud 118.

The capture application is responsible for accomplishing the following objectives:
1. Collect capture data.
2. Allow the user to apply markings to portions of the capture data.
3. Decompose and index capture data.
4. Remain operational during network disconnects.
5. Transmit to the cloud the above markings and portions of the capture data. More specifically, transmit the capture data in segments to the cloud storage.
6. Provide status updates to the user.
7. Perform other ancillary operations (e.g., rotating partitions, calibration and database table replication).

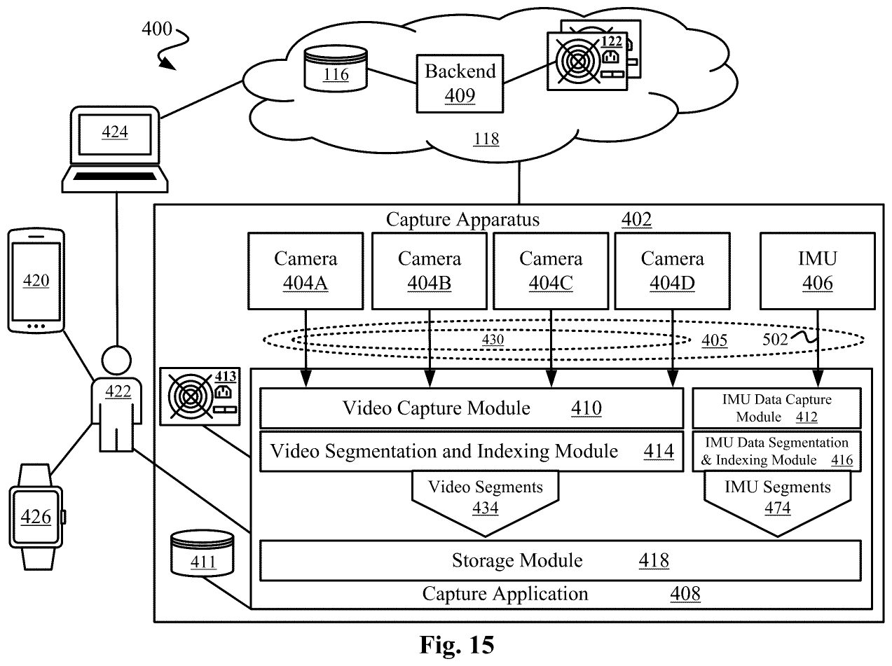

We have discussed in detail how the capture application achieves its objectives (1) and (2) above in reference to the teachings of the prior embodiments. Let us now review in detail how capture application 130 of FIG. 2 accomplishes the rest of its above objectives in conjunction with the teachings already provided above. Thus, let us first review how capture application 130 decomposes capture data 106 into segments and indexes it. For this purpose, let us examine FIG. 15.

FIG. 15 is a variation of FIG. 2 focusing on the workings of the instant capture application and omitting some elements for clarity. More particularly, FIG. 15 illustrates an architectural block diagram 400 with the various modules or components of an instant capture application 408 running on and in conjunction with the various modules/components of the present technology. As shown, capture application 408 runs by utilizing the computer resources of capture apparatus 402 and more specifically, compute resources 413, local storage 411 and network resources (not shown).

There is a user/operator 422 with access to capture application 408. There is also a computing device 424 running a computer application 170, a secondary computing device 420 and a companion device 426 of the above teachings. Secondary device 420 is used by user 422 to attached secondary content (photos, voice memos, etc.) to the capture data per prior teachings. The backend application or simply backend 409 of the present design runs by utilizing compute resources 122 and remote storage resources 116 in cloud 118.

Capture apparatus 402 has a number of cameras 404A, 404B, 404C and 404D as shown. Any number of such cameras 404 may be present on capture apparatus 402. Thus, in FIG. 15 there may be a single camera 404A, two cameras 404A-B, three cameras 404A-C, four cameras 404A-D as explicitly shown, and so on. There is also an inertial measurement unit (IMU) 406. As shown by the dotted ellipse, video or image data 430 available via respective digital interfaces or device drivers (not explicitly shown) of cameras 404 is provided to video capture module 410.

Similarly, IMU data 502 measured by IMU 406 is provided via its interface or device driver (not explicitly shown) to IMU data capture module 412. Together video data 430 and IMU data 502 are referred to as capture data 405 as shown by the dotted ellipse. The jobs of video capture module 410 and IMU data capture module 412 include reading/capturing video data 430 and IMU data 502 produced by camera(s) 404 and providing it to video segmentation and indexing module 414 and IMU data segmentation and indexing module 416 respectively.

In this disclosure we use the terms decomposing/decomposition and segmenting/segmentation interchangeably to refer to the exercise of processing video and IMU data into segments. In other words, we may state that the present technology decomposes video/IMU data into segments. Alternatively, we may state that the present technology segments the video/IMU data. Video/IMU data segmentation is discussed in detail below.

Thus, there is a video segmentation and indexing module 414 and an IMU data segmentation and indexing module 416. The jobs of video segmentation and indexing module 414 and IMU data segmentation and indexing module 416 include segmenting video data 430 and IMU data 502 received from modules 410 and 412 and decomposing it or segmenting it into video segments 434 and IMU segments 474 respectively. After capture data 405 consisting of video data 430 and IMU data 502 has been indexed and decomposed/segmented into video segments 434 and IMU segments 474, storage module 418 is then responsible for locally storing it and uploading it to remote storage 116 as will be explained in detail below.

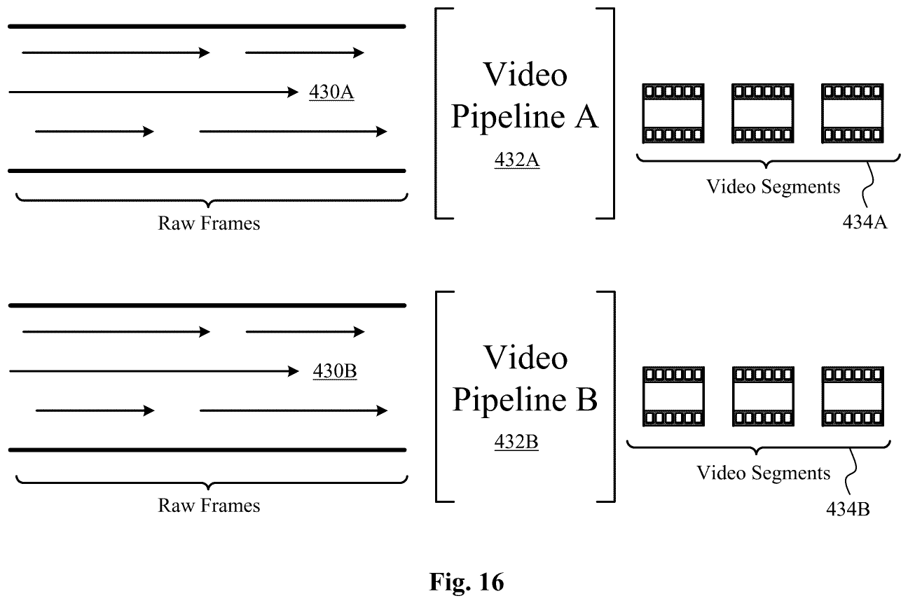

Depending on the embodiment, a number of different video pipelines can be implemented in/by video segmentation and indexing module 414 for processing video data 430 generated by the cameras of capture apparatus 402 and obtained via video data capture module 410. FIG. 16 shows two video pipelines, video pipeline A and video pipeline B marked by reference numerals 432A and 432B for processing video data 430 generated by two cameras 404A and 404B respectively of capture apparatus 402 of FIG. 15. There is also a video pipeline C and a video pipeline D for processing video data generated by cameras 404C and 404D respectively but they are not shown in FIG. 16 to avoid clutter. As shown, video pipelines A/B receive raw frames 430A/430B from cameras 404A/B and process these raw frames to produce video segments 434A/B respectively.

In one embodiment, each of cameras 404 of FIG. 15 is a FLIR® Blackfly camera that produces 8-bit monochrome 2000×1500 resolution image frames 430 at 30 frames per second (fps). Preferably, the camera is a Teledyne FLIR Blackfly S USB3 camera of which Model BFS-U3-120S4M is a monochrome variant and model BFS-U3-120S4C is a color variant. Preferably, such a camera is used in the embodiment when the capture apparatus is an AOD. In the same or a related embodiment, the monochrome variant is used.

In another embodiment, each of cameras 404 has the following specifications:
It supports 8-bit, 10-bit, 12-bit and 16-bit pixel formats.
It has a resolution of 4000×3000 (i.e. 4:3 aspect ratio).
It further supports other resolutions by hardware binning and cropping. Binning is referred to the process of combining blocks of adjacent pixels throughout an image by either summing or averaging the pixel values.
Its image sensor is a Sony® IMX226 (Type 1/1.7) CMOS sensor. The sensor is available in different variants. The preferred variant is IMX226CLJ suitable for monochrome application and having the following specifications:
   The image sensor is a 12.4 Megapixel sensor.
   The sensor diagonal is of length 9.33 millimeter (mm) for Type 1/1.7.
   The recommended number of recording pixels are 4000 (Horizontal)×3000 (Vertical).
   The unit cell (pixel) size is 1.85 micrometer (Horizontal)×1.85 micrometer (μm) (Vertical).

The camera is preferably equipped with a wide-angle lens, such as model PT-03220B16MP from M12 Lenses® Inc. This lens is designed to be used with Type 1/1.7 image sensors, such as Sony IMX226 (Type 1/1.7) sensor. The specifications of the lens relevant to the present discussion include:
Image format of 1/1.7 inches.
Nominal field of view (FOV) of 160° (diagonal), 131° (Horizontal) and 99° (Vertical).
Focal length of 3.2 mm.

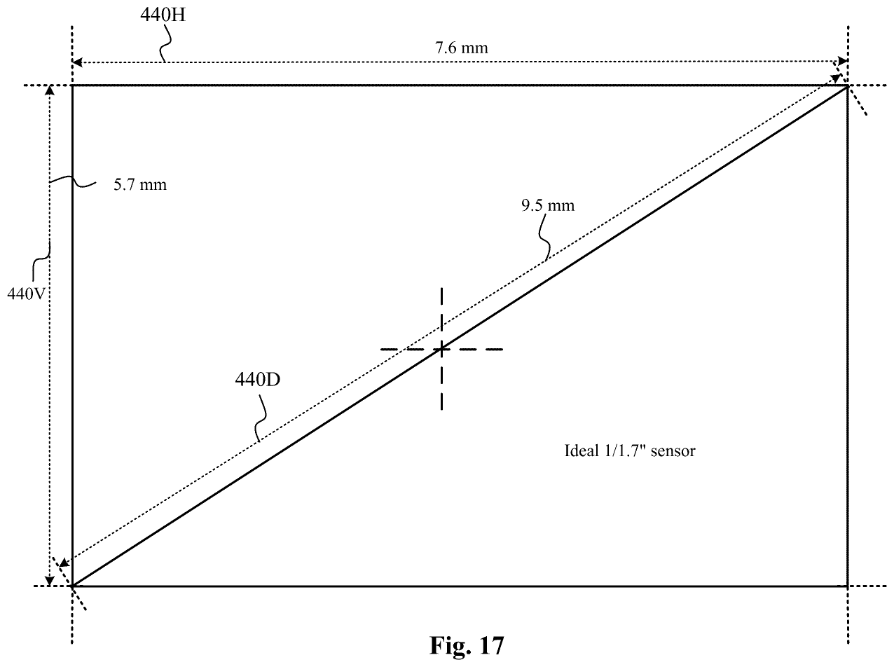

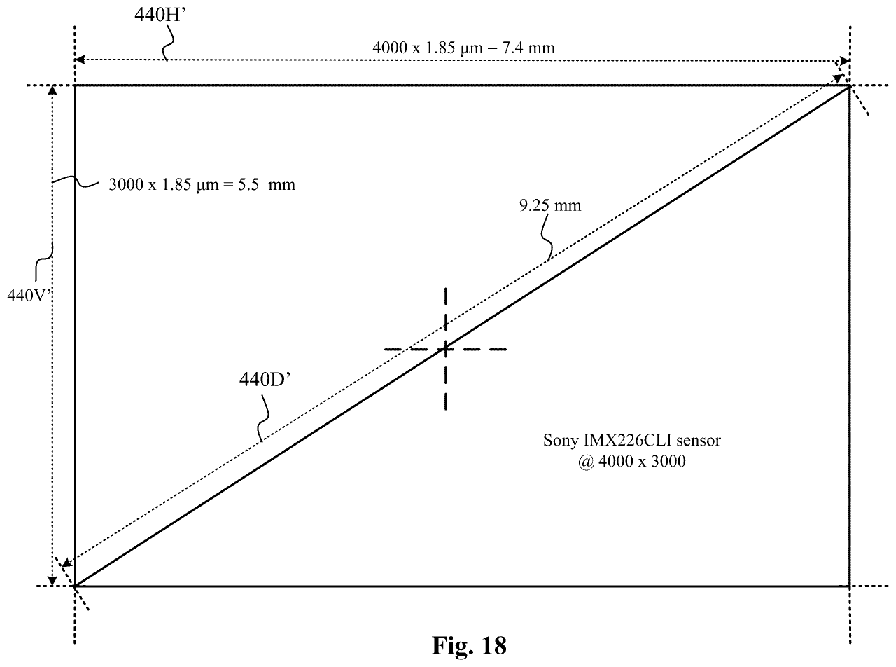

The effective FOV of the lens/sensor combination is not equal to nominal FOV of the lens. This is because the lens' nominal FOV is specified for an ideal 1/1.7 sensor (i.e. for a sensor with dimensions exactly 1/1.7″). The nominal FOV of such an ideal 1/1.7″ sensor is depicted in FIG. 17 with diagonal, horizontal and vertical lengths 440D, 440H, 440V of 9.5 mm, 7.6 mm and 5.7 mm respectively. FIG. 18 shows these lengths 440D′, 440H′, 440V′ of 9.25 mm, 7.4 mm and 5.5 mm respectively for a preferable sensor Sony IMX226CLI with a resolution of 4000×3000 pixels.

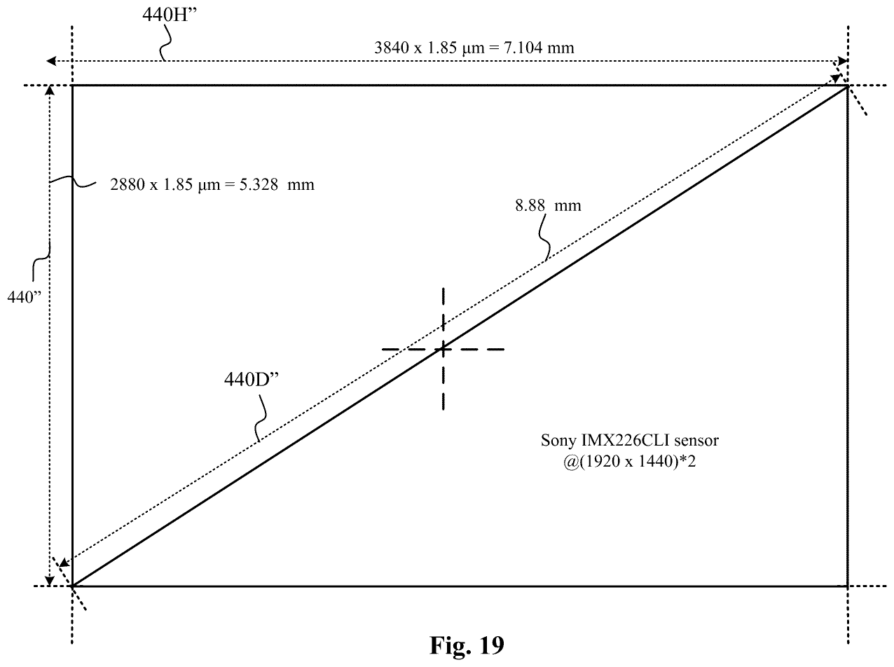

FIG. 19 shows these lengths 440D″, 440H″, 440V″ of 8.8 mm, 7.104 mm and 5.328 mm respectively for a preferable sensor Sony IMX226CLI with a resolution of (1920×1440)*2 pixels i.e. with 2×2 binning and then cropping to an image size of 1920×1440 pixels. Explained further, the present embodiment applies 2×2 binning to the camera with a 4000×3000 pixels resolution, thus reducing it to 2000×1500 pixels. This is preferably followed by cropping to 1920×1440 pixels having a standard 4:3 aspect ratio resolution format that is divisible by 8 and is preferred by various video encoders.

### Effective FOV:

Per above, the nominal FOV of the preferred lens PT-03220B16MP is 160° (diagonal) for a standard/ideal 1/1.7″ sensor where a standard 1/1.7″ sensor has a diagonal of 9.5 mm. In the preferred embodiment, the 4000×3000 image is down-sampled by 2, and then cropped to 1920×1440 pixels with a diagonal length (effective) of 8.88 mm. Therefore, the effective FOV under the present capture conditions is per below.
Effective diagonal FOV: 160°*8.88/9.5˜149.6°
Effective horizontal FOV: 131°*5.328/5.7˜122.4°
Effective vertical FOV: 99°*5.328/5.7˜92.5°

Notice the comparison to the respective nominal FOV values for the lens of 160° (diagonal), 131° (Horizontal) and 99°

### (Vertical).

Armed with the above knowledge, let us now consider some ways in which the four cameras of an instant capture apparatus of our four-camera embodiments can be arranged. While referring to FIG. 4 in conjunction with FIG. 15, a practitioner can attach cameras 204A-D/404A-D either horizontally or vertically to helmet 202. Since the horizontal and vertical FOV of the cameras are different, these two arrangements will result in different coverage patterns for the two camera arrangements.

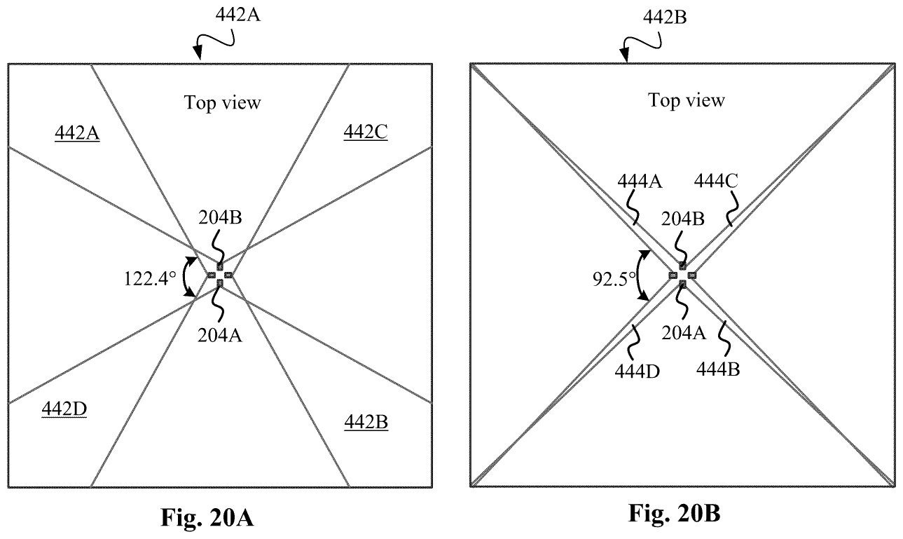

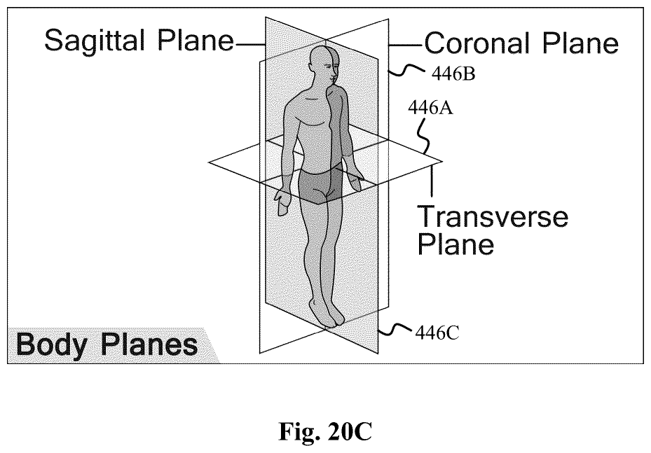

A conceptual top-view representation of the effective FOV of these two camera arrangements 442A and 442B is shown in respective FIG. 20A and FIG. 20B where only two cameras 204A/404A and 204B/404B of cameras 204/404 are explicitly marked to avoid clutter. Let us now review FIG. 20A-B in conjunction with FIG. 20C that shows the three standard body planes of user or operator 104/422. More specifically, FIG. 20C shows transverse plane 446A, coronal plane 446B and sagittal plane 446C of the user.

In camera arrangement 442A, cameras 204/404 are attached/arranged horizontally with an effective horizontal FOV of 122.4° of each camera as shown. In other words, the horizontal axis of each camera 204/404 is oriented along transverse plane 446A of the head of the user. In contrast, in camera arrangement 442B, cameras 204/404 are attached/arranged vertically with an effective horizontal FOV of 92.5° of each camera. In other words, the vertical axis of each camera is now oriented along the transverse plane 446A and the horizontal axis of each camera is now nominally oriented along the vertical axis with small uncovered regions or blind spots 444A-D as shown.

As a result, camera arrangement 442A has large overlapping or “wasted” regions 442A-D along transverse plane 446A of user 104/422 as shown, while the effective FOV along the “up-down” or vertical direction or along sagittal plane 446C of the user is just 92.5°. However, by rotating the cameras by 90° we achieve camera arrangement 442B. With this arrangement, we reduce the overlap in camera coverage along the transverse plane of the user while increasing the FOV along the “up-down” direction of the user to 122.4°. There are however minor blind sports 444 in FIG. 20B which would be acceptable for many applications. That is why, camera arrangement 442B of FIG. 20B offers better overall scene coverage for most applications and is employed by the preferred embodiment of the present technology.

Per above, each camera is preferably configured to apply 2×2 binning (which reduces the resolution to 2000×1500), followed by cropping to 1920×1440 pixels. By utilizing camera arrangement 442B of FIG. 202B in which cameras are rotated by 90° i.e. attached vertically to the helmet, the preferred embodiment uses a total of (1440×4=5760)×1920 pixels to achieve omnidirectional coverage around the user. From henceforward, unless otherwise provided, the below teachings will apply to the embodiments of FIG. 2 as well as FIG. 15 which is a variation of FIG. 2. Hence, for the sake of brevity, we may not repeat reference numerals from FIG. 2-4 with the knowledge the present teachings apply to the prior embodiments discussed in reference to FIG. 2-4 also.

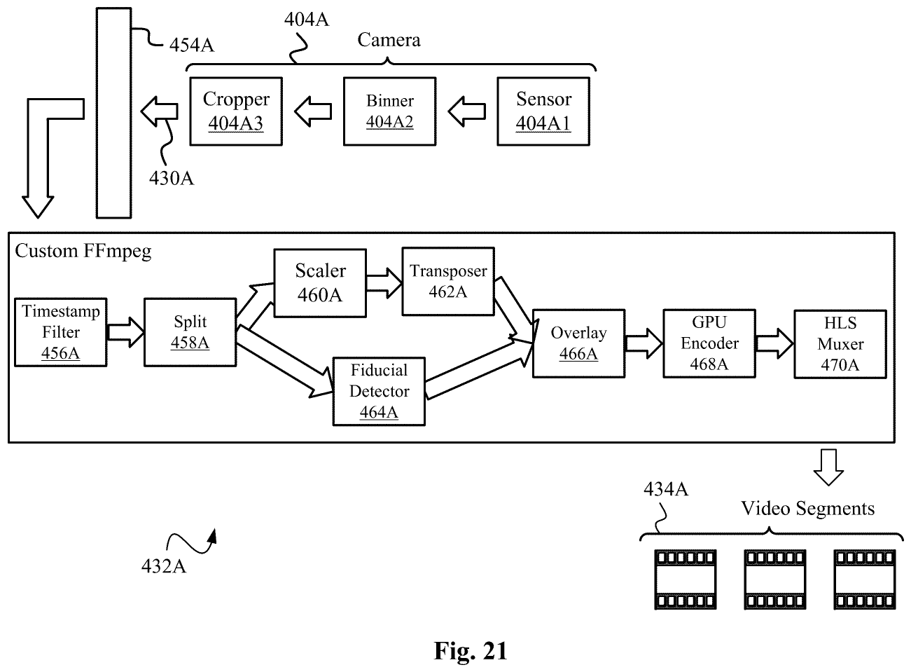

The present design affords a number of different ways of implementing video pipelines for processing data generated by the camera(s) of the capture apparatus. Two such video pipelines 432A and 432B were introduced above in reference to FIG. 16 for processing data generated by cameras 404A and 404B of cameras 404 respectively of FIG. 15. A given implementation may mix and match different video pipelines for processing video data generated by various cameras. FIG. 21 shows one exemplary implementation of video pipeline 432A according to the present principles. As noted above, video pipeline 432A processes video output of camera 404A of capture apparatus 402 via data capture module 410 of FIG. 15.

Camera 404A consists of various hardware and software components. These components include sensor 404A1, a binner or binning module 404A2 that preferably bins the raw frames in a 2×2 format/configuration and a cropper 404A3 that crops the frames to 1920×1440 pixels size per above explanation. Camera components also include a device driver with APIs that can be used by an external software to query the camera or to configure it. The device driver of camera 404A is not explicitly shown in FIG. 21 but is presumed to exist.

Raw frames 430A that are produced by camera 404A are written to a FIFO 454A (a first-in first-out special file or “named pipe” in Linux® parlance). Alternatively, the raw frames are communicated down pipeline 432A via some other suitable inter-process communication (IPC) mechanism of the operating system such as Linux®. The advantage of doing this is that in the vast majority of instances raw frames 430A written to FIFO 454A are only written to the memory/RAM (random access memory) and not to the disk. Therefore, this mechanism affords a major performance boost for the present design.

Pipeline 432A utilizes FFmpeg suite of libraries to implement a number of modules or submodules or functions or tasks to process image frames 430A read from FIFO 454A. As shown in FIG. 21, the first such function is a custom timestamp filter 456A. For each frame, timestamp filter 456A computes a timestamp with an accuracy of milliseconds and stores this information in the raw frame metadata. In the preferred embodiment, custom timestamp filter 456A can be invoked using FFmpeg filter complex options. Exemplarily, the following FFmpeg command may be used for this purpose (assuming FIFO 454A is the named pipe/tmp/videofifo 0):

ffmpeg -f rawvideo -vcodec rawvideo -pixel_format gray
-video_size 1920x1440 -framerate 30 -i /tmp/videofifo_0
-filter_complex “[0:v]imtimestamp;” < other options >

The above command reads raw video frames from the named pipe/tmp/videofifo 0. Because the input is raw video, the framerate (i.e., ‘30’), pixel format (i.e., ‘gray’) and video size (i.e., ‘1920×1440’) need to be specified. The option-filter complex “[O: v] imtimestamp;” applies the custom filter imtimestamp to video stream 0 (the only video stream in this example). Custom filter imtimestamp timestamps each frame with millisecond accuracy.

The timestamped frames are then split i.e. copied to two different paths by a splitter submodule/function 458A as shown in FIG. 21. Specifically, splitter 458A makes a copy of the timestamped frames into two streams of frames. It provides one stream of timestamped frames to scaler function/module 460A and the other stream of timestamped frames to fiducial detector module 464A. Scaler function 460A scales the frames to the final resolution required for the output video segments 434A shown in FIG. 21. Typically, this is a scale-down operation. Building on our example above, the FFmpeg filter complex option expands to:
filter complex “[0: v] imtimestamp, split=2 [s1] [s2];”

The above FFmpeg filter complex option splits the output of the filter imtimestamp into two outputs referenced as ‘s1’ and ‘s2’.

A transposer submodule/function 462A is applied to frames emerging from scaler 460A as shown in FIG. 21. This function is necessary for camera arrangement 442B of FIG. 20B discussed above in which the cameras were rotated 90°. Transposer 462A rotates the images to their final orientation for video segments 434A. Continuing with our example above, the FFmpeg filter complex option is further expanded to:

-filter_complex
“[0:v]imtimestamp,split=2[s1][s2];[s1]scale=1280:960[scale]
;[scale]transpose=2[base];”

The above FFmpeg filter_complex option applies a scaling and transpose operation to the split stream ‘s1’, and the output is referenced as ‘base’.

In parallel to the scaling and transpose operations performed on the timestamped frames by scaler 460A and transposer 462A respectively, fiducial detector module 464A detects any fiducial information from the copy of the timestamped frames per above. Continuing with our example above:

-filter_complex
“[0:v]imtimestamp,split=2[s1][s2];[s1]scale=1280:960[scale]
;[scale]transpose=2[base];[s2]imfiducialdetect[fiducial];”

The above FFmpeg filter complex option processes second split stream ‘s2’ with filter imfiducialdetect and the output is referenced as ‘fiducial’. Note that in this example, the input to the fiducial detection filter is the video at the original resolution, orientation and frame rate. However, the fiducial detection logic is not required to process every single frame, producing null or blank results for skipped frames. In one embodiment, the fiducial detection logic also scales and transposes its own results.

The fiducial information is derived using computer vision techniques and involves determining the presence of any fiducial markers or landmarks in the frames. This fiducial information is stored in an index file/table of video segments 434A as will be explained further below. Frames emerging from transpose function 462A and from fiducial detector 464A are overlaid together. If the output of fiducial detector 464A is purely metadata the overlay operation is straightforward. Otherwise, the output stream of 464A needs to be added over the output stream of 462A.

Returning to our example:

-filter_complex
“[0:v]imtimestamp,split=2[s1][s2];[s1]scale=1280:960[scale]
;[scale]transpose=2[base];[s2]imfiducialdetect[fiducial];
[base][fiducial]overlay=x:y”

The above FFmpeg filter_complex option overlays the output “fiducial” over the output ‘base’ (which is the result from scaling and transposing). The parameters ‘x: y’ control the position of the overlaid video relative to the base video.

Next a video encoder 468A is used to encode the frame based on an appropriate video encoding standard/format. For performance reasons, encoder 468A is preferably a GPU-based or GPU-accelerated encoder or simply a GPU encoder. Exemplarily, GPU encoder 468A encodes the frames using an H.264 video encoder or is an H.264 encoder. The following FFmpeg command may be utilized for this purpose:

ffmpeg -f rawvideo -vcodec rawvideo -pixel_format gray
-video_size 1920x1440 -framerate 30 -i /tmp/videofifo_0
< filter complex options >
-pix_fmt yuv420p -b:v 3M -profile:v 100 -r 30 -g 30 -c:v
h264_nvmpi < other options >

The above command uses the H264 hardware encoder onboard Nvidia Jetson Xavier. It sets the pixel format to yuv420p, a target bitrate of 3 Mbps, a frame rate of 30 fps, GOP=30 (group of pictures structure) and H264 High Profile mode.

Next, an HTTP Live Stream (HLS) multiplexer 470A is used to multiplex the frames into individual video segments 434A of the desired length. In the preferred embodiment, HLS multiplexer 470A is a customized version of the HLS encoder forming part of FFmpeg. This custom HLS muxer has access to the timestamp information computed by the timestamp filter. It writes this information to a JSON metadata file created with the same name as the target video segment but with the JSON file extension. Exemplarily, the following FFmpeg command may be used for this purpose to produce video segments of 2 seconds duration:

ffmpeg -f rawvideo -vcodec rawvideo -pixel_format gray
-video_size 1920x1440 -framerate 30 -i /tmp/videofifo_0
< filter complex options >
-pix_fmt yuv420p -b:v 3M -profile:v 100 -r 30 -g 30 -c:v
h264_nvmpi -f hls -hls_time 2 < other options >

Finally, the HLS multiplexer 470A writes the video segments 434A to the filesystem under an appropriate naming convention. In the preferred embodiment, the file name includes the camera number or label, the video segment starting time and duration, the video segment size (in bytes) and count number. Exemplarily, the following FFmpeg command may be used to create video segments according to the above naming convention:

ffmpeg < input options > < filter complex options > <
encoding options > -f hls -hls_time 2 -hls_flags
second_level_segment_index+second_level_segment_size+second
_level_segment_duration+second_level_segment_milliseconds -
strftime 1 -strftime_mkdir 1 -hls_segment_filename
“/storage/video/%Y%m%d/FLIR.${cam_id}/%H/FLIR.${cam_id}.%Y%
m%d%H%M%S.%%03m.%%01d.%%07s.%%05t.ts”

The above command stores video sin directory:/storage/video/[date]/FLIR. [camera id]/[hour of day]/, where ‘date’ follows the year/month/day number format (without the “/” characters), and ‘hour of day’ follows the 24-hour format. ‘Camera id’ is the camera identifier as reported by the device driver.

The file name portion is: FLIR. [camera id]. [date time]. [date ms]. [count]. [size]. [duration]. ts, where ‘date time’ follows the year/month/day/hour/minute/second number format (without the ‘/’ characters), ‘date ms’ is the millisecond portion of the date time, ‘count’ is the video segment count, ‘size’ is the video segment size in bytes, and ‘duration’ is the video segment duration in milliseconds.

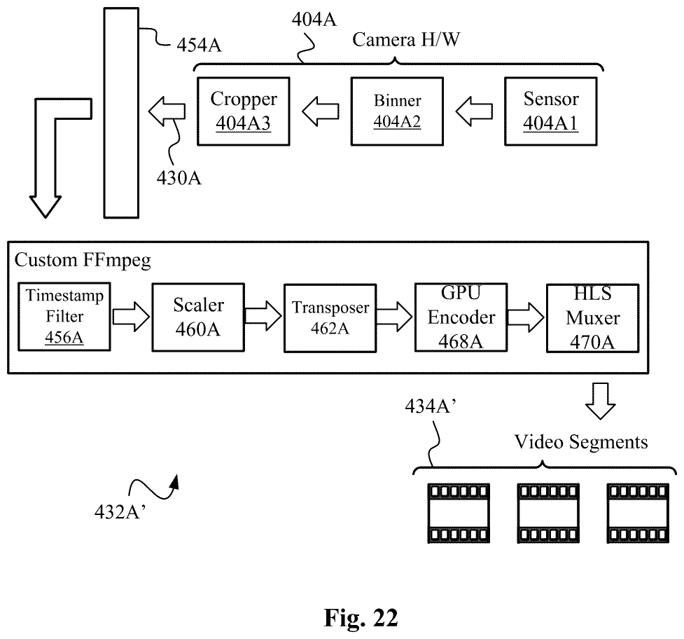

The preferred implementation of instant video pipeline 432A utilizes a Linux Operating System running on Nvidia Jetson Xavier embedded computer onboard capture apparatus 402 of FIG. 15. An alternative and simplified variation 434A′ of the video pipeline 434A is presented in FIG. 22. Video pipeline 432A′ does not include fiducial detector 464A and consequently does not require splitter and overlay modules 458A and 466A respectively of pipeline 434A. The resultant video segments 434A′ are generated by simplified video pipeline 432A′ as shown.

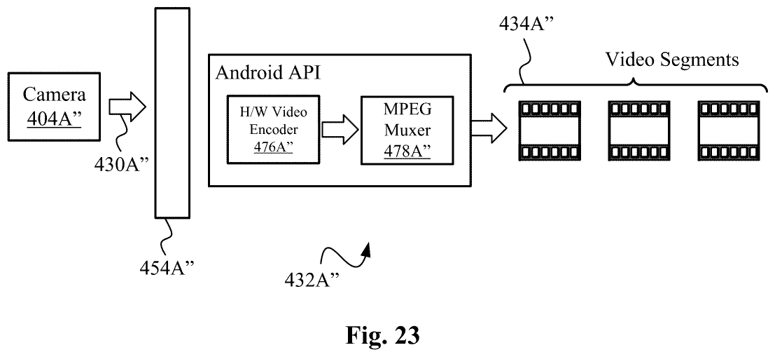

Still another video pipeline design afforded by the present technology utilizes Android™ API instead of FFmpeg. Such a video pipeline 432A″ is illustrated in FIG. 23 and is particularly suited to embodiments where the capture apparatus operates as an OOD. Exemplarily, video pipeline 432A″ utilizes a fisheye camera 404A″ that produces 1920×1920 resolution image frames 430A″ (monochrome or color), at 30 frames per second (fps).

In a preferred embodiment, the capture apparatus is a Ricoh® Theta X camera equipped with two opposite-facing fisheye cameras, each with a FOV exceeding 180°. Video frames from both cameras can be combined to produce 360° images at a later postprocessing stage. But for purposes of the present discussion, assume each that fisheye camera operates independently, in which case the video pipeline 432A″ shown in FIG. 23 is duplicated and applies to each camera.

Video frames 430A″ produced by camera 404A″ are written to FIFO 454A″ or “named pipe”, or communicated downstream via another suitable IPC device of Android™ OS. The advantage of this is that in most instances of its use, the data i.e. frames 430A″ that are written to FIFO 454A″ are only written to the memory/RAM and not the disk. This mechanism affords a major performance boost for the present design.

Now, instead of FFmpeg, pipeline 432A″ utilizes a combination of hardware API of the computing device embedded/integrated with the camera and Android OS API in order to implement the various submodules or modules or functions or tasks to process image frames 430A″ read from FIFO 454A″. The first such function is encoder 476A″ that preferably utilizes a dedicated hardware encoder for performance reasons. In a preferred embodiment, the hardware encoder is an embedded Snapdragon system on a chip (SoC) by Qualcomm®. In the same or related embodiment, the hardware encoder utilizes H.264 standard to encode the frames.

Exemplarily, the present technology utilizes Qualcomm's own APIs for encoding. Alternatively, the instant technology utilizes the MediaCodec Java® API of Android for this purpose. Next, the encoded frames are multiplexed by an MPEG multiplexer 478A″ to produce video segments 434A″ of the required duration. Exemplarily, the MediaMuxer class is utilized for this purpose. The output of this process is a sequence of video segments encoded in MP4 format.

A separate process (not shown in FIG. 23) analyzes each encoded video segment to extract metadata information, including the presentation timestamp (PTS) of each frame contained within each video segment. In a preferred embodiment, FFprobe is used to extract said metadata information. FFprobe is a tool for analyzing multimedia streams and is a part of the FFmpeg project.

The metadata information is saved as a sequence of JSON files named after the video segments.

Per above, the preferred implementation of video pipeline 432A″ utilizes Android OS running on a Snapdragon SoC by Qualcomm embedded with one or more fisheye cameras onboard the capture apparatus. Any postprocessing not deemed essential to the encoding process is preferably performed in the remote backend (e.g., combining the stream of two fisheye cameras into a single 360° video). The present approach greatly reduces the computational burden required to implement the video pipelines and minimizes the internal temperature of their various electronic components.

There are several video encoding parameters that are preferably optimized by the present technology for recording video based on various use cases while still providing random access to video data at any instance of time of the video recording timeline. These parameters include resolution, framerate, bitrate and keyframe intervals as well as video file size. The present technology utilizes either H.264 or H.265 encoding for video encoders above because these standards allow one to control the above parameters while generating an encoded video format that is widely supported in most computing environments.

They also have the desired effect of generating very compact video data that is universally playable by everyday decoders. H.265 has enhanced compression algorithms over H.264, resulting in typically smaller file sizes while also maintaining higher quality at lower bitrates. As mentioned, in one embodiment, video encoding is performed by the onboard GPU. In another embodiment, video encoding is performed by a dedicated hardware encoder preferably present in Qualcomm Snapdragon family of embedded SoCs.

Referring again to FIG. 15, a preferred embodiment utilizes the same video pipeline 432A for each of cameras 404 of a multi-camera configuration. A multi-camera setup entails additional video pipelines 432B, 432C, 432D and so on, for processing video data produced by cameras 404B, 404C, 404D and so on respectively and those have the same structure as video pipeline 432A.

However, alternative implementation can mix and match different pipelines for different cameras of the same capture apparatus. In other words, any combination of video pipelines 432A and 432A′ may be used for a given capture apparatus containing cameras 404.

FIG. 21-23 and associated discussion presented three video pipelines 432A based on the present principles that are particularly suited for the four-camera embodiment of FIG. 4 discussed above in detail. Pipelines 432A 432A′ and are applicable to the embodiment of FIG. 4 containing an embedded computer system running Linux OS. Pipeline 432A″ is applicable to an embodiment with a capture apparatus running Android OS. Exemplarily, such an embodiment uses the capture apparatus shown in FIG. 5 with four cameras whose horizontal and vertical FOVs are identical or symmetrical.

Explained further, the capture apparatus of FIG. 5 is also a four-camera configuration with cameras 224A-D on helmet 222.

However, the horizontal and vertical FOVs of camera 224 are identical. Thus, video data frames generated by cameras 224 need not be transposed, resulting in a simplified version of video pipelines 432 with no transpose module/function required. The rest of the relevant teachings of the four-camera embodiment of FIG. 4 of the present design also apply to FIG. 5.

It is important to remark however, that pipelines 432A, 432A′ and 432A″ do not require camera symmetry in arrangement or in kind. An advantage of the instant technology is that heterogenous multi-camera setups are fully supported. Each camera can operate with different FOV, resolution and frame rate.

Furthermore, aside from video pipelines 432A, 432A′ and 432A″ discussed above, other video pipeline implementations are also conceivable within the scope of the present technology in order to meet given application needs. Ultimately, video pipelines 432 process image/video frames from one or more cameras 404 in order to generate respective video segments 434 per above explanation. Let us now further review video segmentation in even more detail.

Video Segmentation or Decomposing Video Data into Segments:

Typically, a video stream from a single camera is recorded as a single file with the writing of data starting when the recording starts and ending when the recording stops. If the recording is 20 minutes long then one would have a file that contains all 20 minutes of video data. However, such a typical recording into single file causes several problems as discussed below.

For example, if the video file created above was of size 16 GB, and if we need to transfer it over a network, then due to its large size there is a high probability that the file transfer will fail to complete due to connectivity issues. Furthermore, if we need to store the file for extended periods of time, such a file size will typically be suboptimal for maximizing the storage on the device. Moreover, if we need to access the video frames at a given point in time, e.g. a frame or frames from the 6th minute of recording, then we will need to sequentially seek from the start of the video file before finding the desired content. In summary, a single video file is not an optimal design choice and does not support random access.

The present technology solves the above problems. It does so by decomposing or segmenting the video data produced by the camera(s) of the capture apparatus into video segments of short duration. The present video segmentation strategy can be optimized for multiple goals. One can create longer video segments that maximize the onboard device storage, shorter video segments that allow more complete random access to the video data as well as to maximize network transfer effectiveness.

According to the chief aspects, an instant video segment is a video clip of a short duration (e.g. 2 seconds) with a given encoding (e.g. H.264 or H. 265), a constant Group of Pictures or GOP (e.g. begins with an 60), and I-frame. Various characteristics of a video segment may be customized to fit the needs of a given application. Moreover, it is not required for the framerate and the length/duration of the segments to be the same across the segments. Such a design affords great flexibility in implementing the present technology for various applications.

The present design uses video segmentation for recording or storage of the video data. When video recording starts, a new video container (as a file) is created. After a specified set of criteria for the file have been met, the current video container is closed and new video container (as a file) is created for subsequent video frames. Advantageously, the above criteria for closing a video container include elapsed time, file size, frame count, among others.

Each new video segment starts with an I-Frame. A video segment may contain a single I-Frame or many I-Frames. Both H.264 and H.265 formats allow the present technology to control when an I-Frame is emitted from the video encoder. While referring to FIG. 21-23, video segments 434A are preferably stored as files following a standardized video container format. Similarly, video segments resulting from additional cameras e.g. video segments 434B, 434C and so on (not explicitly shown) are also preferably stored as files following a standardized video container format.

In one embodiment, the above video container format is MP4. In another embodiment, the video container format is MPEG Transport Stream (MPEG-TS). In yet another embodiment, the video container format is fragmented MP4 (fMP4). It is sometimes desirable to have the ability to recombine and then stream an arbitrary subset of video segments as a continuous and seamless video without further transcoding. Formats such as MPEG-TS and fragmented MP4 (fMP4) are preferable for this purpose.

As a key innovation or the present design, a practitioner is able to perform random-access retrieval of video data generated by the camera(s) onboard a capture apparatus and processed by the video pipeline(s) of the above teachings. This advantage is afforded by efficient segmentation of the video stream(s) of the camera(s) per above explanation and indexing as explained further below.

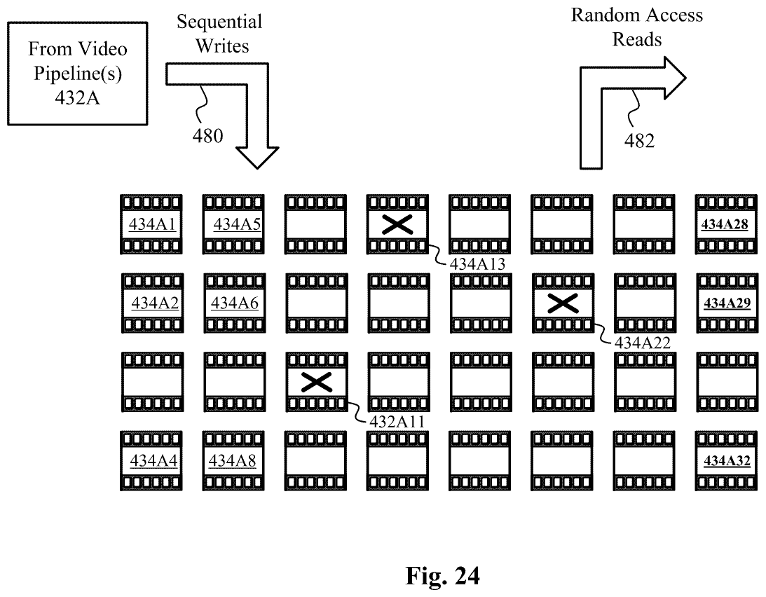

Let us see the illustration of FIG. 24 to understand this better. Video segments 434 generated by a video pipeline 432, such as video segments 434A from video pipeline 432A of the above teachings, are written sequentially or in order of the video recording timeline. For video pipeline 432A, these sequentially written video segments are shown by reference numerals 434A1, 434A2, . . . 434A32. Not all intervening segments are explicitly marked by reference numerals to avoid clutter.

Based on the instant design, even though video segments 434A1-434A32 are sequentially written to individual files as shown by block arrow 480 they can still be randomly accessed as shown by block arrow 482. More specifically, video segments 434A11, 434A13 and 434A22 as marked by the letter X are shown to be randomly retrieved from their individual files. Of course, within a file, the video data at a given instance of time is accessed by seeking or on a sequential basis. That is why it is advantageous to keep the length/duration of video segments 434 small. The above ability to perform random access retrieval on video data is an important innovation of the present design.

The random-access retrieval is afforded by an indexing scheme of the present technology. Instant video indexing refers to storing and updating by the capture application of a number of fields related to the video segments in a table of a database. This table is referred to as the video index. Similarly, IMU indexing refers to the storing/updating by the capture application of a number of fields related to the IMU segments in a table of a database. This table is referred to as the IMU index. Finally, user events indexing refers to the storing/updating by the capture application of a number of fields related to the user events in a table of a database. This table is referred to as the user events index. All these indexes or tables are stored in a database on local storage 411 of FIG. 15, from where they are uploaded to remote storage 116 as provided below. While briefly referring to FIG. 2, markings 107 discussed in the prior embodiments are also referred to by the more inclusive term of user events in this disclosure.

The preferred implementation utilizes a local database to manage and store the above indexes or indices for video, IMU and user events/markings data as database tables in local storage 411. In the preferred embodiment, the video index in local storage 411 contains the following fields or columns:
1. A UUID (Universally Unique Identifier) assigned to the capture apparatus.
2. Timestamp of the start time of the video segment.
3. Duration of the video segment, preferably 2 seconds for an AOD and 12 seconds for an OOD.
4. A Camera Label containing identifying information about the camera responsible for the video segment, such as where the camera is attached/located on the capture apparatus e.g. front of the helmet, rear of the helmet, left of the helmet, right of the helmet, on top of the helmet, on a selfie stick or monopod, among others.
5. A Resource Locator identifying the location of the video data or content. In one embodiment, the video content is stored in a datastore in local storage 411 where the datastore is preferably structured on a key-value pair architecture. In such an embodiment, the resource locator or simply the locator is a key in the datastore pointing to the video content as the value. In another embodiment, the video content is stored as a file or files in a filesystem on local storage 411. In such an embodiment, the resource locator is path(s) in the filesystem of the file(s) containing the video content.
Once the index has been uploaded/synced to remote storage 116 per below teachings, the resource locator is updated to contain the location of the video content in remote storage 116. Advantageously, remote storage 116 is implemented on AWS® S3 cloud storage, and as such the resource locator for video data or content residing in S3 storage is the S3 key.
6. Ancillary data, a flexible JSON field with sub-fields containing any other information about the video segment as needed for a given implementation. Preferably, the ancillary data includes:
   Fiducial presence. Information about any fiducial markers that were identified in the video segment e.g. an Entrance, an Exit, a Living Room, and the like.

One set of the above fields will constitute a row in the index table. The table containing the collection of rows with the above sets of fields for the entire video content of a given project is referred to as the video index. In practice, there may be several such index tables or indices in the database for the respective number of projects that are currently active for a given implementation. The above video index design allows one to run queries on the video data that are executed in a random-access manner rather than the typical sequential manner of the prior art.

For example, an exemplary user query “Retrieve video data from 2024 Jul. 19 10:01:05 UTC to 2024 Jul. 19 10:01:10 UTC from Left camera” will return file contents of the following 4 files of Left camera (assuming 2 second video segments):
1. 2024 Jul. 19 10:01:04 UTC (containing data from 2024 Jul. 19 10:01:04 UTC to 2024 Jul. 19 10:01:06 UTC)
2. 2024 Jul. 19 10:01:06 UTC (containing data from 2024 Jul. 19 10:01:06 UTC to 2024 Jul. 19 10:01:08 UTC)
3. 2024 Jul. 19 10:01:08 UTC (containing data from 2024 Jul. 19 10:01:08 UTC to 2024 Jul. 19 10:01:10 UTC)

The above video segment files will be individually accessed in the filesystem via their respective locators i.e. field (5) above contained in the video index. In the example of FIG. 24, the randomly retrieved files were marked with the label X. No other segments/files, and not certainly the entirety of the video data need be accessed or “seek-ed” based on the above-taught instant random-access design. This affords tremendous performance improvements and the ability to run fast queries.

Note that the random-access capability of the video index can be enabled only by a subset of the above-discussed index fields, namely:
Start timestamp-field (2),
Duration-field (3),
Camera Label-field (4), and
Resource locator-field (5)
   IMU Data Segmentation or Decomposition of IMU Data into Segments:

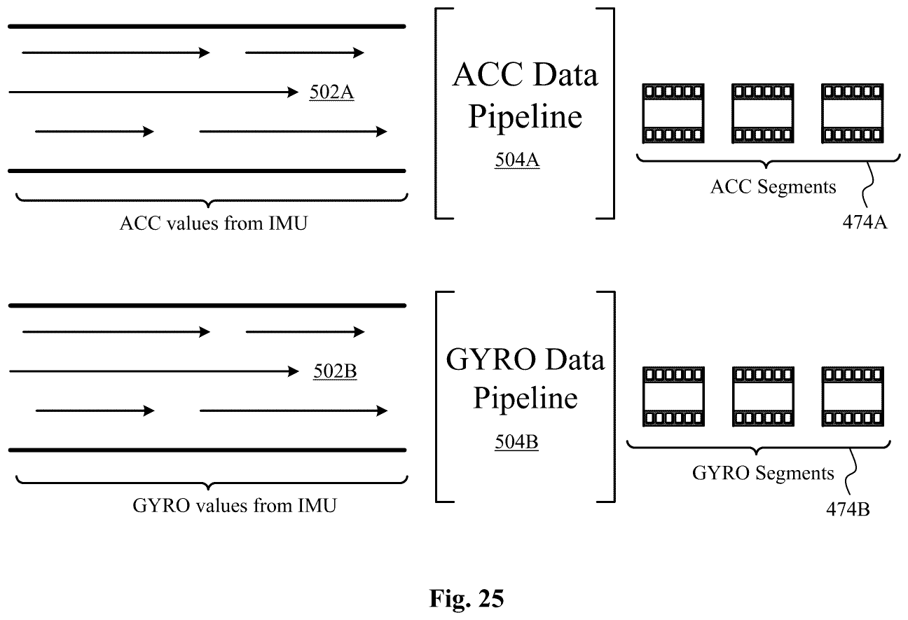

In addition to the video data, the present technology also decomposes the IMU data into IMU data segments per below teachings. FIG. 25 illustrates an overview of this process. As shown, there are two IMU data processing pipelines 504A and 504B in charge of processing accelerometer values 502A and gyroscope values 502B to produce accelerometer data segments 474A and gyroscope data segments 474B respectively.

Recording IMU data presents different problems than video data. IMUs typically run at higher frequency, meaning that they generate new data in a very short time window. An IMU running at 200 Hz will generate 200 samples per second, with new data available every 5 milliseconds (ms). IMUs typically provide three acceleration or simply acc values (Ax, Ay, Az) and three gyroscope or simply gyro values (Gx, Gy, Gz). In order to avoid IMU data misses or drops, the present design reads these values fast enough to keep the IMU hardware from overflowing its internal FIFO buffer or to keep the IMU device driver from overwriting entries in its buffer. The instant technology also accurately timestamps the values read.

To read IMU data as fast as possible with accurate timestamps, it is advantageous to separate the process of reading of IMU values from the process of writing of the IMU values into files in local storage 411. That is why in the present design, an execution thread reads (Ax, Ay, Az, Gx, Gy, Gz) values from the actual sensors and stores these values in a six-dimensional array in the local memory.

The size of the array determines the size of the IMU segment i.e. acc data segment or simply acc segment and gyro data segment or simply gyro segment. Explained further, each time the array gets full, it is written to a file, and a new array is created. Depending on the implementation, the size of the array may be specified as a number of entries or as a time interval (e.g. 10 seconds, 60 seconds, etc.) worth of IMU data.

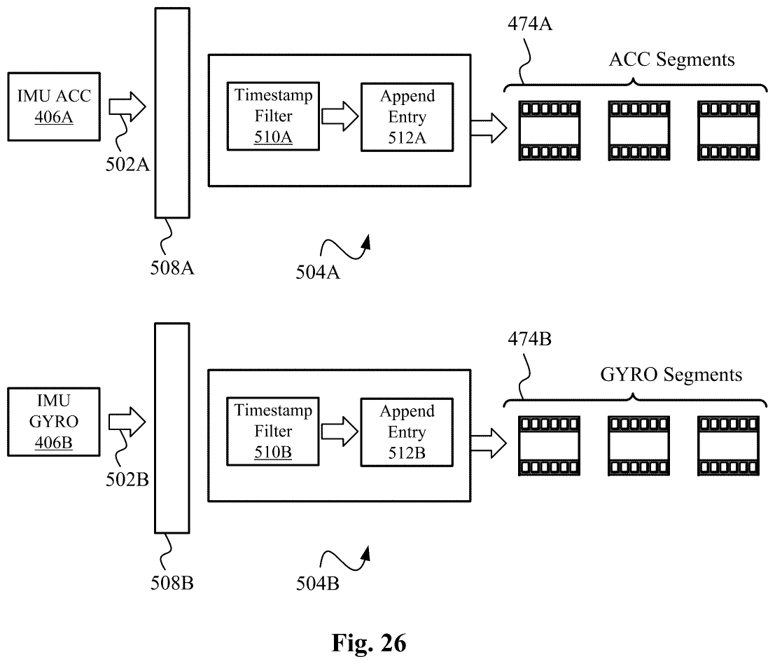

FIG. 26 illustrates the implementation design of acc and gyro data processing pipelines 504A and 504B respectively of FIG. 25 according to the present principles. Acc values Ax, Ay, Az marked by reference numerals 502A are produced by accelerometer 406A of IMU 406 introduced in FIG. 15 earlier. Similarly, gyro values Ax, Ay, Az marked by reference numerals 502B are produced by gyroscope 406B of IMU 406. Acc/gyro values 502A/B are written to respective FIFOs 508A/B of FIG. 26. Per above discussion, such a mechanism affords a major performance boost for the present design.

The acc/gyro values read from FIFOs 508A/B are timestamped by timestamp filter modules or sub-modules or tasks or functions 510A/B in a manner similar to video frames per above discussion.

The timestamped entries are then appended to the above-discussed 6-dim array by append modules 512A/B. Once the array is full as per the specified time or size criteria, the array is written to a file, and a new array is created. Alternatively, a ring buffer is used. In either case, each such array written to a file constitutes an acc or gyro segment. These acc/gyro segments are shown by reference numerals 474A/B in FIG. 26.

File creation and writing is a slow operation compared to writing data to memory. Therefore, once the above 6-dim array is filled, a new file is created and the IMU data is written into that file. This is done asynchronously with a separate execution thread or a write-thread. The write-thread does not affect or interrupt the read-thread that is separately in charge of reading the actual acc/gyro values from IMU sensors 406A/B.

IMU data files are typically written in a comma-separated values (CSV) format which is a widely supported file format. In one embodiment, acc and gyro values are recorded and segmented independently. That is to say that the accelerometer segments are written into one set of CSV files, and the gyroscope segments and written into a second set of CSV files. In another embodiment, the acc and gyro segments are written to the same set of CSV files i.e. a single CSV file contains both acc and gyro values respective to the acc and gyro data segments.

In yet another embodiment, the IMU additionally produces linear accelerometer and gravity values, which are also recorded and segmented independently. That is to say that linear acc segments are written into a third set of CSV files, and the gravity segments are written into a fourth set of CSV files. These linear accelerometer and gravity values are then optionally used in estimating the velocity profile of the capture apparatus by employing instant non-sequential VIO. The non-sequential VIO is performed on backend 409 utilizing remote storage 116 and compute resources 122 and per prior teachings.

In practice, the linear acc and gravity values produced by an IMU are in fact derived or estimated by the firmware or device driver of the IMU based on its acc and gyro values and then provided externally via an API. The present technology preferably only stores these IMU-based linear acc and gravity values. Instead of using these values, it preferably estimates its own linear acc and gravity values for better accuracy for its downstream non-sequential VIO. In alternative embodiments however, the present design uses the IMU-based linear acc and gravity values for its VIO.

The present technology further provides random-access retrieval on IMU data in addition to the video data. Random-access to IMU data is afforded by an IMU index already introduced above. In a manner similar to the video index detailed above, the IMU index or table of the preferred embodiment contains the following fields or columns:
1. A UUID (Universally Unique Identifier) assigned to the capture apparatus.
2. Timestamp of the start time of the IMU segment.
3. Duration of the IMU segment, preferably 10 seconds for an AOD, and 60 seconds for an OOD.
4. A Sensor Label containing identifying information about the sensor responsible for the IMU segment such as an accelerometer, a gyroscope, a magnetometer, among others.
7. A Resource locator, identifying the location of the IMU data or content and analogous to the resource locator for video data/content taught above. In one embodiment, the IMU data is stored in a datastore in local storage 411 where the datastore is preferably structured on a key-value pair architecture. In such an embodiment, the resource locator or simply the locator is a key in the datastore pointing to the IMU data as the value. In another embodiment, the IMU data is stored as a file or files in a filesystem on local storage 411. In such an embodiment, the locator is path(s) in the filesystem of the file(s) containing the IMU data.
Once the index has been uploaded/synced to remote storage 116 per below teachings, the resource locator is updated to contain the location of the IMU data in remote storage 116. Advantageously, remote storage 116 is implemented on AWS® S3 cloud storage, and as such the resource locator for IMU data or content residing in S3 storage is the S3 key.
5. Ancillary data, a flexible JSON field with sub-fields containing any other information about the IMU segment as needed for a given implementation. Preferably, the ancillary data includes:
   Stationary flag. A binary flag derived from the IMU data indicating whether the capture apparatus was stationary or not for the duration of the IMU segment.
   Summary. A field containing a subset of samples from the IMU segment that are sufficient for efficiently visualizing the IMU segment.

One set of the above fields will constitute a row in the index table. This table, containing the collection of rows with the above sets of fields for the entire IMU content of a given project, is referred to as the IMU index. In practice, there may be several such index tables or indices in the database for the respective number of projects that are currently active for a given implementation. The above IMU index design allows random-access queries on the IMU data rather than the typical sequential access of the prior art.

### User Markings/Events Index:

The present technology also provides index-based retrieval of user markings or events in addition to the video and IMU data. Access to user events/markings data is afforded by a user events index already introduced above. In a manner similar to the video and IMU indexes/indices detailed above, the user markings index or user events index or table of the preferred embodiment contains the following fields or columns:
1. A UUID (Universally Unique Identifier) assigned to the capture apparatus.
2. Timestamp of when the user event occurred.
3. Ancillary data, a flexible JSON field with sub-fields containing any other information about the user event as needed for a given implementation. Preferably, the ancillary data includes:
   Type of the user event, such as the pressing of a Start button or a Stop/Pause button, entering of a Waypoint or Checkpoint of interest, among others. These user events may occur during or after a capture session or an AEC walkthrough per above teachings.

One set of the above fields will constitute a row in the index table. This table, containing the collection of rows with the above sets of fields for all user events of a given project, is referred to as the user events index. In practice, there may be several such index tables or indices in the database for the respective number of projects that are currently active for a given implementation. The above user events index allows random-access queries on the user events data in a manner consistent with the use of index-based random-access of video and IMU data.

As a key advantage of the present technology, the different cameras of a given capture apparatus can have different hardware and even have different framerates. Because the frames are timestamped by timestamp filter 456A of FIG. 21-23 above, they can be aggregated or overlaid or stitched together in sequence based on their timestamps. We refer to such ordering of video as well as IMU data based on timestamps as time-aligning the data. This time-aligning of video and IMU data is required in order to faithfully perform downstream functions taught in reference to the prior embodiments.

The downstream functions include reordering portions of capture data based on user markings. Explained further, capture data 405 consisting of video data 430 and IMU data 502, is first decomposed into video segments 434 and IMU segments 474 via video and IMU data processing pipelines based on above teachings. Video pipelines were discussed above in reference to FIG. 21-24 while IMU data processing pipelines were discussed above in reference to FIG. 25-26. The video/IMU segments 434/474 are stored and uploaded according to the video and IMU data storage and upload schemes taught further below.

Recall from the prior embodiments that a key benefit of the present non-sequential design is the ability to record portions of video data in arbitrary order. After the capture data has been segmented and stored, the user is able to reorder the video and IMU segments based on the markings and by utilizing the timestamps on the data. In other words, the user can request the video and IMU data in any desired order based on the markings as discussed above. The system time-aligns the requested video and IMU segments and retrieves them in a random-access manner. It does so by matching/comparing the timestamps of the video segments, IMU segments and user events in the request/query.

The non-sequential VIO is then performed by backend 409 on the ordered video and IMU data as per the user request. By employing the non-sequential VIO and based on the user markings, a velocity profile of the capture apparatus during the capture session is estimated based on prior teachings. The velocity profile is estimated using capture data that is now ordered per the user request. Ultimately, a montage of the capture data in the order requested by the user is produced by the backend as provided in the teachings of the prior embodiments. Other downstream functions/tasks of the prior embodiments also apply to the present data capture embodiments once capture data has been segmented and indexed per above. Still other backend processing functions may also be designed in further enhancements to the present design.

Not requiring the cameras of an instant capture apparatus to have the same framerate or be hardware-synchronized is a key advantage of the present design. For constructing a high-fidelity 360° view from the frames of the various cameras, hardware-synchronization of the cameras is often advantageous but not always possible. Therefore, an alternative embodiment performs frame interpolation to generate time-matched frames for constructing the 360° view.

While referring to FIG. 15 in conjunction with FIG. 21-23, the task of reading/capturing image frames 430A from camera(s) 404 and writing them to FIFO 454A are preferably performed by video capture module 410. Then, video segmentation and indexing module 414 is preferably responsible for implementing video pipeline(s) 432 and decomposing video data 430 into segments 434 per above teachings. Module 414 is also preferably responsible for creating and maintaining the video index of the above teachings.

In a similar fashion, and while referring to FIG. 15 in conjunction with FIG. 25-26, the task of reading/capturing acc/gyro data 502A/502B from sensors 406A/406B and writing it to FIFOs 508A/508B is preferably performed by IMU capture module 412. Then, IMU data segmentation and indexing module 416 is preferably responsible for implementing IMU data pipeline(s) 504A/504B and decomposing IMU data 502 into acc/gyro segments 474A/474B per above teachings. Module 416 is also preferably responsible for creating and maintaining the IMU index of the above teachings.

Storage module 418 is preferably responsible for the storage of video and IMU segments 434 and 474 obtained from modules 414 and 416 respectively, in local storage 411 according to data storage and upload schemes taught below. Module 418 is also preferably responsible for uploading the data to remote storage 116 according to the instant data upload schemes. Module 418 is also preferably responsible for ensuring that local video, IMU and user events indices on capture apparatus 402 remain in sync with their counterparts in remote storage 116 as per below teachings.

### Data Storage and Upload Scheme for AOD:

Let us now focus on the data storage and upload capabilities of embodiments where capture apparatus operates as an always-on device (AOD). Per above, these capabilities are preferably implemented by storage module 418 of FIG. 15. Referring still to FIG. 15, AOD capture apparatus 402 or simply AOD 402 may be kept on for the entire duration of a shift of a worker or operator. As taught earlier, in the present AOD embodiments, observer/user 104 of FIG. 2 applies markings to portions 106A-N of capture data 106 retrospectively i.e. after the fact or after the data has been collected/recorded/captured and stored or ex post facto.

An exemplary implementation of such an AOD was shown in FIG. 4 employing 4 FLIR® Blackfly cameras with 2000×1500 pixels resolution operating in 8-bit monochrome mode at 30 fps. The computing resources on the capture apparatus preferably consist of Nvidia® Jetson Xavier embedded computer and the IMU is a BerryGPS®-IMUv3. Preferably, the above computing resources and specifically the microprocessor are embedded/integrated with the camera in a common housing.

Once video/IMU data 430/502 of capture data 405 has been segmented by video/IMU segmentation and indexing modules 414/416 and stored as video/IMU segments 434/474 per above, only data that is of interest or is important is preferably uploaded to remote storage 116. Note that the video, IMU and user events indices are always maintained on local storage 411 of capture apparatus 402 and synced to remote storage 116. This is regardless of which part of capture data or content is uploaded to remote storage 116 and which is omitted from uploading and/or discarded.

In an AOD, after capture data 405 has been captured/recorded, user 422 can retrospectively define a time interval of interest using capture application 408. This results in an upload request marking the video and IMU data associated with the time interval for upload to remote storage 116. A data upload request may be directly generated by user 422 via capture application 408. However, it may also be the indirect result of a user action, such as the marking of start/stop of a capture session or a time interval of interest.

If the user action was performed on capture application 408 then such an upload request is local to capture apparatus 402 and in response the associated data is uploaded to remote storage 116 via backend 409. However, the user action may have been performed on the backend or on computer application 170 running on computing device 424. In such a scenario, an upload request is sent from backend 409 to capture application 408 and acted upon accordingly on capture apparatus 402.

In AOD implementations, the video segments are exemplarily kept short, e.g. of 2 seconds duration, while the IMU segments (acc and gyro) are kept longer e.g. of 10 seconds duration. This affords a finer level of granularity when upload requests are received by the capture application, such as capture application 130 of FIG. 2 and the capture application 408 of FIG. 15. As a consequence of the above design, we can select the data to upload with the minimum amount of “wasted” uploaded data. For example, if the upload request resulting from user's actions is for 18 seconds of video data, then one can select 9 video segments to satisfy the request. However, if the video segments were 1 minute long, then one would select 1 video segment, with 42 seconds of unneeded video data uploaded.

The goal in the AOD embodiments is to perpetually record video data from multiple cameras around the clock. Referring to the four-camera implementation of FIG. 4 for our capture apparatus 402 of FIG. 15, let us now calculate the data requirements. Note, that the data requirements are the same regardless of camera arrangements 442 of FIG. 20 discussed above. Based on the above configurations, a single camera generates˜35+GB/day. The 4 cameras shown in FIG. 4 generate 4×˜35=˜140 GB/day. For the purposes of this example, let us assume that the IMU generates another˜5 GB/day. With 750 GB of local storage 411 as an example, one would then run out of storage on the 5th day for the 6th day of storage i.e. after floor (750/145)=5 days. In order to circumvent this situation, the present technology implements a rolling partition scheme for data storage. Let us now understand the instant rolling partition data storage scheme in detail.

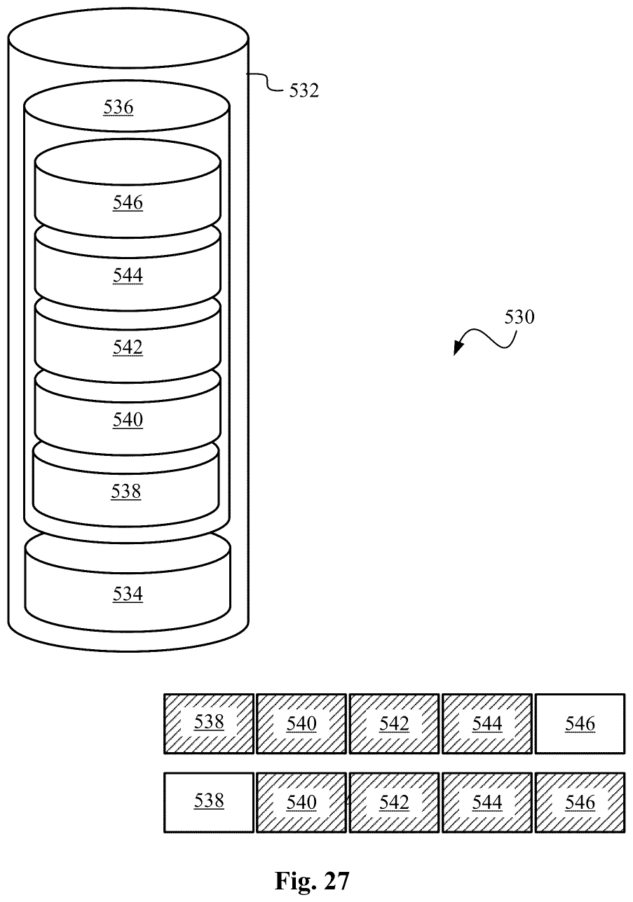

FIG. 27 shows physical and logical views of such a rolling partition storage system. More specifically, FIG. 27 shows a physical disk drive 532 on local storage or disk 411 that is partitioned into a primary partition 534 and an extended partition 536. The primary partition is meant to store the operating system files, while the extended partition is meant to store user data comprising the video segments and IMU segments of the present teachings. In order to accomplish this, extended partition 536 is further partitioned into 5 logical partitions 538, 540, 542, 544 and 546 as shown. Based on the instant principles, extended partition 536 is logically divided into as many partitions as needed based on the amount of data generated by the cameras and the IMU (as well as user events).

The daily data by the cameras and the IMU of the AOD is preferably stored in a single partition as shown in FIG. 27. Alternatively, the video and IMU data may be stored in separate partitions. As shown in the example of FIG. 27, data for the first four days is stored in partitions 538, 540, 542 and 544 as indicated by the hatched pattern in the boxes. However, on the fifth day as data is written to partition 536, first partition 538 is reclaimed by formatting the partition. This design affords tremendous performance improvement over the traditional record-by-record or file-by-file deletion schemes.

Exemplarily, if we need to delete thousands or tens of thousands or hundreds of thousands of records for a given day, the record-by-record or file-by-file deletion to achieve this is very slow in traditional schemes. This is because the traditional process requires significant I/O bandwidth and also consumes the usable life of the flash storage devices. On the other hand, formatting of entire partitions in the present design is much faster. This is because partitioning involves just the manipulation of the partition table. It also extends the lifespan of the storage devices implementing local storage 411.

Typically, while operating as an AOD, capture apparatus 402 of FIG. 15 operates behind a firewall, which may be a local/business firewall of the business or establishment where the capture session is being recorded. This makes the AOD inaccessible from the outside world over the public internet. This can be a problem when instant backend 409 needs to send an upload request to capture application 408 utilizing compute resources 413 and storage resources 411 of capture apparatus 402. The present design solves the above problem.

For this purpose, in one embodiment, a third-party messaging service e.g. Pusher® is used to establish a secure bidirectional WebSocket connection between capture application 408 and the Pusher messaging service. This allows the capture application to “listen” for upload requests. Preferably, the WebSocket connections between the messaging service and the instant AOD capture application 408 are organized into channels. To request data from a capture apparatus, the remote backend sends its request to the Pusher service, which then delivers the message using the channel for capture application 408. The request would identify which data to upload and where to upload it in remote storage 116.

Recall that while the video, IMU and user events indices are stored as database tables, the actual video and IMU segments are stored as files in the filesystem. Therefore, while fulfilling a data upload request, capture application 408 first locates the video/IMU content files by following the content locator field in the respective video/IMU indices. It then transmits these video/IMU segments files to backend 409 where they are stored in a filesystem in remote storage 116. For this purpose, it uses one of several file transfer techniques including secure HTTP (HTTPS) File upload, secure file transfer protocol SFTP, secure copy protocol (SCP), among others. Based on the above design, AOD capture apparatus 402 and more specifically capture application 408 does not have to constantly poll the remote backend 409 to become aware of data requests.

Thus, the video and IMU segments or content files are sent by capture application 408 to backend 409 “on-demand” i.e. in response to data upload requests. On the other hand, the local video, IMU and user events indices are continually replicated to remote storage 116 via database replication to be explained further below. In an alternative embodiment however, the video and IMU segments files or content files are also continually copied to remote backend/storage 409/116 using one of several file transfer techniques performed by a background process. Such techniques exemplarily include secure HTTP (HTTPS) File upload, secure file transfer protocol SFTP, secure copy protocol (SCP), among others. For efficiency reasons, such an embodiment is recommended when communication is extremely fast and/or the video segment sizes are very small (perhaps due to low-resolution video).

Database replication is an automated technique in which data from one database is securely copied to another, usually remote database. For simple tables, the replication operation/process is lightweight and fast. As a result, the index tables between local storage 411 on capture apparatus 402 and remote storage 116 on remote backend 409 are always kept in sync.

Let us consider an example. Since in an AOD video segments are continuously created, in the four-camera configuration taught above, given video segments of 1 seconds, cameras yield approximately 60×4=240 video segments every minute. Assuming database replication is performed every few seconds, the transaction size is very small i.e. only 250 to 500 database rows changes during that timeframe.

To perform database replication, there is a background process that looks for changes in the local video, IMU and user events indexes/indices or tables on storage 411. If there are changes, a replication operation is queued. The replication operation creates a list of rows that have changed for each index since the last replication, connects to the remote database and brings the local and remote tables to the same state while creating a transaction log. As a result of instant database replication, an application can query an index on the backend to gain information about the capture data contained on AOD 402.

The above data replication scheme is also extended to user events and not just video and IMU data. In other words, the user events are also stored in the local user events/markings index in local storage 411 per above teachings and replicated to remote storage/database 116 through database replication. One can therefore efficiently determine which video and IMU segments correspond to a user event by querying the remote database replica while using the timestamp of the user event as a query parameter.

Consider the scenario where the user retrospectively defines a capture session on backend 409 or on computer application 170. By querying the index(es) on the backend, the application can determine exactly which data segments to request from AOD 402. It can then issue appropriate upload request(s) with the resource locators to AOD 402 and subsequently obtain those data segments from the AOD. This present design results in significant performance improvements than otherwise possible.

Moreover, complex queries performed on remote storage/database 116 are efficient because the backend is generally provisioned with more computer resources than capture apparatus 402. Further, if an AOD capture apparatus is directly unreachable due to loss of network connectivity, one can still query the remote replicated database on remote storage 116 of backend 409 to gain knowledge about capture data that has already been captured by AOD 402.

In situations where database replication is not available or practical, the present design provides alternative techniques to transmit the local database information to the remote backend. In one embodiment, a background process keeps track of the changes to local video, IMU and user events indices in local database on local storage 411. When network connectivity is present, the process issues one or more HTTP POST requests to update the changes to remote database on remote storage 116 via backend 409. In one embodiment, every transactional change to a local index is thusly replicated through a POST request. In another embodiment, multiple transactional changes to the local index are accumulated and replicated through a single POST request.

In the same or related embodiment, the background process keeps track of whether each row in the local indices has been successfully replicated via a dedicated POSTED column. The column is set to false for any newly added rows. The background process periodically queries the local tables for rows with POSTED column set to false. These rows are then sent to the remote backend through HTTP POST request. The local POSTED column is set to true upon receiving a success confirmation from the remote backend. Should the POST fail for any reason, including due to loss of connectivity, the POST column is kept false for a subsequent retry.

It is to be noted that while database replication taught above is most advantageous to AODs, its benefits may also be conceived for OODs. However, the preferred implementation of data upload and storage scheme for OODs is discussed below.

### Data Storage and Upload Scheme for OOD:

An on/off device or an on-off device (OOD) is a device that is not meant to capture data continually and is meant to be in off-state between capture sessions. This may be due to storage limitations, short battery capacity or thermal runtime limits. An OOD can be more compact, cheaper and lighter than an AOD.

Battery capacity imposes a limit on the total recording time across multiple capture sessions (e.g. 1-2 hours) before a battery recharge. But thermal runtime limits set the maximum possible duration for a single capture session (e.g. 20 to 30 minutes) before a cooldown period is required. Storage capacity imposes a limit on the amount of data that can be captured and stored in local storage 411 of FIG. 15 before it must be uploaded to remote storage 116. Exemplarily, internal storage 411 for an OOD may be of size˜64 GB, however the portion of it that may be available for data storage is often less e.g. ˜45 GB.

Storage capacity indirectly imposes a limit on the maximum recording time during periods when there is no network availability. In other words, if the network is down, one must stop capturing data after either the storage limit or the thermal limit is reached. Then one must wait for the cooldown period to pass and for the network to be available again to transmit the captured data to remote storage if needed.

The above factors contribute to various usage patterns of capture application 408 operating on the OOD capture apparatus 402 or simply OOD 402. In one use case for an OOD, the user starts and stops the recording. This effectively establishes a time interval of interest or capture session on the spot. Rather than waiting for remote backend 409 to request data, OOD capture apparatus 402 proactively uploads segmented and indexed capture data to remote backend 409 and more specifically to remote storage 116. Therefore, data is pushed by an OOD to the remote backend, whereas data is pulled or requested from an AOD by the backend. Data upload in an OOD is performed by a background process that continually attempts to contact remote backend 409 to upload recorded data as well as user events.

Due to storage capacity limits on local storage 411, all capture data must be uploaded to remote backend in an OOD. It is crucial that one proactively uploads data to free space in local storage 411. But there needs to be a balance between file size and upload times. Video and IMU segments of short duration can be uploaded almost immediately after the recording starts. For example, with short segments of 5 seconds, uploads can begin within 5 seconds of the start of the recording. But with segments having a longer duration, e.g. 5 minutes, data upload does not begin until 5 minutes have elapsed since a recording starts. Furthermore, long segments increase the chance of upload failures due to network timeouts.

On the other hand, we also want to minimize the number of HTTP requests. For example, if the segments are very short, e.g. 1 second duration, we then need to upload 60 files/minute per camera requiring 60 HTTP POST requests/minute. One could instead batch multiple files into a single HTTP Multipart request, but we might as well avoid the hassle of assembling batches by simply selecting segments of longer duration. Therefore, a balance must be struck based on the requirements of an implementation and the attributes of the available local storage 411 of the OOD. In the preferred embodiment, video segments are kept 12 seconds long and the IMU segments are kept 60 seconds long. This results in 5 HTTP POST requests/minute per camera for video data and 1 HTTP POST request/minute for IMU data.

A person familiar with consumer camera products understands that users rarely free storage proactively. They typically first run out of space, and then manually free storage. However, it is not desirable for an OOD to run out of storage space during a capture session. Storage management is thus handled automatically without user intervention by the present technology.

When capture apparatus 402 is implemented as an OOD, it is preferably done by using a low-cost, off-the-shelf embedded SoC and by sharing the same physical storage between the operating system and the applications. Therefore, for an OOD, implementing a mechanism based on reformatting and rotating partitions in local storage 411 is too risky. One mishap, e.g. a power failure during partitioning, can render the device unusable. Instead, an OOD deletes data through filesystem operations. So, another reason for not using segments with very short durations is that the number of file deletions will be excessive.

An OOD 402 and more specifically its capture application 408 deletes a video or IMU segment once it has been successfully uploaded to remote backend 409 i.e. remote storage 116 in cloud 118. In contrast, an AOD retains data until the retention period on the device expires. In AEC implementations of the present technology, network availability is often inconsistent. One needs to upload as much data as possible during the periods when the network is available. At the same time, network connections can be unreliable, so the technology must be highly tolerant of upload failures.

In as far as the instant indexes or tables are concerned, capture application 408 of an OOD 402 stores video, IMU and user events indices of the above teachings in a local database in storage 411. In the preferred embodiment, the entries/rows of the local indices/tables are transmitted to the remote backend through a RESTful API over HTTP performed by an upload service. The local index entries are said to be posted to the remote backend (through HTTP POST requests). An API server at the backend processes the HTTP POST requests, and enters the posted entries/rows in the respective indexes/tables of the remote database on remote storage 116.

The upload service of capture application 408 keeps track of which local index entries need to be posted to the remote backend. In one embodiment, entries are posted asynchronously to the remote API server. In another embodiment, multiple entries are posted concurrently using separate connections operating simultaneously. An entry is marked as posted if the API server responds with success. Otherwise, it remains marked as pending or unposted in the table of the local database in storage 411 for a retry attempt. The upload service runs continuously as a standalone thread.

In as far as the capture data content is concerned, the upload is performed by a background process that uses the local database in local storage 411 to track which video and IMU segment/content files need to be uploaded. In one embodiment, it selects N oldest recorded files from its pool of unposted or un-uploaded files, and uploads them concurrently and asynchronously. That is, each file in the selected batch is uploaded using a separate connection request with all N connections operating simultaneously. Preferably, N=10 in the above data upload scheme.

A video or IMU segment file is marked as uploaded if the remote backend responds with success. If a file fails to upload due to server error, network error, or the like, it remains in the local database in local storage 411 for a next attempt. The local database always contains a current batch of files pending to be uploaded. The above background process runs constantly as a standalone thread, always looking for an opportunity to upload any pending files. It uses one of several file transfer techniques for uploading the files.

Such techniques exemplarily include secure HTTP (HTTPS) File upload, secure file transfer protocol SFTP, secure copy protocol (SCP), among others. In one embodiment, posted files are removed by the upload service itself upon receiving a success confirmation from the remote backend. In the preferred embodiment, a separate thread periodically looks for files marked as uploaded in the local database and deletes these files from the filesystem in local storage 411.

### Companion Application:

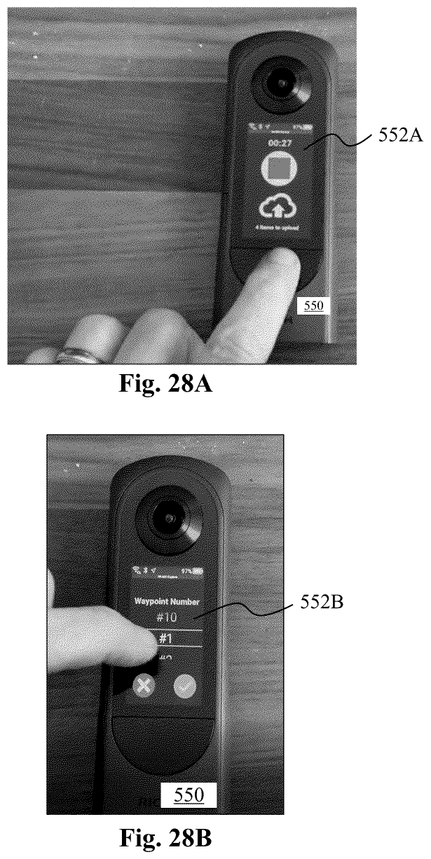

In accordance with the above teachings, an instant capture apparatus, such as capture apparatus 102/402 of FIG. 2/FIG. 15 has an appropriate UI, which may be a GUI, for user 104/422 to interact with the apparatus. In one embodiment, such a UI is provided directly on capture apparatus 102/402. FIG. 28A and FIG. 28B show such a capture apparatus 550 in the form of a handheld device with a touch screen GUI and a camera and that is directly integrated with other components of the apparatus in a common housing. GUI screen 552A of capture apparatus 550 in FIG. 28A shows the user pausing/stopping a recording, while the GUI screen 552B of capture apparatus 550 in FIG. 28B shows the user entering a waypoint. Text under the cloud icon on screen 552A reports the number of pending files (if any) that are yet to be uploaded. Uploads occur automatically if the network is available.

For AEC and other embodiments, it is highly desirable for the capture apparatus to be head-mounted as shown in block 162A of FIG. 3 and discussed in detail in reference to the four-camera embodiments of FIG. 4-5. In such embodiments, it is inconvenient for the user to interact with capture apparatus 102/402 without taking the helmet off. Therefore, it is useful to provide a UI to user 104/422 that is remote/separate from head-mounted capture apparatus 102/402. Such a UI is provided via a companion application that operates on companion device 126/426 based on the instant principles and as already discussed above.

Companion device 126/426 issues/sends commands/instructions or requests to capture application 130/408 operating on capture apparatus 102/402. The companion application is a client application of capture application 130/408 that sends commands/requests to it and relays status information to user 104/422. Requests/commands from the companion application are only acknowledged by the capture application if the capture apparatus/device is in a state where such a request/command “makes sense”. This eliminates the requirement of having a complex handshake between the capture application and the companion application.

For example, consider the case when the companion application starts up and sends a request by user 104/422 to capture apparatus 102/422 and specifically to capture application 130/408 to start recording. If the capture apparatus was already recording, it ignores the request or command of the companion application. Now consider the scenario in which user 104/422 mistakenly closes the companion application and then restarts it. Upon restart, the companion application receives the latest status update from capture application 130/408 running on capture apparatus 102/402 that is still operating.

The companion application sets its display and available controls to match the received latest status update. In one embodiment, the companion application receives status updates from the capture application every second, however the frequency of updates can be chosen according to the requirements of a given implementation. The companion device can take the form of any suitable computing device. Preferably, the companion device is a handheld or a wearable device, including a smart phone, a smart watch, a tablet, a wearable computer, AR goggles, among others.

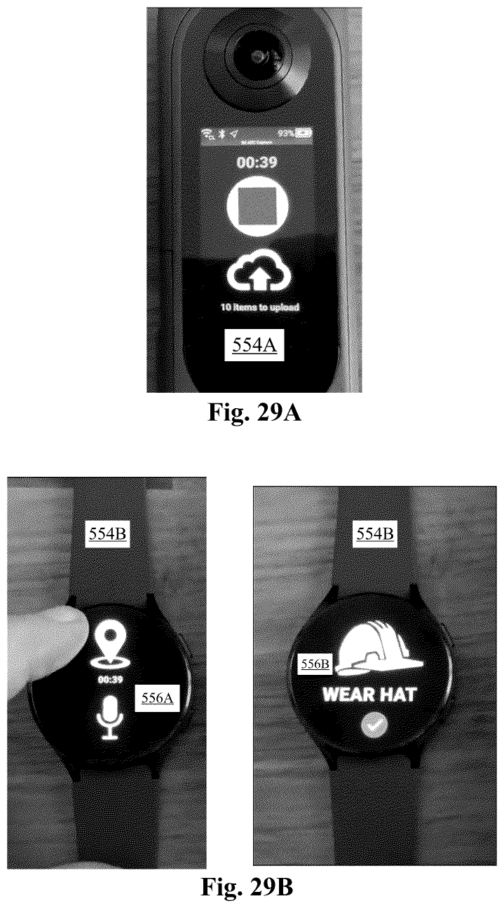

FIG. 29A and FIG. 29B show two such companion devices based on the instant principles. In FIG. 29A, the same handheld device of FIG. 28 is now also being used as a companion device 554A to send commands to a head-mounted capture apparatus (not shown). In the present embodiment, the handheld capture device of FIG. 28 acts a companion device for the head-mounted capture apparatus. An interesting application of this embodiment is that both the capture device of FIG. 28 and the head-mounted capture apparatus act as two different capture apparatus in a given capture session. However, just the device of FIG. 28 acts as the companion device for both the capture apparatus. This is because the UI of the handheld device is directly accessible by the user, thus permitting interaction with both the handheld device and the head-mounted capture apparatus.

In comparison to the above embodiment, in FIG. 29B, a smartwatch is being used as a companion device 554B to send commands to a head-mounted capture apparatus (not shown). Notice GUI screen 556A in FIG. 29B shows the icons to add waypoints and voice memos to the recording per above teachings. GUI screen 556B shows a prompt to the user to wear the helmet with capture apparatus 550 mounted on top.

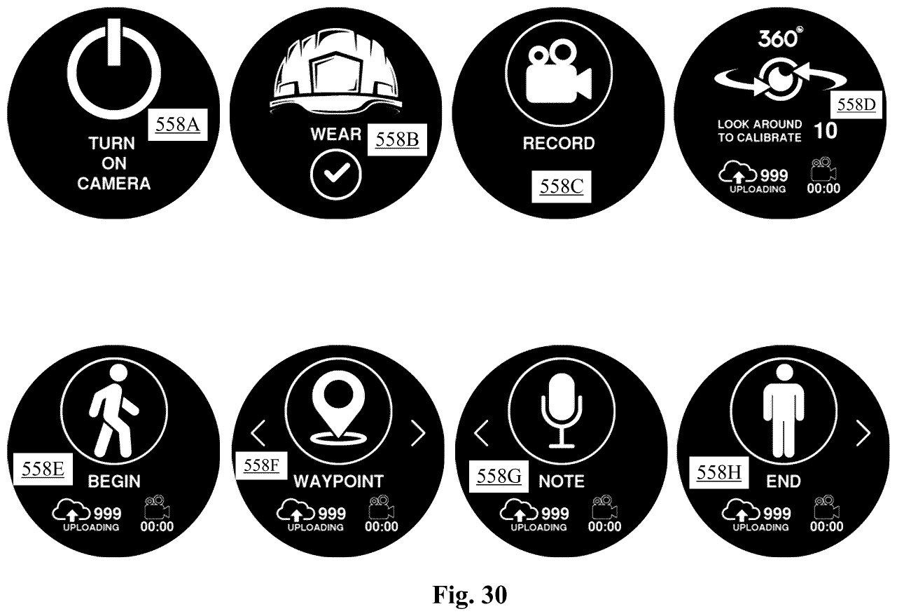

For completeness, FIG. 30 presents various screens 558 of an exemplary companion application operating on a smartwatch based on the present principles. More specifically, screen 558A shows the icon to power/turn on/off the cameras of capture apparatus 550, screen 558B shows a user prompt to wear the helmet with capture apparatus 550 mounted on top and screen 558C shows the icon to start/stop recording. Screen 558D shows a user prompt asking the user to look around in a 360° view manner while wearing the helmet to calibrate the IMU of the capture apparatus.

There is also a cloud icon with a text legend reporting the number of pending files that are yet to be uploaded to the remote storage based on above teachings. Screen 558E allows the user to start/begin a walkthrough, screen 558F allows the user to enter a waypoint, screen 558G allows the user to add a voice memo and screen 558H allows the user to end or stop a walkthrough.

In the same or a related embodiment, capture apparatus 102/408 of FIG. 2/FIG. 15 comprises a computer embedded or integrated with a 360° camera in a common housing and equipped with an IMU such as a Ricoh® Theta X. Per above, instant capture application 130/408 runs on the embedded computer. The capture apparatus is preferably carried on a monopod by user 104/422. In the same or a related embodiment, the capture apparatus is head-mounted on the operator.

In another embodiment, the capture application runs on an embedded computing device such as a Raspberry PI, NVidia Jetson Xavier, NVidia Jetson Nano, or a similar device, equipped with a separate IMU unit. In such an embodiment, one or more cameras are connected to the embedded device. Further, the cameras and IMU are preferably head-mounted on the operator.

In view of the above teachings, a person skilled in the art will 5 recognize that the methods of present invention can be embodied in many different ways in addition to those described without departing from the principles of the invention. Therefore, the scope of the invention should be judged in view of the appended claims and their legal equivalents.

What is claimed is:

1. A data capture system comprising:
(a) a capture apparatus containing at least one camera and an inertial measurement unit (IMU);
(b) a first set and a second set of computer-readable instructions stored in a first non-transitory storage medium and a second non-transitory storage medium respectively, and at least one microprocessor coupled to said first non-transitory storage medium for executing said first set of computer-readable instructions, and at least one microprocessor coupled to said second non-transitory storage medium for executing said second set of computer-readable instructions;
(c) said first set of computer-readable instructions causing a first computer application to:
(d) collect one or more portions of capture data while said capture apparatus is carried by a user undergoing motion at a site during a capture session, wherein said capture data comprises video data and IMU data produced by said at least one camera and said IMU respectively;
(e) allow said user to apply one or more markings to said one or more portions;
(f) decompose said one or more portions into a plurality of video segments and a plurality of IMU segments;
(g) index said plurality of video segments, said plurality of IMU segments and said one or more markings by employing a video index, an IMU index and a markings index respectively; and
(h) said second set of f computer-readable instructions causing a second computer application to estimate a velocity profile of said capture apparatus by performing non-sequential visual inertial odometry (VIO) on said plurality of video segments and said plurality of IMU segments, and by employing said one or more markings.

2. The data capture system of claim 1 further comprising a companion device containing at least one microprocessor coupled to a third non-transitory storage medium for executing a third set of computer-readable instructions, wherein said third set of computer-readable instructions cause a third computer application to issue commands to said first computer application and to provide status updates to said user.

3. The data capture system of claim 1, wherein said at least one microprocessor executing said first set of computer-readable instructions of said first computer application is integrated with said at least one camera in a common housing.

4. The data capture system of claim 1, wherein said capture apparatus comprises an embedded computer containing said at least one microprocessor executing said first set of computer-readable instructions of said first computer application.

5. The data capture system of claim 1, wherein said plurality of video segments are produced by a video pipeline comprising a timestamp filter, a scaler, a transposer, a GPU encoder and an HTTP Live Streaming (HLS) multiplexer.

6. The data capture system of claim 1, wherein said video segments are produced by a video pipeline comprising a hardware video encoder and an MPEG multiplexer.

7. The data capture system of claim 1, wherein said plurality of IMU segments comprise a plurality of accelerometer segments and a plurality of gyroscope segments, and wherein said plurality of accelerometer segments and said plurality of gyroscope segments are stored in an array.

8. The data capture system of claim 1, wherein said at least one camera is attached to one of a helmet worn by said user during said capture session and a monopod carried by said user during said capture session.

9. The data capture system of claim 1, wherein said video index comprises a plurality of entries corresponding to said plurality of video segments, and wherein each of said plurality of entries comprises a starting timestamp, a duration, a camera label and a resource locator of the video segment corresponding to said each of said plurality of entries.

10. The data capture system of claim 1, wherein said IMU index comprises a plurality of entries corresponding to said plurality of IMU segments, and wherein each of said plurality of entries comprises a starting timestamp, a duration, a sensor label and a resource locator of the IMU segment corresponding to said each of said plurality of entries.

11. The data capture system of claim 1, wherein said plurality of video segments and said plurality of IMU segments are uploaded from a local storage to a remote storage according to a data storage and upload scheme.

12. The data capture system of claim 11, wherein said plurality of video segments and said plurality of IMU segments can be read from one of said local storage and said remote storage by a random-access retrieval based on said video index and said IMU index respectively.

13. The data capture system of claim 11, wherein said capture apparatus is an always-on device (AOD).

14. The data capture system of claim 13, wherein said video index, said IMU index and said markings index are copied to said remote storage by table replication.

15. The data capture system of claim 13, wherein said data storage upload scheme utilizes a bidirectional WebSocket connection established by a messaging service.

16. The data capture system of claim 11, wherein said capture apparatus is an on-off device (OOD).

17. The data capture system of claim 16, wherein said first set of computer-readable instructions further cause said first computer application to transmit one or more entries of said video index, said IMU index and said markings index to said remote storage via a RESTful (Representational State Transfer) API over HTTP.

18. The data capture system of claim 16, wherein said data storage and upload scheme utilizes a background process that uploads said plurality of video segments and said plurality of IMU segments to said remote storage.

19. A method executing computer program instructions by at least one processor coupled to at least one non-transitory storage medium storing said computer program instructions, said method comprising the steps of:
(a) collecting one or more portions of capture data produced by a capture apparatus carried by a user undergoing motion at a site during a capture session, said capture apparatus comprising a camera and an inertial measurement unit (IMU);
(b) applying one or more markings by said user to said one or more portions;
(c) decomposing said one or more portions into a plurality of video segments and a plurality of IMU segments;
(d) indexing said plurality of video segments, said plurality of IMU segments and said one or more markings by employing a video index, an IMU index and a markings index respectively; and
(e) estimating a velocity profile of said capture apparatus from said one or more portions by employing non-sequential visual inertial odometry (VIO) and by utilizing said one or more markings.

20. The method of claim 19 further providing a companion device running companion application for issuing commands and for providing status updates to said user.

21. The method of claim 19 further attaching said at least one camera to one of a helmet worn by said user and a monopod carried by said user during said capture session.

22. The method of claim 19 further uploading said plurality of video segments and said plurality of IMU segments from a local storage to a remote storage according to a data storage and upload scheme.

23. The method of claim 22, wherein said capture apparatus is an always-on device (AOD).

24. The method of claim 23 further copying said video index, said IMU index and said markings index to said remote storage by table replication.

25. The method of claim 23, wherein said data storage and upload scheme utilizes a bidirectional WebSocket connection established by a messaging service.

26. The method of claim 22, wherein said capture apparatus is an on-off device (OOD).

27. The method of claim 26 further transmitting one or more entries of said video index, said IMU index and said markings index to said remote storage via a RESTful (Representational State Transfer) API over HTTP.

28. The method of claim 26, wherein said data storage and upload scheme utilizes a background process that uploads said plurality of video segments and said plurality of IMU segments to said remote storage via HTTP file upload.
